(19) United States
(12) Patent Application Publication
(10) Pub. No.: US 2024/0330732 A1
(43) Pub. Date: Oct. 3, 2024

(54) PREDICTIVE MODELING OF A CONTROL AGENT FOR A QUANTUM COMPUTER

(71) Applicant: IonQ, Inc., College Park, MD (US)

(72) Inventors: Neal Carden PISENTI, Portland, OR (US); John King GAMBLE, Redmond, WA (US)

(21) Appl. No.: 18/620,664

(22) Filed: Mar. 28, 2024

Related U.S. Application Data
(60) Provisional application No. 63/492,741, filed on Mar. 28, 2023.
(60) Provisional application No. 63/625,724, filed on Jan. 26, 2024.

(51) Int. Cl. G06N 10/20; G06N 10/40

(52) U.S. Cl. CPC G06N 10/20; G06N 10/40

(57) ABSTRACT

Aspects of the present disclosure relate generally to systems, apparatuses, devices, and methods for use in the implementation and/or operation of quantum information processing (QIP) systems, and more particularly, to predictive modeling of a control agent for a quantum computer.

### CROSS-REFERENCE TO RELATED APPLICATION

This application claims the benefit of and priority to U.S. Provisional Patent Application No. 63/492,741, filed Mar. 28, 2023, and U.S. Provisional Patent Application No. 63/625,724, filed Jan. 26, 2024, the contents of which applications are hereby incorporated by reference herein in their entireties.

### TECHNICAL FIELD

Aspects of the present disclosure relate generally to systems, apparatuses, devices, and methods for use in the implementation and/or operation of quantum information processing (QIP) systems.

### BACKGROUND

Trapped atoms are one of the leading implementations for quantum information processing or quantum computing. Other implementations include those based on superconducting qubits or photonic qubits, for example. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

It is therefore important to develop new techniques that improve the design, fabrication, implementation, and/or control of different QIP systems used as quantum computers or quantum simulators, and particularly for those QIP systems that handle operations based on atomic-based qubits.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

This disclosure describes various aspects of methods, and computing systems, and QIP systems that, individually or in combination, provide closed-loop control and calibration in quantum information processing (QIP) systems.

In some aspects, the technologies disclosed herein relate to a computer-implemented method, including: executing a quantum circuit configured in a qubit register formed from qubits included in quantum hardware, the quantum circuit corresponding to a quantum program of an end-user of the quantum hardware; and generating at least one control parameter corresponding to the quantum circuit by evaluating a control model during execution of the quantum circuit.

In some aspects, the technologies disclosed herein relate to the foregoing computer-implemented, further including compiling, based on the control model, the quantum circuit corresponding to the quantum program on a subset of the qubits included in the quantum hardware.

In some aspects, the technologies disclosed herein relate to a computing system including: at least one processor; at least one memory devices storing processor-executable instructions that, in response to being executed by the at least one processor, cause the computing system at least to: execute a quantum circuit configured in a qubit register formed from qubits included in quantum hardware, the quantum circuit corresponding to a quantum program of an end-user of the quantum hardware; and generate at least one control parameter corresponding to the quantum circuit by evaluating a control model during execution of the quantum circuit. In some aspects, the technologies disclosed herein relate to the foregoing computing system, further including compiling, based on the control model, the quantum circuit corresponding to the quantum program on a subset of the qubits included in the quantum hardware.

In some aspects, the technologies disclosed herein relate to a quantum information processing (QIP) system including: at least one processor; at least one memory device storing processor-executable instructions that, in response to being executed by the at least one processor, cause the QIP system at least to: execute a quantum circuit configured in a qubit register formed from qubits included in quantum hardware, the quantum circuit corresponding to a quantum program of an end-user of the quantum hardware; and generate at least one control parameter corresponding to the quantum circuit by evaluating a control model during execution of the quantum circuit.

In some aspects, the technologies disclosed herein relate to a computer-implemented method, including: obtaining observed data corresponding to a qubit register formed from qubits included in quantum hardware, wherein the observed data includes receiving one or more of qubit-based measurement data or side-channel measurement data; and generating, using the observed data, a control model that predicts at least one control parameter.

In some aspects, the technologies disclosed herein relate to a computing system including: at least one processor; at least one memory devices storing processor-executable instructions that, in response to being executed by the at least one processor, cause the computing system at least to: obtain observed data corresponding to a qubit register formed from qubits included in quantum hardware, wherein the observed data includes receiving one or more of qubit-based measurement data or side-channel measurement data; and generate, using the observed data, a control model that predicts at least one control parameter.

In some aspects, the technologies disclosed herein relate to a quantum information processing (QIP) system including: at least one processor; at least one memory devices storing processor-executable instructions that, in response to being executed by the at least one processor, cause the QIP system at least to: obtain observed data corresponding to a qubit register formed from qubits included in quantum hardware, wherein the observed data includes receiving one or more of qubit-based measurement data or side-channel measurement data; and generate, using the observed data, a control model that predicts at least one control parameter.

In some aspects, the technologies disclosed herein relate to a system, including: one or more processors configured to execute components stored in one or more memory devices, the components including, a first component that, in response to execution by the one or more processors, individually or in combination, causes generation of a second component, wherein the first component defines a native gate of quantum hardware including multiple qubits, and wherein the second component defines a configuration of hardware elements to implement the native gate, the configuration including a gate variant associated with the native gate, and an association between one or more control hardware elements and one or more target qubits of the multiple qubits.

In some aspects, the technologies disclosed herein relate to a quantum information processing (QIP) system including: quantum hardware configured to provide multiple qubits; and a classical computing system including: one or more processors configured to execute components stored in one or more memory devices, the components including, a first component that, in response to execution by the one or more processors, individually or in combination, causes generation of a second component, wherein the first component defines a native gate of quantum hardware including multiple qubits, and wherein the second component defines a configuration of hardware elements to implement the native gate, the configuration including a gate variant associated with the native gate, and an association between one or more control hardware elements and one or more target qubits of the multiple qubits.

In some aspects, the technologies disclosed herein relate to a device, including: a first processing unit functionally coupled with a second processing unit by a low-latency bus structure, the first processing unit configured to execute multiple components stored in memory, wherein the components include: a first component configured to, compile a quantum program, resulting in one or more hardware instructions, and send, via the second processing unit, towards quantum hardware, a first hardware instruction of the one or more hardware instructions; a second component configured to receive data responsive to the first hardware instruction; and a third component configured to update, based on the data, a control model; wherein the first processing unit, the low-latency bus structure, and the second processing unit are integrated into a module within the quantum hardware.

In some aspects, the technologies disclosed herein relate to a quantum information processing (QIP) system including: quantum hardware configured to provide multiple qubits; and control hardware configured to control operation of the multiple qubits, the control hardware including a device including: a first processing unit functionally coupled with a second processing unit by a low-latency bus structure, the first processing unit configured to execute multiple components stored in memory, wherein the components include: a first component configured to, compile a quantum program, resulting in one or more hardware instructions, and send, via the second processing unit, towards quantum hardware, a first hardware instruction of the one or more hardware instructions; a second component configured to receive data responsive to the first hardware instruction; and a third component configured to update, based on the data, a control model; wherein the first processing unit, the low-latency bus structure, and the second processing unit are integrated into a module within the quantum hardware.

In some aspects, the technologies disclosed herein relate to a computer-implemented method, including: obtaining a first error channel of quantum hardware; obtaining one or more temporal dependencies of respective calibration parameters corresponding to the quantum hardware; determining a second error channel based on the one or more temporal dependencies and a control model that defines a control state of the quantum hardware; executing, based on the first error channel and the second error channel, over a time interval, a simulation of a calibration circuit configured within a quantum register formed from at least one qubit included in the quantum hardware; and updating, based on results of the simulation, a control model.

In some aspects, the technologies disclosed herein relate to a computing system including: at least one processor; at least one memory devices storing processor-executable instructions that, in response to being executed by the at least one processor, cause the computing system at least to: obtain a first error channel of quantum hardware; obtain one or more temporal dependencies of respective calibration parameters corresponding to the quantum hardware; determine a second error channel based on the one or more temporal dependencies and a control model that defines a control state of the quantum hardware; execute, based on the first error channel and the second error channel, over a time interval, a simulation of a calibration circuit configured within a quantum register formed from at least one qubit included in the quantum hardware; and update, based on results of the simulation, a control model.

In some aspects, the technologies disclosed herein relate to a quantum information processing (QIP) system including: at least one processor; at least one memory device storing processor-executable instructions that, in response to being executed by the at least one processor, cause the QIP system at least to: obtain a first error channel of quantum hardware; obtain one or more temporal dependencies of respective calibration parameters corresponding to the quantum hardware; determine a second error channel based on the one or more temporal dependencies and a control model that defines a control state of the quantum hardware; execute, based on the first error channel and the second error channel, over a time interval, a simulation of a calibration circuit configured within a quantum register formed from at least one qubit included in the quantum hardware; and update, based on results of the simulation, a control model.

In some aspects, the technologies disclosed herein relate to a computer-implemented method, including: obtaining one or more temporal dependences of respective calibration parameters corresponding to quantum hardware, wherein a first temporal dependence of the one or more temporal dependences extends from an initial time to a terminal time, the first temporal dependence corresponding to a first calibration parameter of the respective calibration parameters; generating a predictive model of the first calibration parameter, wherein the predictive model is generated using at least the first temporal dependence; and determining, using the predictive model, for a time after the terminal time, a value of the first calibration parameter.

In some aspects, the technologies disclosed herein relate to a computing system including: at least one processor; at least one memory devices storing processor-executable instructions that, in response to being executed by the at least one processor, individually or in combination, cause the computing system at least to: obtain one or more temporal dependences of respective calibration parameters corresponding to quantum hardware, wherein a first temporal dependence of the one or more temporal dependences extends from an initial time to a terminal time, the first temporal dependence corresponding to a first calibration parameter of the respective calibration parameters; generate a predictive model of the first calibration parameter, wherein the predictive model is generated using at least the first temporal dependence; and determine, using the predictive model, for a time after the terminal time, a value of the first calibration parameter.

In some aspects, the technologies disclosed herein relate to a quantum information processing (QIP) system including: at least one processor; at least one memory device storing processor-executable instructions that, in response to being executed by the at least one processor, individually or in combination, cause the QIP system at least to: obtain one or more temporal dependences of respective calibration parameters corresponding to quantum hardware, wherein a first temporal dependence of the one or more temporal dependences extends from an initial time to a terminal time, the first temporal dependence corresponding to a first calibration parameter of the respective calibration parameters; generate a predictive model of the first calibration parameter, wherein the predictive model is generated using at least the first temporal dependence; and determine, using the predictive model, for a time after the terminal time, a value of the first calibration parameter.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which.

FIG. 1 illustrates a view of atomic ions a linear crystal or chain in accordance with aspects of this disclosure.

FIG. 2 illustrates an example of a quantum information processing (QIP) system in accordance with aspects of this disclosure.

FIG. 3 illustrates an example of a computer device in accordance with aspects of this disclosure.

FIG. 4 illustrates another example of a QIP system, in accordance with aspects of this disclosure.

FIG. 5A illustrates an example of an architecture for closed-loop calibration in accordance with aspects of this disclosure.

FIG. 5B illustrates a block diagram of another QIP system, in accordance with aspects of this disclosure.

FIG. 5C illustrates a block diagram of a subsystem that hosts an software interface, in accordance with aspects of this disclosure.

FIG. 6A illustrates an example of another QIP system, in accordance with aspects of this disclosure.

FIG. 6B illustrates a flow representation of an accelerated processing unit (APU) execution environment, including in-memory metamodel evaluation, in accordance with aspects of this disclosure.

FIGS. 7A-7D illustrate an example of a dual side-of-peak point check procedure, in accordance with aspects of this disclosure. Specifically, FIG. 7A illustrates correction as a function of steering offset after application of a defined number of GPi gates, where the steering offset can be changed arbitrarily in some cases; FIG. 7B P_{bright} as a function of frequency;

FIG. 7C illustrates P_{bright} after application of a defined number of GPi gates; and FIG. 7D illustrates two-point error signal as a function of beam displacement for the two example numbers of GPi gates shown in FIG. 7C.

FIG. 8 illustrates an example of P_{bright} as a function of beam displacement Δ (in units of the waist) from an ideal alignment, in accordance with aspects of this disclosure.

FIG. 9 illustrates an example of a simulation of closed-loop control, in accordance with aspects of this disclosure.

FIG. 10 illustrates an example of a technique for simulations in accordance with one or more embodiments of this disclosure.

FIG. 11 illustrates an example of a system to implement a technique for simulations in accordance with one or more embodiments of this disclosure.

FIG. 12 presents plots of schematic temporal dependencies of a first calibration parameter and a second calibration parameter, in accordance with one or more embodiments of this disclosure.

FIG. 13 is a schematic block diagram of a computing system in accordance with one or more aspects of this disclosure.

FIG. 14 is a flowchart of an example method for closed-loop control, in accordance with one or more aspects of this disclosure.

FIG. 15 is a flowchart of an example of a computer-implemented method for updating a control model based on simulations according to one or more embodiments of this disclosure.

FIG. 16 is a flowchart of another example of a method for updating a control model based on simulations according to one or more embodiments of this disclosure.

FIG. 17 is a flowchart of an example of a computer-implemented method for generating calibration parameters using a predictive model, in accordance with aspects of this disclosure.

### DETAILED DESCRIPTION

The present disclosure recognizes and addresses the issue of closed-loop control and calibration in quantum information processing (QIP) systems. It can be a formidable challenge to developing and deploy a QIP system that is capable of operating with high fidelity and high qubit count. For a fully connected qubit register, the number of unique gates scales quadratically with the number of qubits. This presents a serious challenge for calibration routines, which must track a large number of nominally independent parameters while simultaneously providing high system uptime to customers. Existing calibration approaches typically applied in QIP systems are not expected to scale satisfactorily.

In many control theory formulations, a closed-loop controller has (near-) continuous access to measurements about the state of the system. These measurements are used, perhaps in conjunction with a model of the system dynamics, to drive the state to a desired setpoint. In the context of a quantum calibration problem, “measurement” has one of two types: qubit-based measurements and side-channel measurements. Qubit-based measurements are simply measurements on the ions, which happen via a single-threaded measurement cycle defined by (cooling, state preparation, coherent operations, and detection). The output of a qubit-based measurement is a single bitstring representing the state of the qubit register after detection. Side-channel measurements can occur asynchronously with the qubit-based measurement cycle. These might describe open-loop processes, like an acousto-optic modulators (AOM) temperature monitor, or feed into a closed-loop process like stabilizing the power output of a laser. In general, qubit-based measurements are required at least for fine-tuning of the quantum computer, since any side-channel measurement necessarily produces an out-of-loop error signal with respect to the ion response that one attempts to stabilize. While aspects of this disclosure are described in terms of qubit-based measurements. The disclosure is not limited in that respect, and side-channel measurements also can be incorporate if they reduce qubit-based calibration overhead. In addition, some aspects of this disclosure related to qubit-based measurement/detection include partial measurement; that is, a measurement of only some qubits in a qubit register during a coherent-operations phase.

Further, each qubit-based measurement cycle can return a single bitstring representing the state of the qubit register after detection (or a measurement operation). Due to the probabilistic nature of the measurement, a single output bitstring does not contain much information about the quantum state of the qubit register. Hence, a double inference problem arises: From a measurement record (defined to be a sequence of bitstring outputs associated with a sequence of coherent programs), relevant properties of the underlying quantum state must be inferred, and subsequently, that information must be used to infer satisfactory (e.g., ideal or nearly ideal) control parameters to implement a desired gateset. Time spent acquiring information about the satisfactory control parameters necessarily reduces QIP system uptime, that is, time available to execute production quantum circuits (e.g., customer circuits). It is noted, simply for purposes of illustration, that for a QIP system to be calibratable, it needs to be possible to determine all elements of the control vector faster than the elements drift in time. As is used in this disclosure, the terminology “production quantum circuit” refers to a computation quantum circuit that is configured and executed for purposes other than calibration. Accordingly, in this disclosure, the terminology “production quantum circuit” and “computation quantum circuit” are used interchangeably, and both refer to a quantum circuit that is configured and/or executed for purposes different from the purpose of a calibration quantum circuit.

Aspects of the present disclosure, individually or in combination, provide a high-level architecture for closed-loop control that decomposes into a local feed-forward controller (or metamodel) that can determine satisfactory (e.g., optimal or ideal) control parameters at a particular point in time, and a control model generator module (also referred to as a control agent) that closes the feedback loop by tuning metamodel parameters to implement a desired gateset. The feed-forward controller can evaluate one or more control models continuously or nearly continuously, in that output of a control model can be readily evaluated at any timepoint on the real-time Input/Output (RTIO) timeline, while the control agent can have less bandwidth and less measurement precision because the control agent shares time on the qubits with every other process accessing a qubit register that includes at least some of the qubits. In this disclosure, RTIO refers to capturing instructions that occur, or are emitted, with precise timing relative to a system clock used to synchronize coherent operations on the qubits. Thus, aspects of the present disclosure decompose control into a predictive feed-forward component that can be active at fast timescales, but it can be steered at slower timescales by a closed-loop control agent. The strategy employed by the closed-loop control agent can be as complex as necessary to meet calibration and throughput objectives of a given QIP system. Accordingly, aspects of the present disclosure address the inherent measurement accuracy and bandwidth limitations imposed by single-threaded access to the qubit register.

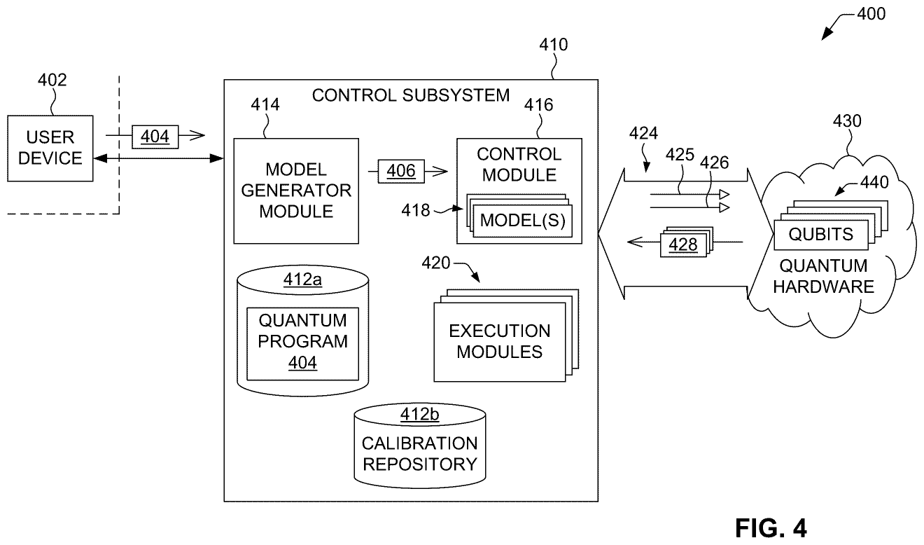

In the present disclosure, coherent control parameters can be driven by time-dependent control models of the form ƒ_{{w}}(t) and/or ƒ_{{w}}(t, s). The weights {w} are determined by the control agent, which also can model the confidence level on the accuracy of each metamodel output (e.g., a control parameter and/or a weight defining a control parameter). The parameter s represents a value of side-channel sensor data at time t. It is noted that while ƒ_{{w}}(t, s) is shown as being dependent on a single parameter s, the disclosure is not limited in this respect. Indeed, in some cases, the control models can be of the form ƒ_{{w}}(t, s₁, s₂ . . . , s_{K}), where K is a natural number greater than unity and s_{λ} (λ=1, 2 . . . . K) represents a value of side-channel sensor data generated by a sensor device 1, at time t. In this way, a time-dependent control model (or metamodel) can incorporate additional real-time sensor information that may correlate with one or more desired calibration parameters. The control agent can request measurement data from quantum hardware that constitutes a QIP system, to improve an internal model of one or more control parameters, and also improve the overall calibration “health” of the system can be simulated via the modeled calibration uncertainty across all relevant calibration parameters. It is noted that, in some cases, this information also can be used by a compiler subsystem to optimize circuit mappings, or the compiler subsystem (not depicted in FIG. 4) can request certain calibration parameter distributions to be refined in order to improve performance on certain circuits. The control agent can dynamically adjust the time spent on calibration tasks relative to customer jobs (also referred to as production jobs) in order to maintain some baseline performance while maximizing customer throughput.

Aspects of the present disclosure also can support offline simulation of control agents and can decouple implementation details. To that end, aspects of the present disclosure provide an abstraction layer or interface between the control agents and lower-level hardware APIs. Thus, aspects of the present disclosure can enable flexible design and validation of control strategies independently of the control platform and physical hardware pertaining to a QIP system.

The closed-control loop approach and architecture in accordance with this disclosure provides a tangible improvement to the technological field of quantum information processing (QIP). Indeed, aspects of the present disclosure can reduce the dimensionality of a control vector via known physical relationships (which can be determined a priori) and/or empirically determined correlations. In addition, aspects of the present disclosure can parameterize the control vector to separate drift timescales. Specifically, a parameterization can be determined in which only a few quantities change quickly while all others change slowly. Aspects of the present disclosure also can increase the sensitivity of calibration measurements using targeted ideas from diagnostic tomography. Further, aspects of the present disclosure can dynamically adjust a rate of calibration measurement based on observed system drift, and leverage open-loop predictive modeling of the calibration state where possible. Furthermore, in QIP systems based on trapped-ion qubits, aspects of the present disclosure can parallelize calibration quantum circuits in order to take advantage of fixed overhead in the ion measurement cycle. Still further, aspects of the present disclosure can dynamically shape the system duty cycle to reduce back-action from calibration measurements and other context-dependent drifts.

The closed-loop control approach in accordance with this disclosure can be applicable to multiple types of QIPs and qubit technologies. While various aspects of the closed-loop control approach are described with reference to a QIP system based on trapped-atom qubits, the disclosure is not limited in that respect. Indeed, the error-mitigation approach in accordance with this disclosure can be used in other types of QIP systems based on solid-state qubits. Additionally, while described with reference to qubits, the error-mitigation approach of this disclosure can in some cases be implemented for other types of quantum devices, such as qudit devices.

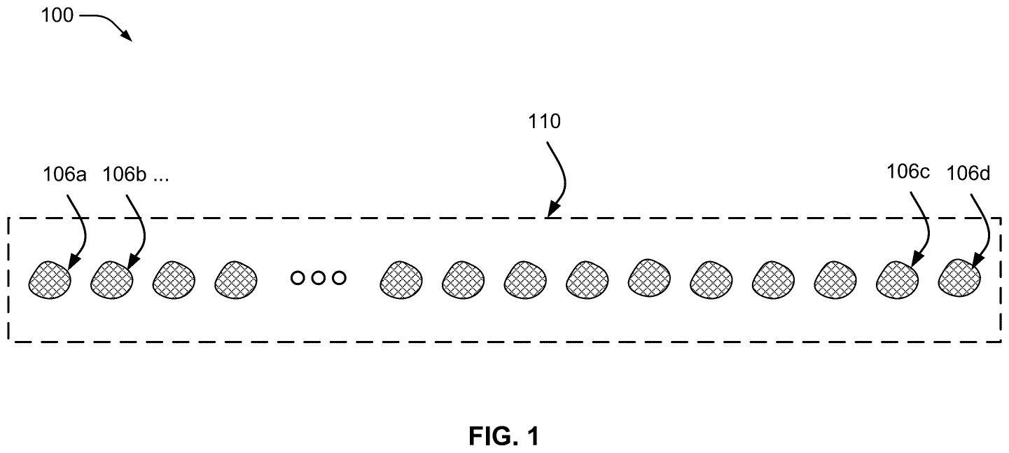

Solutions to the issues described above are explained in more detail in connection with FIGS. 1-16, with FIGS. 1-3 providing some concepts pertaining to QIP systems or quantum computers, and more specifically, of atomic-based QIP systems or quantum computers.

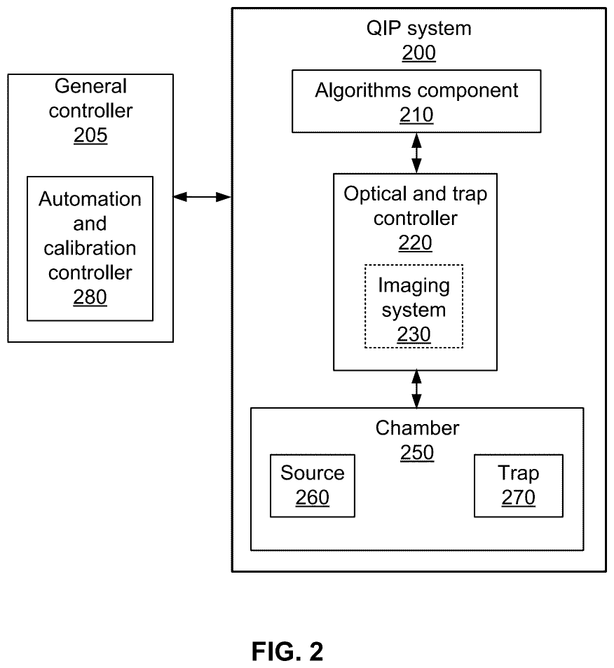

FIG. 1 shown below illustrates a diagram 100 with multiple atomic ions 106 (e.g., atomic ions 106a, 106b, . . . , 106c, and 106d) trapped in a linear crystal or chain 110 using a trap (the trap can be inside a vacuum chamber as shown in FIG. 2). The trap maybe referred to as an ion trap. The ion trap shown may be built or fabricated on a semiconductor substrate, a dielectric substrate, or a glass die or wafer (also referred to as a glass substrate). The atomic ions 106 may be provided to the trap as atomic species for ionization and confinement into the chain 110.

In the example shown in FIG. 1, the trap includes electrodes for trapping or confining multiple atomic ions into the chain 110 that are laser-cooled to be nearly at rest. The number of atomic ions (N) trapped can be configurable and more or fewer atomic ions may be trapped. The atomic ions can be Ytterbium ions (e.g., ^{171Yb+} ions), for example. The atomic ions are illuminated with laser (optical) radiation tuned to a resonance in ^{171Yb+} and the fluorescence of the atomic ions is imaged onto a camera or some other type of detection device. In this example, atomic ions may be separated by about 5 microns (μm) from each other, although the separation may be smaller or larger than 5 μm. The separation of the atomic ions is determined by a balance between the external confinement force and Coulomb repulsion and does not need to be uniform. Moreover, in addition to atomic Ytterbium ions, neutral atoms, Rydberg atoms, different atomic ions or different species of atomic ions may also be used. The trap may be a linear RF Paul trap, but other types of confinement may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

FIG. 2 shown below is a block diagram that illustrates an example of a QIP system 200 in accordance with various aspects of this disclosure. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations.

Shown in FIG. 2 is a general controller 205 configured to perform various control operations of the QIP system 200. Instructions for the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200.

The QIP system 200 may include an algorithms component 210 that may operate with other parts of the QIP system 200 to perform quantum algorithms or quantum operations, including a stack or sequence of combinations of single qubit operations and/or multi-qubit operations (e.g., two-qubit operations) as well as extended quantum computations. The algorithms component 210 may also include software tools (e.g., compilers) that, individually or in combination, permit or otherwise facilitate such performance or implementation. As such, the algorithms component 210 may provide, directly or indirectly, instructions to various components of the QIP system 200 (e.g., to the optical and trap controller 220) to enable the implementation of the quantum algorithms or quantum operations. The algorithms component 210 may receive information resulting from the implementation of the quantum algorithms or quantum operations and may process the information and/or transfer the information to another component of the QIP system 200 or to another device for further processing.

The QIP system 200 may include an optical and trap controller 220 that controls various aspects of a trap 270 in a chamber 250, including the generation of signals to control the trap 270, and controls the operation of lasers and optical systems that provide optical beams that interact with the atoms or ions in the trap. When used to confine or trap ions, the trap 270 may be referred to as an ion trap. The trap 270, however, may also be used to trap neutral atoms, Rydberg atoms, different atomic ions, or different species of atomic ions. The lasers and optical systems can be at least partially located in the optical and trap controller 220 and/or in the chamber 250. For example, optical systems within the chamber 250 may refer to optical components or optical assemblies.

The QIP system 200 may include an imaging system 230. The imaging system 230 may include a high-resolution imager (e.g., CCD camera) or other type of detection device (e.g., photomultiplier tube or PMT) for monitoring the atomic ions while they are being provided to the trap 270 and/or after they have been provided to the trap 270. In an aspect, the imaging system 230 can be implemented separate from the optical and trap controller 220, however, the use of fluorescence to detect, identify, and label atomic ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of a processor or processing portion of the QIP system 200. That is, the trap 270 may be considered at the core of the processing operations of the QIP system 200 since it holds the atomic-based qubits that are used to perform the quantum operations or simulations. At least a portion of the source 260 may be implemented separate from the chamber 250.

It is to be understood that the various components of the QIP system 200 described in FIG. 2 are described at a high-level for case of understanding. Such components may include one or more sub-components, the details of which may be provided below as needed to better understand certain aspects of this disclosure.

Aspects of this disclosure may be implemented at least partially using the general controller 205, the automation and calibration controller 280, and/or the algorithms component 210.

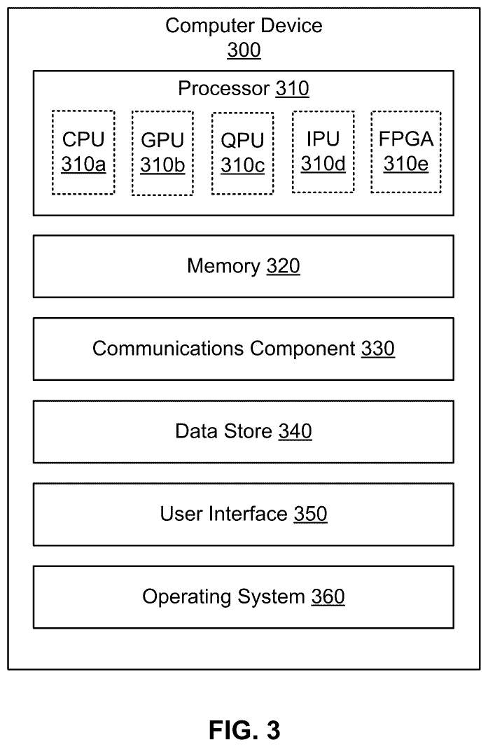

FIG. 3 illustrates an example of a computer system or device 300 in accordance with aspects of the disclosure. The computer device 300 can represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single or multiple set of processors or multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300).

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

FIG. 4 illustrates an example of a QIP system in accordance with aspects of this disclosure. The example QIP system 400 shown in FIG. 4 includes a control subsystem 410 that can receive a quantum program 404 from a computing device 402 that is remotely located relative to the example QIP system 400 and is functionally coupled (e.g., communicatively coupled) to the control subsystem 410. The computing device 402 can send data defining the quantum program 404 for execution in quantum hardware 430. As is indicated by dashed lines, the computing device 402 can be external to the example QIP system 400. For example, the computing device 402 can be a user device (e.g., a classical computer) of an end-user of the QIP system 400. The end-user can be a customer of the QIP system 400. The control subsystem 410 can retain the quantum program 404 in one or more memory devices 412a (collectively referred to as memory 412a). The quantum program 404 corresponds to a defined quantum computation. The defined quantum computation can be an n-qubit computation, for example. The quantum program 404 can include a quantum circuit (and, in some cases, sub-circuits) representing a quantum algorithm associated with the quantum computation. Examples of the quantum algorithm include a variational quantum algorithm, a machine-learning algorithm, a Fourier transform algorithm, or the like.

The control subsystem 410 can be functionally coupled to quantum hardware 430 via multiple links 424 that permit the exchange of data and/or control signals between the control subsystem 410 and the quantum hardware 430. The quantum hardware 430 can embody, or can include, one or more quantum computers. In some cases, the quantum hardware 430 embodies a cloud-based quantum computer. In other cases, the quantum hardware 430 embodies, or includes, a local quantum computer. Regardless of its spatial footprint, the quantum hardware 430 includes multiple qubits 440 arranged in a particular layout. Each qubit of the multiple qubits 440 can be coupled to an environment and/or to one another. Such coupling(s) decoheres and relaxes quantum information contained in the qubit. Thus, the quantum hardware 430 can be noisy.

The multiple links 424 can include communication links (wireless link(s) and/or wireline link(s)) and functional elements within the quantum hardware 430. The functional elements can constitute a control network that, in combination with the communication links, permit functionally coupling the control subsystem 410 to the multiple qubits 440. Such functional elements include one or more processing devices (e.g., embedded controller device(s)) and other equipment functionally coupled therewith. Accordingly, the type of the multiple links 424 can be based on the type of qubits 440 used by the quantum hardware 430 for computation. In some cases, the multiple links 424 can include wireline links, optical links, or a combination thereof. In other cases, the multiple links 424 can include microwave resonator devices or microwave transmission lines, or a combination of both.

In trapped-atom architectures, the multiple qubits 440 include atomic qubits assembled in a trapping apparatus. Thus, the atomic qubits can be referred to as trapped-atom qubits. In some cases, each one of the atomic qubits can be a neutral atom. In other cases, each one of the atomic qubits can be an ion, such as an Ytterbium ion, a calcium ion, a barium ion, or similar ions. The trapped-atom qubits can be confined within an ion-trap (e.g., the trap 270 (FIG. 2) and can be assembled in a linear arrangement (such as the linear crystal or chain 110 (FIG. 1)). Trapped-atom qubits are individually addressable by a laser beam. In such architectures, the quantum hardware 430 includes functional elements comprising atom source(s), laser devices, electrodes, and other equipment that permit assembling the multiple qubits 440 within the trapping apparatus. In other architectures, the multiple qubits 440 can include solid-state devices of one of several types. Such devices can be embodied in, for example, Josephson junction devices, semiconductor quantum-dots, defects in a semiconductor material (such as vacancies in Si and Ge, or nitrogen-vacancy centers in diamond or silicon carbide), or electron spin centers in semiconductors (doped or intrinsic). Superconducting qubits and spin qubits can be individually addressable by microwave electromagnetic radiation.

The control subsystem 410 can include a single computing device or a system of computing devices. Each one of the computing devices can have the architecture of the computer device 300 (FIG. 3) for example. The system of computing devices can be distributed, in some cases, and includes various computing resources that permit hosting and executing one or more execution modules 420 to cause the execution of the quantum program 404 in the quantum hardware 430, via the multiple qubits 440. The system of computing devices also can host and execute the model generator module 414 and the control module 416. In some cases, modules and other components that form the control subsystem 410 can be hosted by the computer device 300 (FIG. 3).

At each time tᵢ, the control subsystem 410 can determine whether to (a) schedule a particular customer job (or production quantum circuit) to execute in the quantum hardware 430, (b) schedule a particular calibration quantum circuit to execute in the quantum hardware 430, or (c) update metamodel weights. The control model generator module 414 (also referred to as control agent) (optionally in conjunction with some additional circuit scheduling logic, in some cases) can perform such a determination by optimizing an objective function, e.g., maximizing customer job throughput while maintaining confidence that the job quality is above some threshold. Because various approaches can be implemented in order to decompose such an objective into a control strategy, the control subsystem 410 can support rapid design, testing, and iteration of various strategies.

The control subsystem 410 decomposes closed-loop control into a control module 416 (which may be referred to as a metamodel or feed-forward controller) updated by a control model generator module 414 (or control agent, as mentioned). In this way, in sharp contrast to existing QIP technologies, the control subsystem 410 can overcome bandwidth limitations imposed by a slow qubit-based measurement cycle.

The control model generator module 414 can generate a control model using measurement data 428 received form the quantum hardware 430. In some cases, the control model generator module 414 can generate the control model using synthetic data generated by a simulation subsystem executing a simulation of quantum hardware 430. The synthetic data representing a prediction of measurement data. The control model, in some cases, is defined by a time-dependent function that is parameterized by a group of weights. In other cases, the control model is defined by a time-dependent function that is parameterized by a group of weights and has a domain that includes side-channel measurement values. In yet other cases, the control model is defined piecewise by at least a first time-dependent function that is parameterized by a first group of weights in a first time interval and a second time-dependent function that is parameterized by a second group of weights in a first time interval.

To obtain measurement data 428 from the quantum hardware 430, the control subsystem 410, via the control model generator module 414, can send one or more qubit measurement circuits (collectively represented by an arrow 425 in FIG. 4). The qubit measurement circuits (also referred to as calibration quantum circuits) can be designed to maximize sensitivity to a desired calibration parameter. Such circuits can be designed using principles of diagnostic QCVV (quantum characterization, validation, and verification) where particular errors or parameters of a gate can be amplified. The control model generator module 414 can generate the qubit measurement circuit(s) in several ways. For example, the control model generator module 414 can use a black-box optimizer, which optimizer can simulate data via a model of the quantum hardware 430 and can vary different combinations of qubit measurement circuits in order to optimize sensitivity to a particular control parameter of such model (that is, the control parameter being calibrated) and also can minimize sensitivity to other control parameters. In some cases, these circuits can be known from other contexts such as quantum tomography or diagnostic QCVV, including Gate Set Tomography for example.

To generate the control model, the control model generator module 414 can obtain measurement data (or observed data) corresponding to a qubit register formed from qubits included in quantum hardware. The observed data comprises receiving one or more of qubit-based measurement data or side-channel measurement data. The qubit-based measurement data can define one or more bitstrings representative of respective states of a qubit register formed from all or a subset of the qubits 440. The side-channel measurement data can define a state of a classical device. In some configurations, obtaining the observed data can include determining a solution to an optimization problem with respect to an objective function. The solution can define a time interval to obtain the observed data. Obtaining the observer data also can include causing execution of one or more calibration tasks during the time interval.

The control model generator module 414 can then generate, using the observed data, a control model. The control model corresponds to a feed-forward controller. In some cases, the control model can correspond to one of a PID controller, a PIID controller, a controller based on arbitrary closed-loop transfer functions, a linear quadratic regulator (LQR) controller, a model predictive controller, a controller based on a Kalman or Information filter, a Linear Quadratic Gaussian (LQG) controller, an adaptive controller, state observers, a controller trained via neural networks and/or other machine learning techniques, a controller based on robust control techniques, a controller based on stochastic control techniques, or the like. Regardless of the type of controller that the control mode corresponds to, the control model can predict at least one control parameter. In some implementations, the control model also can predict respective scores for the at least one control parameter, each one of the respective scores can represent an estimate of a confidence level on an accuracy of a respective predicted control parameter. In some cases, generating the control model can include training, using the observed data, a machine-learning model. In other cases, generating the control model can include fitting a compact physical model. In yet other cases, generating the control model comprises generating a regression model.

The control subsystem 410, via the control model generator module 414, can determine that an update criterion is satisfied and, in response, can send a request for additional observed data. Based on additional observed data that have been received, the control model generator module 414 can update the control model. The control subsystem 410 can include a scheduler subsystem to schedule and cause execution of circuits. For example, at least one of the execution modules 420 can form the scheduler subsystem. The scheduler subsystem can communicate (via function call or other methods, for example) with the quantum hardware 430. The control model generator module 414 can send the request for additional observer data to the scheduler subsystem. The scheduler subsystem can itself be responsible for generating the precise sequence of control signals to be sent to the quantum hardware 430. In the alternative, the scheduler subsystem can pass an abstract representation of the circuit to another subsystem (such as an embedded controller device within the quantum hardware 430) which can be responsible for generating the control signals and interfacing directly with the quantum hardware 430.

As mentioned, the control subsystem 410 can execute, or can cause execution of, a quantum circuit configured in a qubit register formed from the qubits 440 included in the quantum hardware 430. The quantum circuit can correspond to a quantum program of an end-user of the quantum hardware 430. Such a quantum circuit is represented by an arrow labeled 426 in FIG. 4. One or more of the execution modules 420 can cause the quantum circuit to be execute in the quantum hardware 430. The control module 416 can generate at least one control parameter corresponding to the quantum circuit by evaluating a control model (e.g., one of the model(s) 418) during execution of the quantum circuit. As is described herein, the control module 416 can evaluate the control model at a time corresponding to a timestamp an instruction of the quantum program is executed in the quantum hardware 430. As is described herein, in some cases, the control model corresponds to one of a PID controller, a linear quadratic regulator (LQR) controller, or a model predictive controller.

Depending on the form of the control model, the control module 416 also can generate scores for the at least one control parameter by applying the control model. Each one of the scores can represent an estimate of a confidence level on accuracy of a respective control parameter as yield by the application of the control model. An accuracy of a control parameter can determine the suitability of the control parameter in a calibration cycle. It is noted that the exact form of the scores can vary. In one case, a score quantifies or indicates whether use of the control model is justified and can thus continue, or whether additional calibration measurements are warranted, based on the score being less than threshold score (which can be configurable). In another case, each control parameter can be modeled as a probability distribution. That is, the control model(s) 418 generated by the model generator 414 have determined, individually or collectively, a distribution of parameters values that may be correct with a defined probability, and the QIP system 400 (and the quantum hardware 430 in particular) uses the value that is most likely to be correct. Yet, it can be simulated what would happen if that control parameter had a different value, as described by the distribution of parameter values. If the variance of the distribution is large and exceeds a defined threshold, then the control agent can cause the control subsystem 410 to perform additional calibration measurements to update the distribution of possible parameter values. Such an update can result in the reduction of the variance and can yield a better estimate of the true value of a control parameter.

In some implementations, a circuit compiler subsystem (not depicted in FIG. 4) can compile, based on the control model, the quantum circuit (e.g., production circuit 426) on a on a subset of the qubits included in the quantum hardware. To that end, the circuit compiler subsystem can determine how to decompose a high-level representation of the quantum circuit into native gates that can be executed on the quantum hardware 430. The circuit compiler subsystem can have access to the scores (or parameter distributions) that can be generated by the control module 416 using a control model (which is a byproduct of the modeling performed by the control agent). The circuit compiler subsystem can then use such information to select a decomposition into native gates that can provide a satisfactory performance (e.g., optimal overall performance or a performance that satisfies a defined performance quality metric). For example, if a particular qubit is involved with a calibration parameter that has a large uncertainty (e.g., low score), the circuit compiler subsystem can determine that the particular qubit is to be omitted when the circuit compiler subsystem decomposes the quantum circuit into native gates.

In some configurations, the control subsystem 410 can determine that an update rule is satisfied for a quantum circuit (e.g., production circuit 526). The update rule can be based on performance of the quantum circuit in the quantum hardware. The control subsystem 410 can cause, via the control module 416, the control model generator module 414 to update the control model. Updating the control model can include updating a prediction of a first control parameter of the at least one control parameters.

In addition, or in some configurations, the control subsystem 410 can generate an event-based interrupt corresponding to the quantum hardware 430, and also can cause, in response to the event-based interrupt, a model generator module to update the control model. A general class of event-based interrupts can include changes in the QIP system state that are coupled to a control parameter model (e.g., one of the model(s) 418) or changes to auxiliary control parameters not directly controlled by an instance of the control model generator module 414 (e.g., an instance of a control agent), but that might influence the model or strategy of a given instance of control agent.

For quantum hardware 430 that includes an ion trap (e.g., trap 270 (FIG. 2)), an example of an event-interrupt is initiation of a dark-ion clearing routine, where an ion ends up in a long-lived metastable (dark) state, e.g., the F-state in Ytterbium, and a routine in the QIP system 400 is employed to return the ion to proper qubit states. Such a routine may involve shining a high-power laser at the ion, which could change the background stray field environment due to charge buildup.

For quantum hardware 430 having neutral atoms embodying the multiple qubits 440, an example of an event-interrupt is an indication that the qubit array is to be reloaded (this can occur periodically, for example). Similar type of event-interrupt can be present in quantum hardware 430 that involves NV defect centers or superconducting systems that periodically execute calibration tasks on their microwave control electronics. Additional, in such type of hardware the control subsystem 410 may determine some early-stage calibration is no longer valid, and in response, can issue an event-interrupt.

For quantum hardware 430 having spin qubits, a charge jump event can constitute an event-interrupt. For quantum hardware 430 having superconducting qubits, a quasiparticle poisoning event can constitute an event-interrupt.

As is described herein, the control model generator module 414 can reduce calibration overhead by parameterizing the control vector in a way that separates drift timescales. More specifically, the control model generator module 414 can determine a parameterization in which some quantities change quickly and other quantities change slowly. The control model generator module 414 can determine a parameterization in a several ways. For example, the control model generator module 414 can identify an initial parameterization (e.g., a I parameterization) of the controls, where each element of the parameterization corresponds to a separate calibration parameter. The control model generator module 414 can apply one or more mathematical methods to transform the initial parameterization in order to find an equivalent parameterization where one or more calibration parameters do not need to be updated as frequently as one or more other calibration parameters. Simply as an illustration, in some cases, the “qubit frequency” for each one of the multiple qubits 440 is to be determined. An I parameterization can involve N separate “qubit frequency” calibration parameters for each of N qubits. However, the control model generator module 414 can equivalently determine a parameterization as a single “common qubit frequency” and N individual “delta qubit frequency” parameters (for each qubit). In the second representation, the “delta qubit frequency” parameters do not change very much, while the “common qubit frequency” parameter changes more rapidly. Although the “common qubit frequency” changes more rapidly, still a single value is to be determined, whereas in the I parameterization, each one of the N “qubit frequency” parameters is to be determined individually. A transformation from a first parameterization to a second parameterization can be performed by applying one or a combination of mathematical methods, such as principal component analysis, dynamic mode decomposition, balanced truncation, Krylov subspace methods, proper orthogonal decomposition, or other model order reduction methods, or a combination of the foregoing, for example.

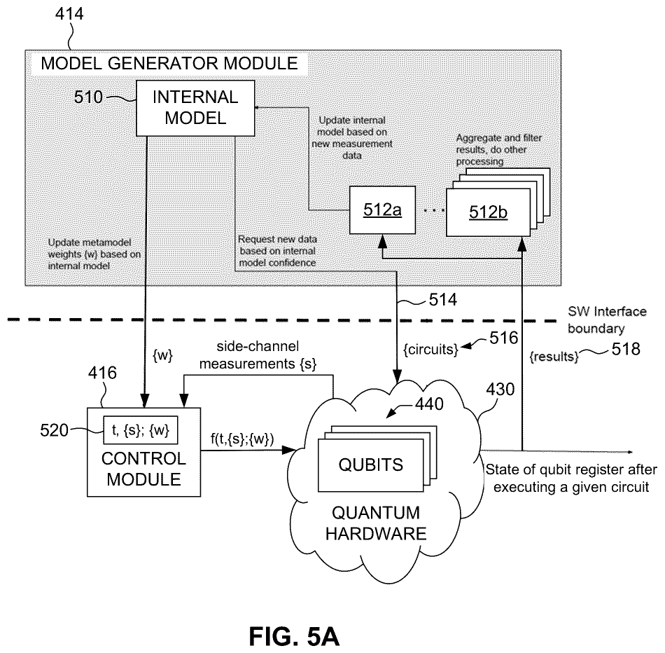

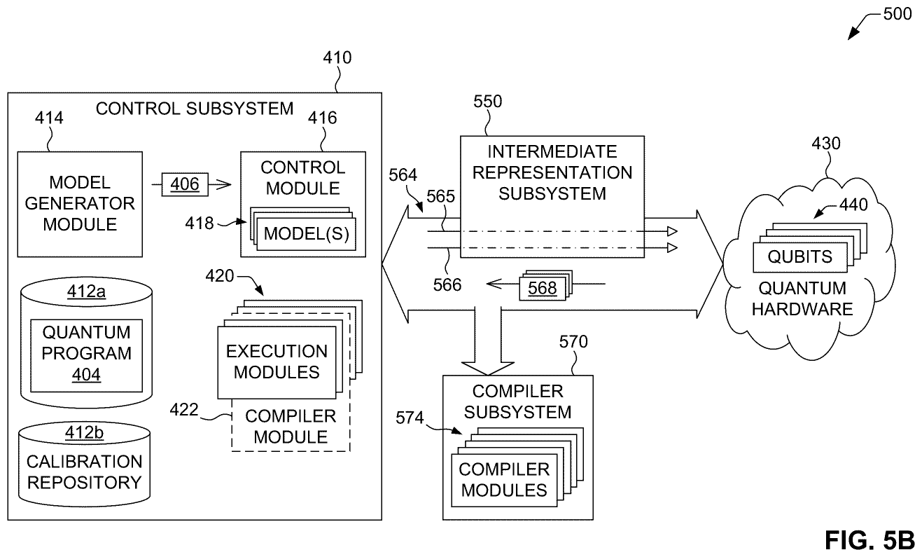

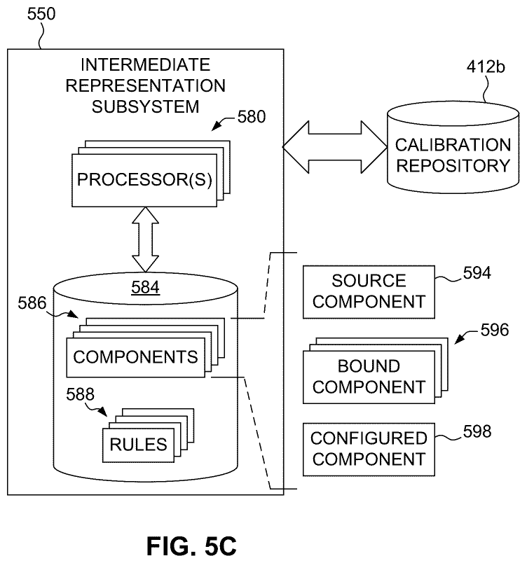

In some configurations, the control model generator module 414 and the control module 416 can be separated by a distinct interface or boundary (represented as a dashed line in FIG. 5A). Such an interface can be embodied in a software interface that the control model generator module 414 (or control agent) can be configured to use to interact with the quantum hardware 430. The software interface can be referred to as an intermediate representation interface. As is described in greater detail below, the software interface is formed by or includes multiple computer-accessible components (or computer-accessible objects) retained in one or more memory devices. A computer-accessible component can be a computer-readable component or a computer-executable component, or both. The control model generator module 414 can use the intermediate representation interface by executing or causing to execute at least one of the computer-accessible components.

The control model generator module 414 (or other control agents) can schedule calibration programs to be executed via an intermediate representation interface, collect results, and set parameters of the various metamodels. In some cases, the intermediate representation interface is meant to be, or include, some format representing the desired control signals, but in a “compressed” form that might also retain some context about the intent. For example, a low-level hardware representation of a control signal might be a timeseries analog signal sampled at 1 Gsps. That signal, however, may be compactly represented by saying “a sinusoid at 200 MHZ, starting phase 0, amplitude 0.5, and duration 10 microseconds” (this would be one example form of an intermediate representation).

In addition, or an alternative, an intermediate representation might be “Do a GPi gate on qubit 4, but offset the qubit frequency by 1 Hz”. In this disclosure, a GPi gate is a single-qubit gate representing a π pulse. That is, the GPi gate causes a state to rotate by π radians. In some implementations, the GPi gate is a native gate. By using an intermediate representation interface, the control subsystem 410 can be simplified relative to existing control systems in QIP systems. More specifically, the control agent need not be concerned about how to implement a GPi gate (that is the domain of the hardware control platform, e.g., at least some of the execution modules 420), but instead the control agent communicates via an intermediate representation interface that might be comprised of particular quantum operations (for example, gates) and overrides/offsets to particular calibration values. The disclosure is, of course, not limited in that respect, and the control agent may also have access to lower-level components and/or higher-level components in a software stack.

By implementing a control agent that is independent of other parts of the architecture of the control subsystem 410 and can communicate across a well-defined interface, the complexity of the implementation of the control subsystem 410 can be reduced. Further, in such an implementation, different control agents can be cleanly simulated using a common simulation subsystem. Then, in a software implementation, the same control agent code can be deployed onto actual hardware, thus simplifying the testing of control agents independently of hardware details, for example.

In addition, or in some configurations, the control module 416 (or metamodel) can be updated directly on an embedded (or similar) control system, according to logic determined by the control agent and/or other system design. As a result, a higher bandwidth connection to the metamodel functions can be made available when needed by a particular calibration. More specifically, for some control agents (e.g., a PID controller) updates to the control model (e.g., one of the model(s) 418) can be readily computed. In this case, an embedded controller (which might not have significant computational bandwidth or resources) can still implement the control agent without sacrificing performance. In this way, updates to the control model could happen synchronously with the qubit measurement cycle, because the (embedded) hardware control system does not need to send data back to a higher-performance computer (e.g., a server device that hosts the model generator 414) and wait for a response. The PID controller is just one such example; other control strategies also may be computationally straightforward and also can be implemented on the embedded controller.

In addition, or in some configurations, a simulation/emulation subsystem can assess the overall calibration state of the QIP system 400 via simulations/emulations, using individual models of each calibration parameter and model uncertainties. The simulations are computational models designed to emulate the quantum hardware 430. In some cases, the simulations can be based on some machine learning methods and/or can be developed from physical models based on engineering designs or testbench data about individual subsystems. Based on a set of control parameters and a system model that describes the behavior of the quantum hardware 430, the performance of a particular quantum circuit may be simulated. Additionally, or as alternative, the result of some relevant benchmark characterizing the overall performance of the quantum hardware 430 also can be simulated.

In addition, or in some configurations, the control subsystem 410 can dynamically shape the duty cycle of the QIP system 400 to reduce back-action from calibration measurements and other context-dependent drifts. In this way, the control subsystem 410 can address the issue of the changing duty cycle of different subcomponents resulting in the changing of satisfactory (e.g., ideal) value of various calibration parameters. Reducing such back-action can be accomplished in one or a combination of ways. In one example, calibration measurements can be interleaved sporadically alongside customer circuits (also referred to as production quantum circuits), to avoid switching contexts between calibration quantum circuits and customer circuits. In another example, the order in which customer circuits are executed can be adjusted to reduce the variance in duty cycle between circuits, thereby reducing calibration drift due to fast-changing duty cycles.

### Example Architectural Aspects

As mentioned, the present disclosure provides a high-level architecture for closed-loop control that decomposes into a local feed-forward controller 416 (generically referred to as metamodel) that can determine satisfactory (e.g., optimal or ideal) control parameters at a particular point in time, and a control model generator module 414 (or control agent) that closes the feedback loop by tuning metamodel parameters to implement a desired gateset. The feed-forward controller 416 can evaluate one or more control models 418 continuously or nearly continuously, in that output of the feed-forward controller 416 can be readily evaluated at any timepoint on the RTIO timeline, while the control agent can have less bandwidth and less measurement precision because it must share time on the multiple qubits 440 with every other process accessing a qubit register that includes at least some of the multiple qubits 440. FIG. 5A illustrates this decomposition. More specifically, FIG. 5A illustrates an example of architecture for closed-loop calibration in accordance with aspects of this disclosure. As is described herein, the control module 416 (which also may be referred to as feed-forward controller 416) can supply a control parameter to the quantum hardware 430. To that end, the control module 416 can evaluate a control model 520 that can be defined by a set of weights {w} and/or a set of values {s} originating from side-channel measurements by one or more sensor devices, which set(s) are used to calculate the control parameter at arbitrary time t. A model generator 414 (or closed-loop control agent) can determine how to update the weights and when to request new measurements from the quantum hardware 430 based on an internal model 510 of calibration parameter. As an illustration, the model generator 414 can use various techniques to track the estimated parameter distribution in time. For example, the model generator 414 (or closed-loop control agent) can request new measurements in order to update the internal model 510 periodically or according to a defined schedule, such that performance of the control subsystem 410 can be maintained above a satisfactory threshold. To request new measurements, the model generator 414 can cause the quantum hardware 430 to execute calibration circuits 516. To that end, the model generator 414 can use the control module 416 (not depicted in FIG. 5A) to direct the quantum hardware 430 to perform one or multiple shots 514. In response to execution of the calibration circuits 516, the quantum hardware 430 can return or otherwise supply results 518. The model generator module 414 can include an update component 512a that can receive the results 518 and can update the internal model 510 based on the results 518 (or measurement data). The model generator module 414 also can include one or more analysis components 512b that can operate on the results 518 (or measurement data) to generate aggregated data, apply one or more filters, and similar operations. The model generator module 414 can update, based on the updated internal model 510, metamodel weights {w} of a control model 520 (or metamodel). In some cases, the model generator module 414 can update the control model 520 via the update component 512a or another component that is part of the model generator module 414.

As an illustration, in some cases, the internal model 510 has two parameters: a calibration parameter u, and the uncertainty in that calibration parameter σᵤ. The update component 512a can updates to the internal model 510 via a Kalman filter, applied to the results 518. As a result, u and σᵤ are updated. Continuing with the illustration, the control model 520 can have a single weight w₀. Such a weight can be considered equal to the calibration parameter u of the internal model 510. The update component 512a can implement an update to the control model 520 via a function call (e.g., an API call) across the software interface boundary shown in FIG. 5A. Such an approach to updating a weight can be applied to metamodels having more than one weight.

### Example Software Architecture

The control subsystem 410 can be embodied, or can include a computing device or a system of computing devices that can implement the control model generator module 414, the control module 416, and the execution modules 420 according to a desired software architecture. Various aspects of the desired software architecture can support the implementation of closed-loop calibration according to the architecture of the control subsystem 410 discussed in connection with FIG. 4.

More specifically, in one aspect, the software architecture provides a mechanism to introspect executing control agent processes, to understand what operations one or more of such processes are performing and the reason(s) why the process(es) perform such operations.

In addition, or in another aspect, the desired software architecture can enable control agent development to occur in a simulation environment, with seamless deployment to real QIP systems for validation.

In addition, or in yet another aspect, to support independent Automation & Calibration workstreams and easy interface with simulation, the logic of the control model generator module 414 (or control agent) should be separate from any particular implementation of a control platform and/or RTIO hardware. For example, if the architecture of the control subsystem 410 changes and/or there is a remapping of physical hardware output channels, it should not be necessary to update an implementation of closed-loop control routines performed by the model generator 414 and/or the control module 416. Accordingly, the control subsystem 410 can include an abstraction layer or interface between control agents and lower-level hardware APIs. In some cases, such an abstraction layer and interface can be provided by simple extensions to an intermediate representation interface and associated formats or levels as is described herein. It is noted that, in some cases, control agents can be implemented as capabilities in the binary of the control platform.

In addition, or in still another aspect, for general introspection and debugging, it is desirable to have access to a mechanism (computational or otherwise) to capture what was actually executed on the quantum hardware 430 and the reason(s) for executing it on the quantum hardware 430. Such a mechanism can involve tracing breadcrumbs from abstract representations (e.g., “run a GPi gate on qubit_1”) down to what was executed on each AWG channel (e.g., “we emitted these instructions with these phases on these channels, because we were doing a coprop SK1 sequence using this beam context”).

In addition, or in a further aspect, some events (such as chain loss) can cause discontinuities in certain control parameters. Thus, closed-loop control agents can have access to such events in order to update their models accordingly. In this disclosure, as is described herein, a closed-loop control agent (or control agent) refers to a control model generator module that can be implemented in software, hardware, or a combination of software and hardware.

Further, the control subsystem 410 also can rely on or other use some scientific computing tools that are readily available in Python and/or other high-level programming languages. Examples of such tools include numpy/scipy/lmfit/pytorch, and similar. Accordingly, when implemented as software, a control model generator module (or control agent) has access to such computing tools in the appropriate high-level programming language.

Other elements may be desired to provide sufficient control flexibility. As an example, multiple quantum circuits can be compiled and uploaded to the control subsystem 410, and can be scheduled for execution in an arbitrary shot-wise order with hardware-limited classical dead time. The data 404 can define the multiple quantum circuits. As another example, the interface between control agents and the rest of the software stack should include a way to pass metamodel parameters, additive offsets from existing values, and/or multiplicative offsets from the existing values alongside a quantum circuit. Eventually, metamodel parameters could be stored and updated persistently in the memory 412a, and/or other memory devices present in the control subsystem 410 or a QIP system, via microcalibration processing modules (which can be referred to as microcalibration processors) as is described herein.

In the configuration of closed-loop control approaches, an intermediate representation interface with one or more mechanisms (computational or otherwise) for customizing the implementation of a QIP program may permit rapid prototyping and exploration for improved quantum computer performance. In one example, the mechanism can be embodied in a first interface that provides two flexible entry points represented by respective interface components. A first interface component of the respective interface components can define or otherwise configure a particular implementation of a gate operations in terms of hardware resources specific to the quantum hardware 403. Such a first interface component is not limited to quantum hardware 430 and can be implemented in most any quantum computing architecture. In some cases, a compiler module (e.g., one of compiler module(s) 574 (FIG. 5B)) can be utilized to configure one or more gate operations using the first interface component based on a prototype parameterization of a control vector. A second interface component of the respective components can define or otherwise configure pulse-level instructions that can be passed to the quantum hardware 430 as hardware instructions. The second interface component can be viewed as a lower-level construct. In cases where more direct control over the quantum hardware 430 (FIG. 4) is desired or otherwise needed, such lower-level constructs can be used.

FIG. 5B illustrates a block diagram of another example of a QIP system, in accordance with aspects of this disclosure. The QIP system 500 includes an intermediate representation subsystem 550 that provides a hard interface—an intermediate interface-between the control subsystem 410 and the quantum hardware 430. Communication between the control subsystem 410 and the quantum hardware 430 can be accomplished via intermediate representation interface. To that point, in part, the QIP system 500 includes links 564 the permit coupling the control subsystem 410 with the quantum hardware 430. The links 564 include, in particular, one or more first links permitting the coupling of the control subsystem 410 with the intermediate representation subsystem 550, and also one or more second links permitting the coupling of the intermediate representation subsystem 550 with the quantum hardware 430.

The control subsystem 410 can use the intermediate representation subsystem 550 to execute, or cause execution of, a quantum circuit. To that end, the control subsystem 410 and the intermediate representation subsystem 550 can use or otherwise leverage the first link(s) and the second link(s) included in the links 564. The quantum circuit and execution thereof are represented by an arrow 525 in FIG. 5B.

The links 564 also include one or more third links permitting the coupling of the control subsystem 410 with the quantum hardware 430, without involving the intermediate representation subsystem 550. The control subsystem 410 can receive, via the third link(s) included in the links 564, data 568 from the quantum hardware 430. As is depicted in FIG. 5A, the control subsystem 410 can receive the data 568 in response to execution of a quantum circuit and/or performance of side-channel measurements. Execution of the quantum circuit is represented by an arrow labeled 565. Performance of a side-channel measurement relies on a measurement circuit, which circuit is represented by an arrow labeled 566.

To provide an intermediate representation interface, the intermediate representation subsystem 550 includes multiple computer-accessible components retained in one or more memory devices. As mentioned, the control model generator module 414 can use the intermediate representation interface by executing or causing to execute at least one of the computer-accessible components. Simply for the sake of illustration, Those computer-accessible components can be used to defined a quantum circuit (a production quantum circuit or a calibration circuit, for example). Because executing calibration logic causes gate calibration, at least some of the computer-accessible components can enable useful calibration design patterns and also can provide a flexible mechanism for customizing gate decomposition. FIG. 5C is a schematic diagram of the intermediate representation subsystem 550 having one or more memory devices 584 (collective referred to as memory 584) retaining multiple computer-accessible components 586.

The computer-accessible components that constitute the intermediate representation interface also can be used, in some cases, by other subsystems and/or modules (implemented in software or a combination of hardware or software). Similar to the control subsystem 410, such other subsystems and modules can generate and consume the intermediate representation interface, or elements thereof, for the purposes of calibration, job circuit execution, or compilation to hardware-specific pulses, for example.

The computer-accessible components that constitute the intermediate representation interface can have one or a combination of the following properties: (i) Serialization. That is, the computer-accessible components can be serialized. Serialization permits at least one of the computer-accessible components to communicate across processes that may not share memory. (ii) Completeness. That is, the computer-accessible components, individually or in a particular combination, contain all relevant information at the level of specificity required for the representation of a quantum operation. (iii) Versioning. The computer-accessible components can be versioned. (iv) Extensibility. That is, the computer-accessible components, individually or in a particular combination, can permit defining multiple variants of a particular quantum gate, where a variant provides a particular parametrization of the particular gate. Further, or in some cases, functionality can be added to the computer-accessible components individually in order to extend their respective functionality. Such extensibility permits the control subsystem 410 to implement different quantum gates on the quantum hardware 430. The different quantum gates can be controlled according a same or a different control model, via the control module 416. (v) Agnosticism. That is, the computer-accessible components, individually or in combination, serve as an interface specification/contract between independent software modules (at least some of the execution modules 420, for example). As such, the computer-accessible components can be defined using industry standards such as gRPC. For purposes of illustration, a gRPC is cross-platform open-source high-performance framework for remote procedure calls.

With respect to extensibility, it is noted that by having gate variant it is possible to capture that a hardware implementation of a logical gate operation is not unique; that is, there are more one way to implement the logical gate operation in quantum hardware. Accordingly, extensibility can permit keeping track of and comparing across such different hardware implementations. For example, to implement a kind of 2Q gate referred to as a “ZZ” gate, the QIP system applies two single qubit gates, an MS gate, and then two additional single qubit gates. This set of operations is parameterized by GPi2 and MS calibration parameters. Yet, various strategies for applying for how to apply the single qubit gates may be available. Such strategies could happen sequentially or in parallel, or they may be implemented as simple “square Rabi” pulses versus more complicated “composite pulse sequences” that implement the same logical operation but in a way that is robust to certain errors. In some cases, a choice between these strategies can be added as an additional parameter of the gate, but doing so may result in a long set of if/then/else statements in the hardware implementation in order to select between several different options for performing the same logical operation. Further, such a parameter is not something to be calibrated like other gate parameters. Hence, in accordance with aspects of this disclosure, the specification of different strategies as respective variants can provide a more stable configuration environment. In addition, different strategies can be compared via A/B test of gate variants, via standard characterization protocols to see which performs more satisfactorily on quantum hardware, and then select the most satisfactory (or second most satisfactory) variant in operation. In addition, or in some cases, gate variants can be used as a way of diversifying circuit execution. That is, if many strategies for performing the same operation are available, by randomizing over those different strategies, circuit execution can be less sensitive to systematic offsets that may be present in one strategy or another.

The computer-accessible components that form the intermediate interface can be separated into three representation levels: A first level which may be referred to as “Source;” a second level which may be referred to as “Bound;” and a third level which may be referred to as “Configured.” At least one first component of the computer-accessible components forms the first level and can be referred to as Source level interface. At least one second component of the computer-accessible components forms the second level and can be referred to as Bound level interface. At least one third component of the computer-accessible components form the third level and can be referred to as Configured level interface. The Source level interface accepts a QIP program in terms of gates natively supported on a wide range of physical architectures. The Bound level interface accepts a QIP program in terms of gate operations on a specific physical hardware design that implements the native gateset. The Configured level interface accepts a QIP program encoded at the most granular detail and contains the numeric values that parameterize control hardware at a point in time.

The first level (Source) essentially corresponds to abstract, logical operations that could be used (e.g., called or executed) on QIP systems of any architecture. The second level (Bound) essentially corresponds to native operations performed within the context of a particular architectural class, e.g., a trapped-ion QIP with dynamic Raman beam steering, or a superconducting-qubit quantum computer, or a trapped-ion quantum computer. The third level (Configured) essentially corresponds to operations performed within the context of a particular instance of an architectural class. FIG. 5C depicts such a separation, where the multiple computer-accessible components 586 include a Source component 594, Bound components 596, and Configured components 598. The three-level representation has application on a wide range of quantum computing architectures. Accordingly, the three-level representation of a QIP program can be defined on many different types of quantum computing architectures (e.g., trapped-ion, superconducting, neutral atom, defects in solid, etc.).

Components that form the Source level interface, Bound level interface, and Configured level interface can be applied, individually or in combination, to describe QIP program interface components as follows.

Source—The Source component 594 corresponds to circuit primitives compiled in a native gateset from a universal set of quantum gates (e.g., Clifford-plus-T). A native gateset may represent one-, two-, or multi-qubit physical operators in a physics model (e.g., a Hamiltonian describing a trapped-ion spin with arbitrary rotation and phase operators) that may be implemented in a variety of ways in a variety of physical architectures (e.g., a Hamiltonian describing the interaction of two Raman beams and a trapped-ion qubit). A native gateset can be defined in terms of one of numerous syntaxes. In an example scenario of trapped-atom QIP systems, without intending to be constrained by syntax, a Source program can be specified with an API, as {gate, target(s), angle, phase(s)} which have a specific mathematical representation in a circuit. Compilation of the Source component 594 from universal gates may permit an arbitrary degree of optimization that is not found in commonplace technologies for compilation of a quantum program.

Bound—Each of the Bound components 596 permits implementing a Source program by binding particular hardware resources to each defined gate in the Source program. Such a binding includes matching controls to targets (e.g., matching AOD-steered Raman beams to qubits) and defining a variant used to implement the native unitary operation associated with a specified gate. For example, implementing the native gate GPi2 (qubit=0) can include performing a counterprop Sk1 gate (variant), binding a laser beam (control) to qubit 0 (target). In this disclosure, a GPi2 gate is a single-qubit gate representing a ½ pulse. That is, the GPi2 gate causes a state to rotate by π/2 radians. This decomposition of the Source operation to Bound operation is not unique, but a compiler subsystem 570, via a particular compiler component or a particular combination of compiler components included in one or more compiler modules 574 (FIG. 5B) can implement defined compiler rules for how to do this when submitting via the Source component 594. These compiler rules constitute directives about how to translate a native gate to the Bound operation, when that mapping is not necessarily unique. Example of the compiler rules include “even qubit indices always use beam A, odd qubit indices always use beam B,” or “single qubit gates will always be implemented using Sk1 composite pulse sequence.” As another example, the compiler component(s) can rearrange a Source program to maximize gate parallelization in the Bound representation/component to reduce circuit runtime. One of many benefits of having such directives as compiler rules is that compiler behavior can be adjusted without rewriting a ruleset that has been hard-coded, at any time that a modification of compiler behavior is desired. Such compiler component(s) can be part of the execution modules 420. Such a level of specificity is appropriate for calibration purposes. Thus, a Bound component of the Bound components 596 is provided during compilation. Each of the Bound components 596 can be defined in terms of one of numerous syntaxes. In an example scenario of trapped-atom QIP systems, without intended to be bound by syntax, the required fields to define a Bound component can be summarized as {native gate, variant, control(s), target(s)}.

Further, in defining a variant corresponding to each of the Bound components 596, both a particular parameterization and a compiler algorithm for decomposing the native operation into AWG pulses (or other hardware-specific pulses) to be sent to the hardware are selected. As is described herein, because the computer-accessible components 586 that form the intermediate representation of this disclosure are extensible and versionable, a particular selection of parameterization and compiler algorithm also is extensible, and a definition of the variant can be versioned. In other words, a definition of the variant is not unique, and an immutable record of the definition can be retained in one or more memory devices (e.g., the memory 584). In this way, a record of the decompositional rule(s) used at a particular time is readily available, and new variants can be readily added to the intermediate interface as new aspects of the hardware that require calibration emerge. Records 588 of respective decompositional rules can be retained in the memory 584. For purposes of illustration, a decompositional rule includes any rule that translates a gate from the Source component to the Configured component. An example of a decompositional rule is “GPi2 gate is implemented with multiple rounds of echo pulses.” By applying such a decompositional rule, the qubit operation involving the GPi2 gate can be decoupled from a noise source. A GPi2 gate may appear multiple times in a quantum circuit but with different noise decoupling variants, and the intermediate representation can express each instance uniquely. Other examples of decompositional rules include “GPi2 is decomposed as an SK1 composite pulse sequence,” or “GPi2 is decomposed as a simple Rabi pulse.”

Configured—It is not sufficient to define the decompositional algorithm (or decompositional rule) and hardware bindings for a gate operation, as all of the gate parameters from calibration or configuration space need to be resolved. A Configured component 598 is created by resolving such parameters. In some cases, this resolution can be implemented by defining one or more control system parameters that actuate the bound hardware that implements a target gate. For example, the control system parameter(s) include digital gain and frequency. More specifically, yet not exclusively, the decompositional rules 588 can include a decompositional rule that when applied to a Configured component (e.g., an instance of the Configuration component), causes the Configured component to be expressed in terms of one or more plain hardware instructions. An example of such a decompositional rule is “output an RF pulse on channel 0 with amplitude 0.1 at 200 MHz for 30 μs.” Such a representation of the Configured component may be referred to as a parameterization of the gate. The parameterization of the gate is a resolved instance of the Calibration component.

One or multiple calibration parameters can be required as input to the decompositional rule (also referred to as parameterization rule) to generate plain hardware instructions. A Configured component that has been resolved contains all such calibration parameter(s), which parameter(s) have been obtained (e.g., retrieved or received) from the calibration repository 412b. As is described herein, the calibration repository 412b can retain calibration state variables and/or calibration parameters. Thus, such a Configured component contains all relevant information for determining the plain hardware instructions. A Bound component, when executed by at least one of the processor(s) 580, can determine which calibration parameter(s) are obtained from the memory component in order to define the parameter(s) of the Configured component. As an example, if the Bound component uses beam pair 1 instead of beam pair 2, this can correspond to the calibration parameters for beam pair 1 relating to the gate to be implemented.

Because such a resolution of parameters has already resolved all dependencies among parameters, one or more compiler components (e.g., at least one component included in one of compiler modules 574) can ingest Configured program objects and, in response, can provide execution-ready instructions (e.g., hardware instructions) without relying on external data (e.g., values of state variables). The Configured component 598 can similarly be injected into simulation tools, such as those described herein, without requiring additional dependencies.

As is described herein, calibration parameters may vary or drift in time. Hence, a Configured component 598 may also be appropriate or otherwise satisfactory for a finite time interval. The Configured component 598, being a self-contained representation, may be used as the target of calibration controllers (e.g., control module 416) without requiring state synchronization between a calibration parameter repository and compiler component(s) (e.g., one or more compiler components of one of the compiler modules 574). It is noted that an appropriate variant-level parameterization permits configuring calibration controllers (e.g., control module 416) to operate in a natural basis for each parameter, also without requiring state synchronization between the calibration parameter repository and the compiler component(s) (e.g., one or more compiler components of one of the compiler modules 574). Such a repository can be integrated into one or more memory devices within the control subsystem 410 or quantum hardware or another subsystem of the example QIP system 500). More specifically, simply for purposes of illustration, an appropriate variant-level parameterization matches a calibration scheme, such that calibration scans decompose into a set of linear scans over a single parameter, where those parameters have a natural functional relationship with a desired or otherwise particular physical system quantity.

The three-level representation of the computer-accessible components 586 that form the intermediate interface, may also permit customization of a program through an override interface. At the Source level or Bound level, a program can include a data structure(s) defining one or more override parameters that override fields in the final Configured object (e.g., in a variant-level parameterization present in the Configured object, for example). Each (or, in some cases, at least one) override parameter of the one or more override parameters can be expressed as an absolute value, an offset value from an existing calibration value, or a fraction of the existing (e.g., current) calibration value. Each (or, in some cases, at least one) override parameter can be expressed as a function of an existing calibration value. A calibration controller (e.g., control module 416) can specify an offset in a single calibration parameter to achieve a calibration scan, instead of requiring access to the absolute value of many parameters in order to compute a calibration scan trajectory through the parameterization space, or even the absolute value of a parameter that the calibration controller is calibrating. Simply as an illustration, parameterizing the GPi gate in terms of a gain, and recognizing that the Rabi rate is proportional to the gain, permits defining a scan where the Rabi rate is change fractionally by +/−10% about a previously calibrated value. The calibration controller can then compute a fractional update to that previously calibrated parameter without knowledge of a prior value of the parameter. Such an approach based on offsets simplifies software architecture by decoupling the parameter repository and the calibration controller, except through a simple “set” interface to update the final parameter value after a calibration scan. Such an approach also permits avoiding requiring the calibration controller to configure a “temporary” calibration value to the parameter repository for each point in the scan, as this requires tight synchronization between the parameter repository and the calibration controller and adds classical latency.

Simply as an illustration, consider a commonplace paradigm for implementing a parameter scan: (a) get a copy of the calibration state, (b) mutate a particular entry, (c) pass that calibration state and the gate definition to the compiler module, (d) the compiler module generates hardware-level instructions. Such a commonplace paradigm requires the controller logic to have access (via an API, for example) to the calibration state (which makes it harder to test), and sequences may not be pre-computed without risking stale calibration data. In sharp contrast, in the proposed approach involving overrides, the parameter scan can be implemented as follows: (a) the controller submits a sequence of gates with overrides to the compiler module, and (b) the compiler module generates hardware-level instructions.

The override parameters described herein also carry semantic meaning for simulation purposes, expressing offsets from an existing (current or ideal) calibration state. Such parameters can be ingested as a single data structure by simulation tools.

In some cases, one or a combination of the computer-accessible components that form the intermediate representation also can also be used to communicate interrupts or other information from the quantum hardware 430 to various control agents or other types of monitoring agents.

One or a combination of the computer-accessible components 586 that form the intermediate representation also can also be used for historic recordkeeping, debugging, or simulation. For historic record keeping, the intermediate representation (IR) is a condensed representation of what the quantum hardware (e.g., quantum hardware 430) was programmed to do. In combination with a versioning of the IR, all aspects of the hardware behavior associated with a particular point of data may be reconstructed. Similarly, the intermediate representation can be easier to introspect than hardware-level instructions. Thus, for debugging, for example, errors can be readily detected by inspection of a quantum program, and it can be readily confirmed if the intent of an operation is translated properly at each level from the native gate to the bound operation to the configured operation into final hardware instructions. In commonplace technologies that lack the intermediate representations of this disclosure, it would be difficult to identify or otherwise isolate where in the process an error occurs. With respect to simulation, it is noted that simulation often works at a higher level of abstraction than the lowest-level hardware instructions. Thus, a straightforward simulation of a quantum circuit could be implemented using one or more Source components, which may provide an ideal output of a QIP system or a noisy output based on some simplified error models. Bound component(s) could be used in addition to some “translational models” specifying lower-level physical details to simulate an ion response to more complex physical phenomena that cannot be captured using a the Source level interface.

Visualization tools can consume an intermediate representation (IR) interface, or elements thereof, to enable straightforward inspection and debugging of the aforementioned software components. This functionality can be used by a user device coupled to the control subsystem 410. Such a user device can be the user device 402 or another user device in an offline setting. In some cases, one visualization may show time-series visualizations of the laser pulses used to implement gates. Using such a visualization, an end-user can readily inspect the time-series visualizations to determine is errors are present. In addition, or in other cases, a visualization tool can translate the intermediate representation into a visual representation of that IR so as to quickly convey relevant information. In one example, a defined sequence should program synchronized phase jumps across two qubits. Decoding this from hardware-level instructions or even the IR can be tedious or plain unfeasible. Yet, a visualization component in accordance with aspects of this disclosure can readily convey information related or otherwise representative of those phase jumps or absence thereof. The IR is a format that can be loaded into custom visualizations or visualization component(s), and because the IR can be serialized, those visualization component(s) need not be in the same runtime as a quantum control system, but can be analyzed offline.

To implement the intermediate representation interface to generate instructions for the quantum hardware 430, the intermediate representation subsystem 550 includes one or more processors 580 configured to execute the computer-accessible components 586 stored in the memory 584. The computer-accessible components 586 can be executed individually or collectively. As is described herein, the computer-accessible components 550 include a Source component 532. In response to execution by the one or more processors 580, individually or in combination, the Source component 532 causes generation of a Bound component (e.g., one of the one or more Bound components 596). The Source component defines a native gate of the quantum hardware 430 (or another type of quantum hardware comprising multiple qubits). The Bound component defines a configuration of hardware elements to implement the native gate. Such a configuration can include (i) a gate variant associated with the native gate, and (ii) an association between one or more control hardware elements and one or more target qubits of the multiple qubits.

In response to execution by the one or more processors 580, individually or in combination, the Bound component causes generation of a data structure defining gate parameters including first gate parameters corresponding to the gate variant and second gate parameters corresponding to the one or more control hardware elements. More specifically, the second gate parameters include one or more calibration parameters for a first control hardware element of the one or more control hardware elements.

In some cases, the Bound component also can include a second data structure defining one or more override parameters. Causing generation of the data structure defining the gate parameter can include applying the one or more override parameters to the defined gate parameters. A first override parameter of the one or more override parameters can be expressed as an absolute offset value from an existing calibration value, a fraction of the existing calibration value, or a relative offset value from the existing calibration value. In other cases, the first override parameter or another override parameter of the one or more override parameters can be expressed as a function of an existing calibration value.

The one or more processors 580 can identify or otherwise define the gate parameters and second gate parameters (e.g., calibration parameter(s) and, in some cases, override parameters) and can map such parameters to values of the parameters in a calibration datastore and/or configuration datastore. By creating such a mapping based on the Bound component, the one or more processors 580 can generate a Configured component. As is described herein, one or more compiler components (e.g., at least one compiler component of one of the compiler modules 574 (FIG. 5B)) can generate a data structure defining pulse-level instructions corresponding to the quantum hardware 430 (or, in some cases, another type of quantum hardware). Simply for purposes of illustration, a pulse-level instruction defines a sequence of pulses to be applied to qubits in order to perform desired gate operations (defined by one or more Source components). A pulse-level instruction can include data indicative of amplitude, phase, and/or frequency of a pulse to be applied to a particular qubit.

The one or more processors 580 (or, in some cases, other processor(s)) can execute a particular computer-accessible component and, in response, can generate hardware instructions to control equipment within the quantum hardware 430. Simply for purposes of illustration, such a particular computer-accessible component can be or can include a pulse-level instruction API. The particular computer-accessible component can pass the data structure defining the pulse-instructions to compiler component(s) to generate the hardware instructions. Implementation of the hardware instructions cause the application of the pulse-level instructions.

In some cases, a subset of the components 586 comprises immutable methods identified by a datum defining a version. As described herein, versioning is a property of the at least some of the components 586. Further, serialization also is a property of the at least some of the components 586. Accordingly, a particular component of the components 586 can define a data structure, and in response to execution by at least one of the processor(s) 580, the particular component can cause a message to be sent. The message can be sent to another component or module of a computing system of a QIP system including the computing system. For example, the message can be sent to a module within the control subsystem 410 or the compiler subsystem 570. The message includes at least one field and respective payload data.

The intermediate representation interface described herein improves existing QIP system systems in many ways. For example, the intermediate representation describe herein permits generating, or can be leveraged to construct, control agents that are agnostic to the particular details of the underlying hardware in the quantum hardware of a QIP system. The intermediate representation permits a control agent to only be concerned with parameterization of the gates that the control agent attempts to calibrate, rather than how that parameterization is implemented in quantum hardware and/or how it is translated into hardware-specific instructions. As a result, control agents can be designed and tested in simulation, and deployed to multiple QIP systems that have divergent low-level implementations. As another example, the intermediate representation described herein can be used in the context of generating control models, and might be co-designed with control agents and/or quantum hardware to achieve satisfactory performance (e.g., optimal or nearly optimal performance). As yet another example, the extensibility of the intermediate representation described herein readily permits configuring a plethora of implementations or parametrizations of a particular gate, and deploying such implementation side-by-side and testing them to identify which implementation provides a satisfactory performance (e.g., best, second best, etc.).

Depending on drift timescales, an existing hardware instruction generator (such as an AWG instruction generator) can be sufficient, in some cases. Because the timescale for uploading circuit instructions to the control subsystem 410 from a compiler subsystem can be less than or about one (1) second, metamodel evaluation could happen on the host server prior to upload assuming parameters do not drift significantly on that timescale. This should be the case for a robust hardware design, for example. In cases where real-time metamodel evaluation (e.g., using precise RTIO timestamps) is required, modifications to the hardware instruction generator can be made to support that requirement. In either case, pipelining circuit uploads can ensure that the quantum hardware 430 (FIG. 4) rarely, if ever, stays in an idle state.

In some situations, the feed-forward dynamics involved in the closed-loop control described herein are changing more quickly than the timescale of networked communication between the quantum hardware 430 and the control subsystem 410 (FIG. 4). For example, if we consider random walk or 1/f-type noise on a particular calibration parameter, the stochastic nature of the noise process may preclude the construction of a high-fidelity model of future time-evolution of that parameter. As is described below, embodiments of this disclosure addressed such a situation by tracking a control parameter via frequent measurements and updating a control model that involved the control parameter. To that end, embodiments of this disclosure, individually or in combination, provide real-time evaluation of measurement data combined with an update to parameters of a control model, with low and deterministic latency.

In some implementations, the control subsystem 410 (FIG. 4) also can provide its own execution environment with a low-latency connection to the real-time hardware that implements execution of quantum operations included in a quantum circuit. The execution environment can access measurement data as part of a measurement cycle (or shot) and can then update one or more metamodels, with low and deterministic latency. In this way, closed-loop calibrations can bypass the communication bottleneck between the model generator module 414 and the quantum hardware 430.

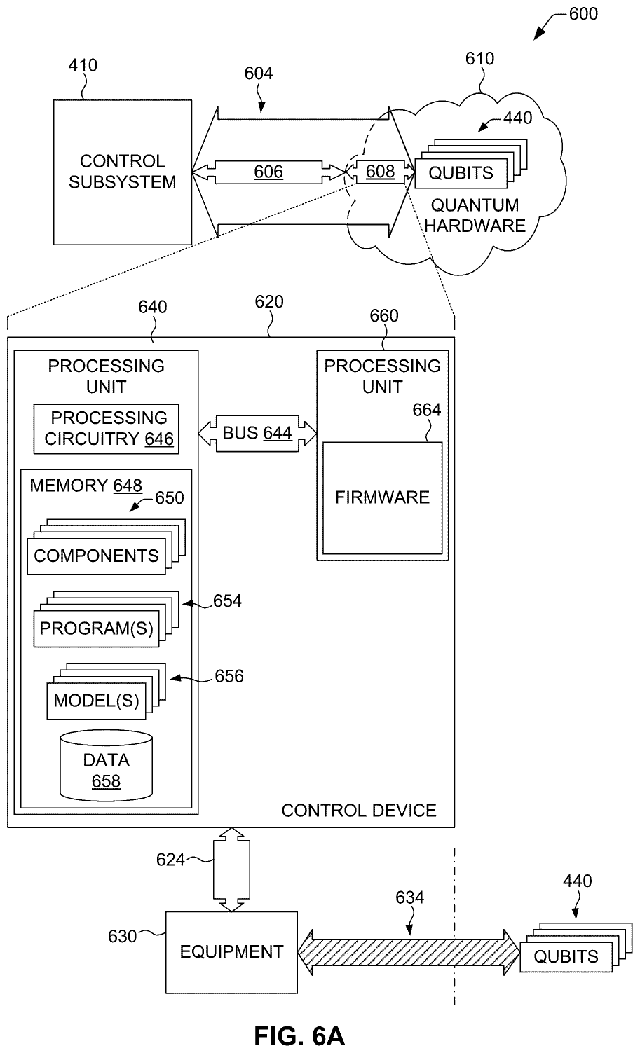

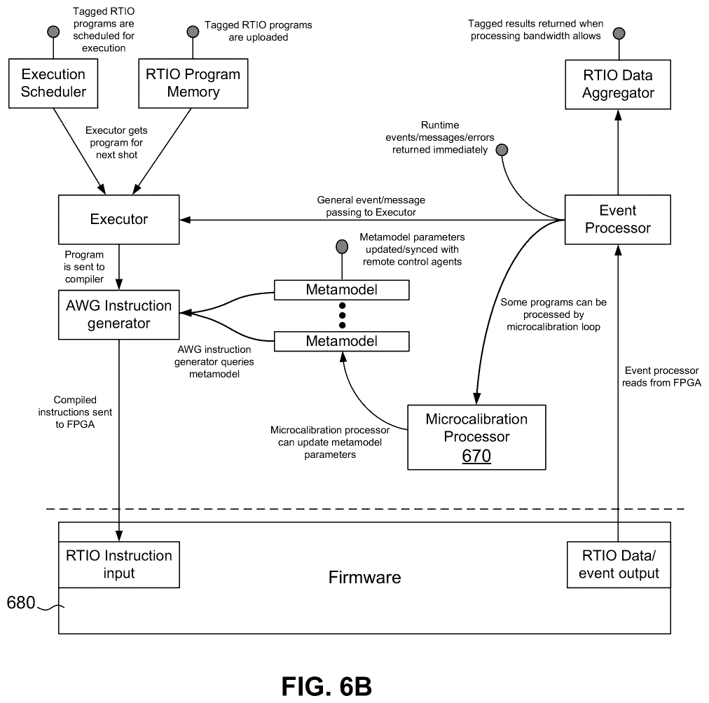

As an illustration, FIG. 6A is a schematic block diagram of an example QIP system 600 that includes the control subsystem 410 and multiple links 604 that functionally couple the control subsystem 410 with quantum hardware 610. The quantum hardware 610 includes at least some of the functional elements of the quantum hardware 430. The multiple links 604 are similar to the multiple links 424 in that the multiple links 604 include one or more communication links 606 (wireline links and/or wireless links). Different from the multiple links 424, the multiple links 604 also include a control platform 608 that provides the execution environment mentioned above. To that end, the control platform 608 includes a control device 620 functionally coupled with equipment 630 via an interface 624 that permits transporting (e.g., sending, receiving, and/or exchanging) digital signals or analog signals, or a combination of digital signals and analog signals. As such the hardware interface 624 can include a digital interface, an analog interface, or a combination of both. Digital signals or analog signals, or a combination of both, can cause the equipment 630 to implement hardware instructions.

As is illustrated in FIG. 6A, the control device 620 is embedded is within the quantum hardware 610, and, thus, can be referred to as an embedded control device 620. The equipment 630 permits manipulating and probing the multiple qubits 440. In some cases, the equipment 630 is the same equipment that permits manipulating and probing the multiple qubits 440 in the QIP system 400 (FIG. 4). To manipulate and/or probe one or more of the multiple qubits 440, links 634 couple the equipment 630 with the multiple qubits 440. The links 634 include solid-state link(s) and/or optical link(s) that can cause physical interaction (e.g., EM-radiation-matter interaction) between the equipment 630 and the multiple qubits 440.

The control device 620 includes a processing unit 640 that is functionally coupled with another processing unit 660 via a low-latency bus structure 644. The low-latency bus structure 644 (or low-latency bus 644) is configured to provide a high-speed interconnect between chipsets. In some cases, the low-latency bus structure 644 provides a data transmission speed of the order of a few hundred Mbps to many Gbps. Each one of processing unit 640 and processing unit 660 can be embodied in, or includes a microprocessor or another type of processor. In some cases, the processing unit 640 is an accelerated processing unit (APU) and the processing unit 660 is an FPGA. In other cases, the processing unit 640 is an ASIC and the processing unit 660 is another ASIC. In yet other cases, both the processing unit 640 and the processing unit 660 can be implemented into a single ASIC. In some configurations, the processing unit 640, the low-latency bus structure 644, and the processing unit 660 are integrated into a single hardware module. In one example, the hardware module is a system-on-chip (SoC). The disclosure is not limited to a single hardware module (e.g., an SoC). Indeed, in some configurations, the control platform 608 includes multiple instances of the control device 620, each packaged into a respective single hardware module (e.g., an SoC). Thus, the control platform 608 can be distributed and includes multiple hardware modules (e.g., multiple SoCs) form part of the control platform 608, and a dedicated backplane functionally couples such multiple hardware modules into a single chassis.

Regardless of its architecture, the processing unit 660 serves as a controller component that can cause execution of a quantum program using the multiple qubits 440. To that end, the processing unit 660 is functionally coupled with the equipment 630 via the bus structure 624, and can direct or otherwise cause one or more individual equipment of the equipment 630 to implement (or execute) defined hardware instructions to manipulate and/or probe the multiple qubits 440. Implementing (or executing) a hardware instruction includes applying, by one or combination of individual equipment, signals at least a subset of the multiple qubits 440. In trapped-ion architectures, for example, the signals can include laser pulses and/or another type of optical waveform. Regardless of their type, the applied signals can correspond to a particular gate defined to act upon one or several particular qubit devices of the multiple qubits 440.

Control bandwidth may still be limited by qubit measurement cycle(s) in the example QIP system 600. However, when a particular control loop cannot tolerate the round-trip delay associated with communications between the control device 620 and the host server device(s) hosting the modules within the control subsystem 410, the processing unit 640 can provide the execution environment mentioned above. To that point, the processing unit 640 is configured to execute multiple components 650 retained in one or more memory devices 648 (collectively referred to as memory 648). Processing circuitry 646 included in the processing unit 640 executes the multiple components 650. The multiple components 650 can be compiled externally to the processing unit 640 and can then be uploaded to the memory 648. In response to execution of the multiple components 650, the processing unit 640 can provide in situ closed-loop control in accordance with aspects described herein.

The processing circuitry 646 can be arranged in a single core with multithread execution functionality, for example. In some cases, the processing circuitry 646 can be arranged in multiple cores. In either arrangement, the processing circuitry 646 can execute the multiple component 650 according to parallelized processing. Message passing amongst two or more of the multiple components 650 is handled accordingly.

To execute a quantum program in such an execution environment, the processing unit 650 can receive the quantum program from the control system 410. For example, the model generator module 414 (not depicted in FIG. 6B) can upload the quantum program to the processing unit 650. The quantum program can be uploaded via an application programming interface (API), in response to the model generator module 414 being executed at the host server device(s) hosting the generator module 414. The quantum program can correspond to a calibration program. In some cases, the calibration program is defined as a calibration quantum circuit to be compiled. In other cases, the quantum program that is precompiled. That is, the quantum program includes a program schedule that defines a desired sequence of operations corresponding to calibration algorithm (or, in some cases, quantum computation algorithm). The program schedule thus defines instants and respective waveforms, where each waveform is scheduled to be applied at a respective instant (also referred to as instruction time) also defined in the program schedule. Simply for purposes of illustration, a sequence of operations refers to an ordered list of quantum operations that occur one after another.

Regardless of whether a quantum program has been received as a quantum circuit to be compiled or a program schedule, the processing unit 640 retains the quantum program within a portion of the memory 648. That portion of the memory 648 can be referred to as RTIO memory, and includes data 654 comprising first data defining the quantum program. The data 654 also can include second data defining a second quantum program, third data defining a third quantum program, and so forth. That is, the data 654 can define a sequence of quantum programs that includes the quantum program.

The disclosure is not limited to receiving quantum programs remotely. In some configurations, the multiple components 650 (FIG. 6A) include a composition component that is configured to generate a quantum program. The quantum program can be generated based on state variables of one or more individual equipment of the equipment 630. In addition, or in some cases, the quantum program can be generated based on such state variables and measurement data received from the one or more individual equipment of the equipment 630. After generating the quantum program, the composition component can retain the quantum program in the RTIO memory, as part of data 654.

Various computational efficiencies can be achieved by retaining quantum programs in the RTIO memory. For example, there are scenarios where a quantum program is defined as a quantum circuit that uses an intermediate representation. In those scenarios, the quantum circuit can be specified in terms of offsets from a current parameterization of a control model instead of being specified in terms of absolute control parameters to be used during execution of the quantum circuit. Accordingly, a particular quantum circuit can be uploaded once into the RTIO memory, and can be reused many times via the intermediate representation.

In some implementations, the multiple components 650 (FIG. 6A) include a scheduler component (or execution scheduler) that is configured to provide a schedule (or queue) of quantum programs for execution. The scheduler component can provide the schedule (or queue) in various ways. In one example, the scheduler component can receive the schedule of quantum programs for execution from the model generator module 414 via an API. The schedule can be received in response to the model generator module 414 being executed at the host server device(s) hosting the generator module 414. In another example, the scheduler component can generate the schedule based on one or more attributes of existing calibration parameters. An example of one such attribute is recency of a calibration parameter, where the recency is indicative of time interval since a last calibration of the calibration parameter.

Regardless of the schedule structure, the scheduler component is configured to identify one or more particular quantum programs for execution. Identifying a particular quantum program for execution includes, in some cases, providing a reference value (a tag, for example) indicative of the particular quantum program. In some cases, the schedule provided by the scheduler component is defined according to one or more templated patterns (e.g., “100 shots of program A, 20 shots program B, . . . ”) in some cases. Thus, a particular quantum program identified by the schedule component can be included in a sequence of quantum programs for execution.

By identifying quantum programs by reference, using respective reference values, execution of a variations of a sequence of quantum programs can be efficiently implemented because each one of the variations need not be uploaded to the processing unit 640 each time, in preparation for execution, Instead, a group of several quantum programs can be uploaded to the processing unit 640, and retained within the RTIO memory, one time. The scheduler component can simply generate a sequence of reference values corresponding to a desired sequence of quantum programs for execution. Such efficiency is achieved by separating the scheduler component from the RTIO memory.

In addition, or in other implementations, the multiple components 650 include an execution component (or executor) that can obtain a quantum program identified in the schedule and can cause the processing unit 640 to execute the quantum program. To that end, in some cases, the execution component can pass the quantum program to a generator component (or instruction generator) also included in the multiple components 650. The generator component is configured to compile the particular quantum program, resulting in one or more hardware instructions. The generator component can compile the quantum program using control parameter(s) of a control model. Thus, the generator component is further configured to access a control model and evaluate the control model. The control model is one of control model(s) 656 retained in the memory 648. Each of the control model(s) 656 corresponds to a respective one of the control model(s) 418. In some cases, the generator component also can compile the quantum program using both control parameter(s) and real-time data generated by the equipment 630. For example, the real-time data can define one or more values of respective state variables of individual equipment of the equipment 630. In addition, or as another example, the real-time data can define one or more values of temperature, humidity, magnetic field, a combination thereof, or the like.

The generator component also is configured to send, towards the equipment 630 (or other quantum hardware), a first hardware instruction of the one or more hardware instructions that resulted from compilation of the particular quantum program. The first hardware instruction, and any other one of the hardware instructions, can be sent toward the equipment 640 via the processing unit 660. More specifically, the processing unit 640 can send, via the bus 644, the first hardware instruction to the processing unit 660. In response to receiving the first hardware instruction, the processing unit 660 can retain the instruction in one or more memory devices, can then send the first hardware instruction to the equipment 630 via the bus 624. Such memory device(s) are part of firmware resources 664 present in the processing unit 660. The firmware resources 664 also include processing circuitry, memory controller(s), interface(s), and the like. The firmware resources 664 can process data and signaling on a guaranteed clock schedule so that instructions are executed at a given time with nanosecond-level precision.

In cases where a quantum program that has been received at the processing unit 640 (e.g., uploaded to the RTIO memory) in precompiled format, the processing unit 640 need not execute the generator component, and therefore, compilation and related evaluation of metamodels are not performed.

Further, or in some implementations, the multiple components 650 include a first processing component (which can be referred to as “event processor”) configured to receive measurement data responsive to one or more of the hardware instructions (e.g., the first hardware instruction mentioned above). Such measurement data include qubit-based measurement data and/or side-channel measurement data. The measurement data can be generated by the equipment 630 and can be received by the event processor via the processing unit 660. The processing unit 650 can retain the data in one or more memory elements 668 within the memory 656.

Furthermore, or in some implementations, the multiple components 650 also include a second processing component (which can be referred to as “microcalibration processor”) that is configured to update a control model of the control model(s) 656. The control model can be updated based on measurement data. Updating the control model includes evaluating the control model using the measurement data, and then updating one or more metamodel parameters of the control model. The control model can be evaluated by applying a Kalman filter or an integral feedback. The second processing component also can be configured to send the updated control model to the control model generator module 414 (not depicted in FIG. 6A), to synchronize the updated control model with a corresponding control model included in the model(s) 418 (not depicted in FIG. 6A). A software configuration permits flexible mapping between circuits, microcalibration processors, and metamodel parameters depending on the calibration needs of the system. For purposes of illustration, the software configuration permits specifying at runtime (that it, without a recompilation of software/firmware) how the microcalibration processor should operate. Further, flexible mapping refers to an arbitrarily defined relationship that can define a calibration circuit, parameters of the microcalibration processor strategy, and how an output maps to a particular calibration parameter retained in memory. A mapping can be defined in terms of one or more statements, such as {when calibration circuit A is run, execute microcalibration processor strategy B and update parameter C}; {when calibration circuit D is run, execute microcalibration processor strategy E and update parameter F}; and the like.

The event processor can provide other functionality based on measurement data. An example of such functionality includes emitting (e.g., generating and/or sending) runtime events and/or messages to one or more modules within the control subsystem 410. Runtime events and/or messages can be emitted via an API that permits passing data and/or signaling to the control subsystem 410. A runtime event or a message, or both, can be emitted upon receiving measurement data indicative of the runtime event. Runtime events include chain loss or dark ion detection, loss or laser lock, of a generic loss of signal (LoS) event from an element of the equipment 630 (FIG. 6A), for example. The event processor can emit a runtime event by sending data or signaling indicative of the event to the control subsystem 410. In addition, or in some cases, the event processor can generate an error message and send the error message to the control subsystem 410. The emission of runtime event(s) can be used to filter out bad data in addition to responding rapidly to the event in order to maximize system uptime of the example QIP system 400 or similar.

Another example of such functionality includes controlling the traversal of a schedule (or queue) based on trigger interruptions. A trigger interruption can be based on a runtime event. For example, the runtime event can be termination of execution of a quantum program, and the event processor can generate, in response to such an event, a trigger interruption indicative of initiation of execution of another quantum program in the schedule. The event processor can pass the trigger interruption to the execution component (or executor). The execution component can be configured to receive the trigger interruption, and pass the other quantum program to the generator component in response to the trigger interruption. In cases where that other quantum program is precompiled, the execution component bypasses the generator component, and sends the program schedule to the processing unit 660.

FIG. 6B is a schematic process flow that illustrates how this may interact with the slow-bandwidth model generator module 414 described in connection with FIG. 5A. More specifically, RTIO programs corresponding to respective quantum circuits can be uploaded and. To that end, in some cases, the control agent can submit the quantum circuits to the execution scheduler/RTIO program memory, where the quantum circuits can be compiled using parameters from various control models (e.g., two or more of the model(s) 656 (FIG. 6A)) and placed onto a FIFO connected to hardware configured for the deterministic real-time output. The AWG instruction generator, in conjunction with metamodel functions, can produce hardware instructions sent to the AWG RFSOC and TTL outputs. Although reference is made to an AWG instruction generator, the disclosure is not limited in that respect. Indeed, the process flow shown in FIG. 6B can be implemented using another type of hardware instruction generator, which can be appropriate for a quantum computer architecture that includes the control platform 608 (FIG. 6A).

Returned data can be processed by an event processing module (or event processor). The event processor can either pass the data back to the host server device(s), or to the fast-loop microcalibration processor 670. The microcalibration processor can be configured to update metamodel parameters internal to the control subsystem 410 (FIG. 4). Thus, such an execution environment can enable or otherwise facilitate a full bandwidth microcalibration paradigm, if it is needed for system performance, for example. In such a paradigm, for example, by processing data from some calibration quantum circuits by one or more microcalibration processors directly on an embedded controller device (e.g., the controller device 620), the slower communication pathway back to the control model generator module 414 (control agent) can be bypassed and metamodel weights can be updated directly on the quantum hardware 430. As is described herein, the event processor also can emit runtime events and/or messages (including error messages for example) to be handled elsewhere in the control subsystem 410 (see FIG. 6A). In FIG. 6B, API endpoints are represented by a grey circle and a segment, and the block 680, labeled “Firmware,” represents the firmware resources 664 depicted in FIG. 6A and described herein.

It is noted that the utilization of an embedded control device, such as the control device 620, is not limited to embedded closed-loop control (or microcalibration). Indeed, the control device 620 and related functionality described herein can be used in example scenarios where the QIP system 600 supports feed-forward gates from mid-circuit measurement, error correction primitives, and enhanced duty cycle execution.

### Example Complexities

### Context Dependency and Measurement Backaction

Due to undesired hardware behavior, the ideal value for a control parameter may change depending on what was previously executed in the quantum hardware 430 (FIG. 4). This can be referred to as context dependency. One example of context dependency couples Raman beam alignment to AOM temperature, which depends on a historic integration of the heat dissipated into the AOM crystal. This can be stabilized by, for example, idling with a particular RF power sent to the AOM, so the time-averaged heat dissipation is constant and the AOM temperature is driven to a steady state. In some cases, the idle settings can be adjusted in a closed-loop fashion in accordance with aspects of this disclosure, in order to make this behavior more robust.

Another way context dependency can manifest is in the difference between calibration quantum circuits (which can be rather short) and “job circuits” (or production quantum circuits, which can be quite long). The act of measuring a control parameter can shift the ideal value away from where it should be during execution of a job circuit. Although some of this can be modeled, other mechanisms can permit mitigating these effects. In one example mechanism, interspersing calibration shots with production shots can serve to time-average the overall duty cycle and improve the stability of the QIP system 400 or any other QIP system in accordance with aspects of this disclosure. To attain such stability, in some cases, quantum circuits can be interleaved on a shot-by-shot basis. In addition, or in another example mechanism, production quantum circuits from a queue can be interleaved or scheduled in such a way as to minimize duty cycle variance. The latter example mechanism may be implemented via a cloud-side job queue management subsystem. Such a management subsystem can be part of the control subsystem 410 in some cases.

### Tandem Measurements

One technique that can be used to increase the acquisition rate of calibration data (e.g., at least a portion of measurement data 428 (FIG. 4)) is to perform qubit-based measurements in tandem. In cases where the multiple qubits 440 (FIG. 4) are trapped-atom qubits, the measurement cycle can include cooling, state preparation, and detection operations that dominate the timescale of execution of calibration quantum circuits. If independent calibration measurements can be performed during the same coherent operations stage of the measurement cycle, then the overhead per bit of information about the calibration state can be reduced. However, it is noted that it is possible for some kinds of measurements to become coupled, e.g., through crosstalk and/or context dependency. A general scheduling strategy can be implemented to combine quantum circuits where possible. One example of tandem measurement is how GPi gate calibrations and Mølmer-Sørensen (MS) gate calibrations are performed-multiple qubits or gate pairs are measured in tandem. In this disclosure, a GPi gate corresponds to a π (or bit-flip rotation) with an embedded phase. Other measurements can be similarly combined, or even measurements of different types (e.g., measure GPi gate gain on qubits {1, 5, 7} and MS gate gain on pairs {[10, 15], [18, 20]} in a single coherent shot). In some cases, calibrations can be inserted at the end of an end-user quantum circuit (e.g., a production quantum circuit) on unused qubit resources to recover additional duty cycle provided that inserting the calibrations does not negatively impact the end-user quantum circuit. This can be integrated with existing error mitigation strategies (e.g., qubit remapping symmetrization) to improve calibration and increase overall circuit throughput.

### Metamodel Predictive Feed-Forward

Because our metamodels can be time-dependent, in the case of a well-defined drift of a control parameter, the number of qubit-based measurements can still be reduced while tracking the control parameter. The closed-loop feedback agent can estimate multiple parameters, e.g., a slope and an intercept, but this might yield overall better performance while reducing the measurement overhead. Other examples (more complicated, in some cases) also can be implemented. Simply as an illustration, a measurement of the amplitude and/or phase of 60 Hz magnetic field noise could be fed forward in a program to extend qubit coherence time. As is described herein, if side-channel measurements {s} at the relevant timescale are available, metamodels of the form ƒ_{{w}} (t,{s}) also can be constructed with improved accuracy.

### Example Calibration Paradigm

Calibration and automation routines can be structured around linear scans of control parameters, where an ion response can be fit to an underlying physical model to determine a satisfactory value (e.g., best value or second-best value) for each parameter. In cases where multiple parameters are coupled, a sequence of calibrations must be iterated in the correct order to obtain convergence. Once an estimate of a particular control parameter is obtained, that value is used until a performance metric, such as a point check, for example, indicates that the particular control parameter has drifted outside an acceptable range. Simply for purposes of illustration, it is noted that point checks are short circuits designed to be sensitive to particular calibration parameters. Such a condition can trigger a loop in automation, where the relevant scan is re-run to determine a new estimate of the control parameter.

The closed-loop architecture in accordance with aspects of this disclosure can address and resolve various issues present in the foregoing calibration scheme. More specifically, the closed-loop architecture in accordance with aspects of this disclosure can address and resolve the following issues:
(1) There is limited sophistication to the logic that might trigger a calibration scan: it can either run on a fixed wall-clock schedule (via cron, for example), or when a point check is outside of some range. For purposes of illustration, cron refers to a job scheduler on Unix-like operating system and is used to schedule jobs/tasks for execution. The cron scheduler is not driven by actual drifts in a QIP system, and the point-check trigger can easily cause unnecessary calibration scans or miss calibration drift because they are not executed frequently enough. There is also limited ability to change the calibration strategy based on an actual model of the parameter uncertainty, which wastes system time (e.g., compute time). Point checks are either run before a job execution window to verify the calibrations are within specification, at which point the job execution proceeds without feedback until some wall-clock time has elapsed, or select point checks can be run on a cron schedule during the execution window.
(2) Existing calibration scans can be slow to run, reducing system uptime. This issue is exacerbated as more qubits (and hence control parameters) are added to the QIP system.
(3) Monolithic calibration scans shift the operational context of the QIP system (e.g., the RF duty cycle into AOMs/acousto-optic deflectors (AODs), such that the calibrated parameter may not be optimal or otherwise satisfactory for operation in the context of a customer job.
(4) In the case of slow, linear drift in a control parameter, there is no cohesive strategy to update the parameter between calibration measurements. As a result, either unnecessary miscalibration is tolerated or reduced system uptime is tolerated when running a calibration scan more frequently to track the drift.

Tandem calibrations, some closed-loop feedback based on point check results during job execution windows, and leveraging the underlying physics models to feed-forward results to multiple control parameters dramatically increase the uptime of some trapped-ion QIP systems having architecture similar to the QIP system 200 (FIG. 2), the QIP system 400 (FIG. 4), or any other QIP system described herein, for example. As such, the closed-loop architecture in accordance with this disclosure can expand and improve the uptime of QIP systems having a high number of trapped-atom qubits (e.g., high-#AQ machines).

### Example Aspects of GPi Gate Gain and AOD Alignment

Simply as an illustration of the closed-loop calibration of this disclosure, various example aspects of how to stabilize beam pointing and gains for single qubit gates are described hereinafter.

TABLE 1
Summary of control parameters

| Parameter | Variable | Description |
|---|---|---|
| c0 | c₀ | Constant light shift (in MHz) applied |
| | | during gate |
| gain | g | Gain (proportional to Rabi rate) |
| | | applied to the primary beam |
| pri_steering_freq | xₐ | Primary AOD steering frequency |
| sec_steering_freq | x_{b} | Secondary AOD steering frequency |

### Gate Model

A simplified model of the system serves as a starting point of the illustration. Single qubit gates can be driven in a counterprop configuration, and the gate can be parameterized by several numbers. In such a countertop configuration, the laser beams used to address a particular qubit come from opposite directions, and hence can be sensitive to one set of normal modes of motion used to drive the entangling gate operation. This is in contrast to a “coprop” configuration, where the two laser beams come from a same direction. Such a set of multiple parameters is repeated per qubit. An example of the set of multiple parameters is shown in Table 1. The light shift term co is incorporated because the light shift depends on the AOM frequency due to the underlying structure of devices that form the quantum hardware 430 (FIG. 4) in some cases. In one aspect, this means the light shift co can depend on the difference in AOD steering frequencies x_{b}−xₐ, because this difference is compiled into a modified AOM frequency to maintain resonance with the qubit transition. Without intending to be bound by theory or modeling, it is assumed that the dependence is reasonably stable and can be characterized, but such a dependence is not included in the description herein.

A qubit response can be described by a rotation matrix

$$R ( θ , ϕ ) = ( \begin{matrix}cos \frac{θ}{2} & - {ie}^{- i ϕ} sin \frac{θ}{2} \\ - {ie}^{i ϕ} sin \frac{θ}{2} & cos \frac{θ}{2}\end{matrix} ) , \qquad ( 1 )$$

where θ is the Rabi angle and ϕ is the gate phase. By convention, a GPi2 gate corresponds to θ=π/2; ϕ=0 is an X gate, while ϕ=π/2 is a Y gate. The gate phase ϕ can be controlled by the AOM RF phase, while the Rabi angle θ≡Ωt. The quantity Ω is the two-photon Rabi rate, proportional to the product of the electric field amplitudes from the primary and secondary beams, and t is the duration of the gate. Currently, t is presumed constant, typically ≈15 us for a GPi2 gate. Thus, stabilizing the unitary gate operation can be achieved by stabilizing the two-photon Rabi rate Ω.

A convenient measure of the Rabi rate can be obtained by concatenating m GPi2 gates together, and measuring the probability that the ion is in the |1 [symbol] (bright) state. In this case, the probability P_{bright} is given by

$${P}_{bright} = {sin}^{2} ( \frac{m Ω t}{2} ) . \qquad ( 2 )$$

In scenarios where a qubit gate configuration is near the correct gain calibration value, Eq. (2) can be linearized around that point for m=4N+1 applications of the GPi2 gate, where P_{bright}=0.5. In this case, an estimate of P_{bright} can be directly converted into an estimate of Ω. Such a linearization is described in detail below.

### Gain and Beam Steering Model

To incorporate the ion response to beam alignment and GPi gain, Ω can be expressed as

$$Ω ( g , {x}_{a} , {x}_{b} ) = {gf}_{a} ( {x}_{a} ) {f}_{b} ( {x}_{b} ) , \qquad ( 3 )$$

where g is the RF gain for the primary beam (which can be directly proportional to the electric field amplitude), ƒₐ(xₐ) is a function describing the electric field profile of the primary beam as a function of position xₐ, and ƒ_{b}(x_{b}) is a function describing the electric field profile of the secondary beam as a function of position x_{b}. The positions xₐ, x_{b} can be expressed in units of the AOD steering frequency, such that ƒₐ and ƒ_{b} are functions of pri_steering_freq and sec_steering_freq, respectively.

It can be a good approximation to model the beam electric field profile with a Gaussian function. Thus, the following can be considered:

$${f}_{a} ( {x}_{a} ) = {E}_{a} {e}^{- {( {x}_{a} - {\overline{x}}_{a} )}^{2} / {w}_{a}^{2}} \qquad ( 4 )$$

$${f}_{b} ( {x}_{b} ) = {E}_{b} {e}^{- {( {x}_{b} - {\overline{x}}_{b} )}^{2} / {w}_{b}^{2}} , \qquad ( 5 )$$

where Eₐ and E_{b} are defined to be proportional to the electric field intensity for each beam; wₐ and w_{b} are waist parameters of each beam; and x̅ₐ and x̅_{b} represent the ideal beam alignment, where fluctuations in Ω due to beam pointing noise can be minimized.

### Linearized Models

Linearized models can be provided by linearizing Eq. (2) about Ω̅, such that Ω̅t=θ=π/2. To that end, Ω can be re-written as follows:

$$Ω = \overline{Ω} ( 1 + {ϵ}_{Ω} ) \qquad ( 6 )$$

such that Eq. (2) becomes

$${P}_{bright} = {sin}^{2} [ \frac{m π}{4} ( 1 + {ϵ}_{Ω} ) ] . \qquad ( 7 )$$

The quantity ϵ_{Ω} is the fractional deviation of Ω from the ideal value Ω̅ that would yield a GPi2 gate. Expanding Eq. (7) about ϵ_{Ω}=0 yields

$${P}_{bright} = \frac{1}{2} + \frac{m π}{4} {ϵ}_{Ω} , \qquad ( 8 )$$

for m=4N+1 gates. The linearized error function is then

$${ϵ}_{Ω} = \frac{4}{m π} ( {P}_{bright} - \frac{1}{2} ) . \qquad ( 9 )$$

The fact that Ω is a multi-variate function of beam position and GPi gain can be addressed. There are numerous strategies to sample over {g, xₐ, x_{b}} to extract the ideal values of each in fewer measurements. One example solution that is straightforward is to separate the timescale of each control loop depending on the measured drift and sensitivity to the underlying parameters. For example, Ω can be stabilized by feeding back to g, and on a much slower timescale independently correct the positions xₐ, x_{b}. When an update is made to either xₐ or x_{b}, a beam shape model can be used to also update g to reduce large discontinuities in that parameter when the beams are realigned.

### Linearized Model in g

The linearized model in g is quite straightforward because Ω×g. If g is defined as

$$g = \overline{g} ( 1 + {ϵ}_{g} ) , \qquad ( 10 )$$

$$then$$

$${ϵ}_{g} = \frac{4}{m π} ( {P}_{bright} - \frac{1}{2} ) . \qquad ( 11 )$$

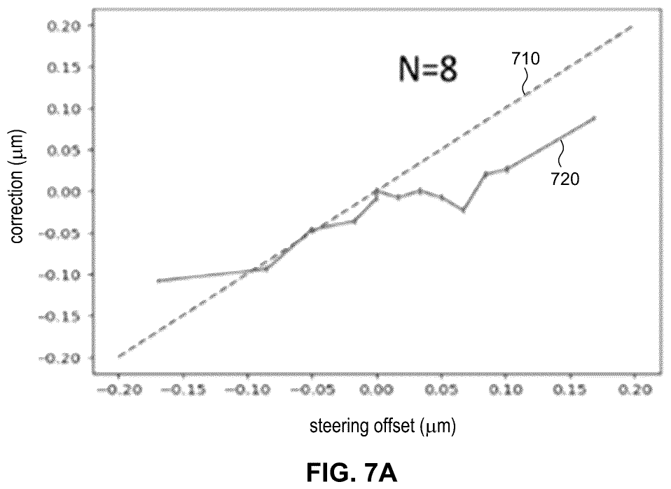

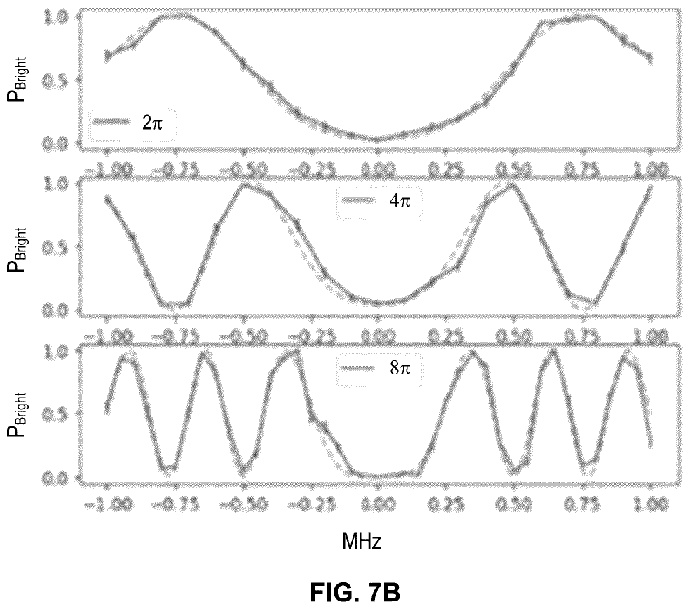

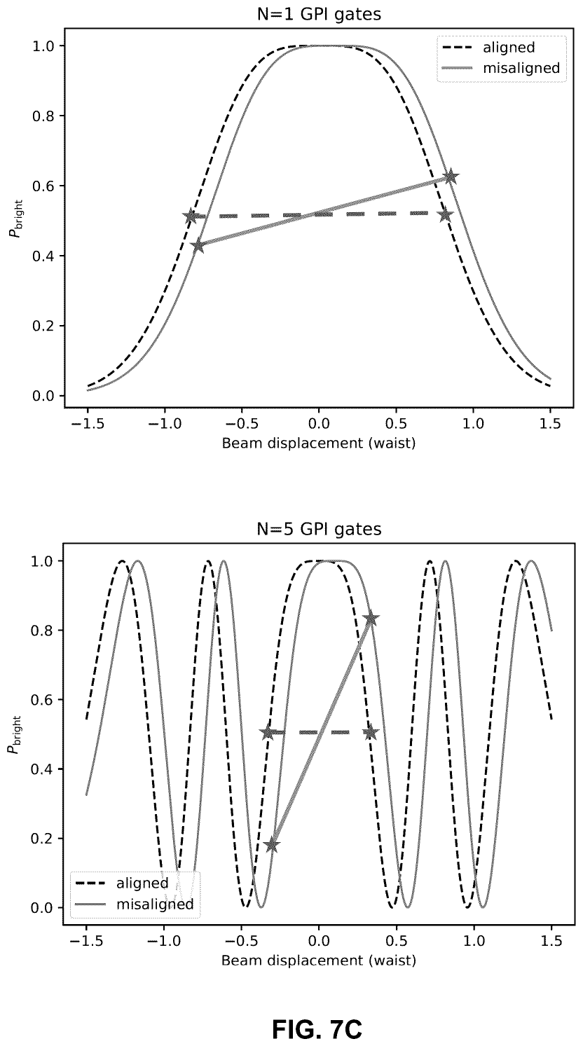

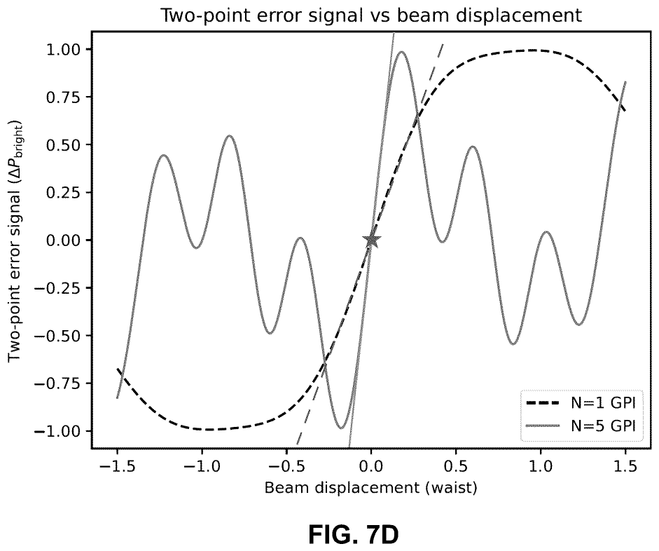

FIGS. 7A-7D illustrate an example of a dual side-of-peak point check procedure, in accordance with aspects of this disclosure. In such a procedure, two measurements can be made, one on each side of the peak after a beam steering has been displaced by an amount +ΔX and −ΔX; P_{bright} can be measured at each displacement after the application of N GPi gates, resulting in a measured value of P_{bright} at +ΔX and another measured value of P_{bright} at −ΔX; and an error signal can be generated by subtracting the two measured values of P_{bright}. Beam steering can then be updated based on population difference. Although this technique can consume twice as much data as a traditional “point check,” this technique has the advantage of removing sensitivity to the overall beam intensity, corresponding to the GPi gain calibration value.

Specifically, FIG. 7A illustrates correction as a function of steering offset after application of a defined number of GPi gates, where the steering offset can be changed arbitrarily in some cases. An idealized correction is shown as a dashed line 710 and corrections responsive to a steering offset are shown as trace 720. FIG. 7B illustrates P_{bright} as a function of frequency, where in each of the shown panels, idealized changes in P_{bright} are represented by a dashed line and measured changes are shown with a line-symbol trace. FIG. 7C illustrates P_{bright} after application of a defined number N of GPi gates. FIG. 7D illustrates two-point error signal as a function of beam displacement for the two example numbers of GPi gates shown in FIG. 7C.

Linearized Model in xₐ, x_{b}

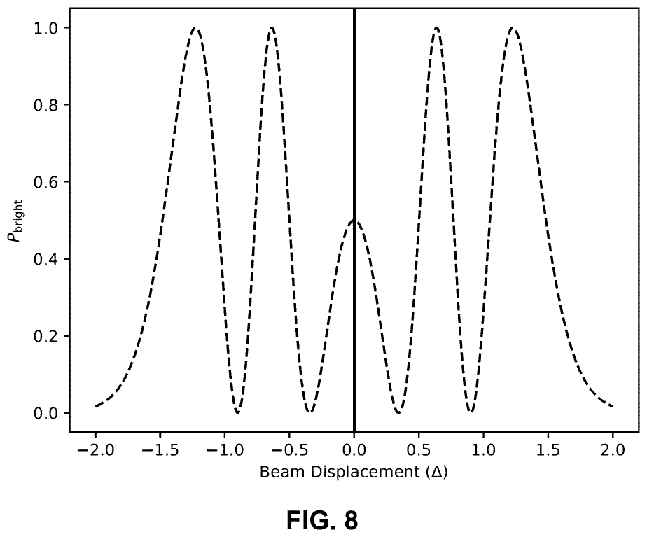

Extracting an independent estimate of xₐ from a single measurement of P_{bright} may be difficult. Because the first derivative of fa vanishes at the ideal alignment, a measurement in the neighborhood of x̅ₐ may not yield “which way” information to correct the steering. Instead, a measurement offset by a known amount from the peak can be made, and under the assumption that g̅ is known, deviation from the desired value can yield the correction. If g̅ is not known, a similar measurement can be made on either side of the peak and the difference can be used to construct the desired correction. When an estimate of x̅ₐ is correct, the ion response should be symmetric as the steering is offset in opposite directions, and thus the difference between P_{bright} as measured on either side of the peak should be zero. FIG. 8 illustrates such a procedure and symmetry. In some cases, the measurement can scan several points over the peak and fit to extract an estimate of x̅ₐ, similar to what is done in a more traditional scan.

In the situation where g̅ is presumed calibrated, an initial empirical model of the beam shape can be adopted by scanning in one direction some Δ=(xₐ−x̅ₐ)/wₐ. A slope k can be extracted along one of the linear regions offset from xₐ, and thus can have an error function

$${ϵ}_{{\overline{x}}_{a}} = k ( {P}_{bright} - \frac{1}{2} ) \qquad ( 12 )$$

when measuring offset by the appropriate amount. FIG. 8 illustrates the shape of this curve; that is P_{bright} as a function of beam displacement Δ (in units of the waist) from the ideal alignment x̅ₐ assuming a 4N+1-GPi2 measurement circuit. If the gain g is calibrated, this can produce a very sharp error signal for the displacement when offset to one side of the peak. In such an approach, in some cases, the error signal might become convolved with the GPi2 gain calibration, whereas the technique described herein in connection with FIGS. 7A-7D should be first-order insensitive to such a convolution.

### Noise Parameter Distributions

The ideal value g̅, x̅ₐ, x̅_{b} may be time dependent (for example, exhibit linear drift). These values also may be assumed to be sampled from an underlying distribution at every experimental shot (which may be referred to as “shot-to-shot” noise). In one example approach, such a distribution can be considered to be Gaussian. The disclosure is not limited in that respect and other distributions can be considered. Indeed, in some cases, the exact shape of the distribution for a particular quantum hardware can be identified and utilized. Collecting statistics for the distribution P_{bright} is equivalent to constructing an ensemble average over many realizations of the (noisy) random variables g̅, x̅ₐ, x̅_{b}. The parameters of these distributions can inform the closed-loop control strategy—for example, if g̅ is very tightly distributed, it might be advantageous to expend more effort estimating and tracking x̅ₐ, x̅_{b} to reduce the overall variance in Ω. Ultimately, the relevant cost function for the controller only depends on Ω, and the objective is to minimize the total variance of Ω.

### Simulation Results

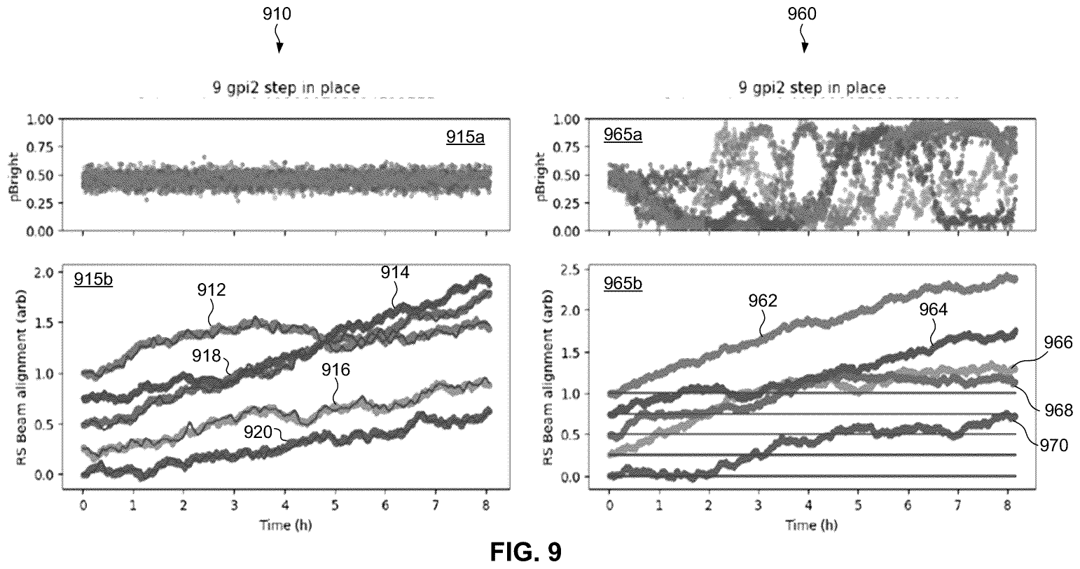

Closed-loop control strategies can be validated via simulations. As an example, random walk drift on the RS beam can be tracked using the error signal strategy described in connection with FIGS. 7A-7D and a modified PI loop filter (or PI controller). Every T seconds, the control agent inserts N shots of two calibration quantum circuits (measuring each side of the peak). The instantaneous error signal is the measured difference in P_{bright} for each qubit, which difference is fed into the PI controller module. As it can be gleaned from FIG. 9, even in example simulations with no rigorous optimization, the closed-loop control tracks the beam drift across the qubit register without cutting significantly into the system uptime. More specifically, panels 910 in FIG. 9 illustrates simulation results for a simple PI controller that tracks beam drift under random walk noise. In addition, as a comparison, panels 960 in FIG. 9 illustrates simulation results for the same noise process, but without closed-loop control. Each of the different grey-scale traces formed by solid dots corresponds to a different qubit in quantum hardware (e.g., quantum hardware 430 or quantum hardware 610). To facilitate comparison, a given hue of grey of a trace in a panel in FIG. 9 corresponds to the same hue of grey in all other panels. Panel 915a and Panel 965a each presents P_{Bright} as a function of time (or temporal drift of P_{Bright}). Panel 915b and Panel 965b each presents temporal dependence of a control parameter. Solid-line traces in each panel correspond to predicted value of a defined control parameter for respective qubits. The grey-scale traces formed by solid dots represent actual ground-truth physical value of the parameter. Trace 912 corresponds to a first qubit q₁, trace 914 corresponds to a second qubit q₂, trace 916 corresponds to a third qubit q₃, trace 918 corresponds to a fourth qubit q₄, and trace 920 corresponds to a fifth qubit q₅. Trace 962 corresponds to the first qubit q₁, trace 964 corresponds to the second qubit q₂, trace 966 corresponds to the third qubit q₃, trace 968 corresponds to the fourth qubit q₄, and trace 970 corresponds to the fifth qubit q₅. As mentioned, from FIG. 9, it can be gleaned that the closed-loop control in accordance with aspects of this disclosure provides a superior control paradigm. The solid lines represent the value of the control parameter, and the dots represent the actual ground-truth physical value. Other types of simulations can be implemented in order to validate different control strategies. Simulations can be implemented using, among other computing tools, open-source or custom-based scientific libraries, for example.

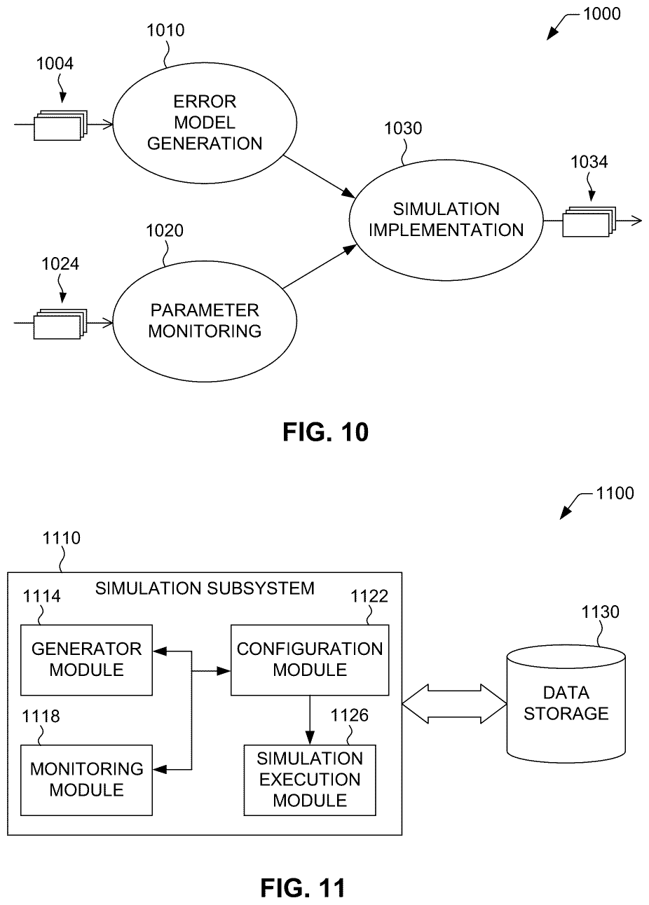

FIG. 10 illustrates an example of a technique for simulations in accordance with one or more embodiments of this disclosure. The example technique 1000 can be implemented by simulation subsystem 1100 as is illustrated in FIG. 11. The example technique 1000 has multiple stages. In a first stage 1010 (referred to as an error model generation stage 1010) a first error channel of quantum hardware can be constructed. Examples of the quantum hardware include quantum hardware 430 (FIG. 4) and quantum hardware 610 (FIG. 6A). In some cases, the first error channel corresponds to a gate-level error channel. Thus, to construct the first error channel, data 1004 is received at the first stage 1010 where the data 1004 define attributes of one or more native gates configured in the quantum hardware. The data 1004 can originate from the application of a tomography protocol or from measurement(s) of a microscopic parameter, or a combination of both. The data 1004 can be generated during an offline period of a QIP system that includes the quantum hardware. An example of the tomography protocol includes gate set tomography (GST). In trapped-atom architectures, examples of microscopic parameters include Rabi rate, phase, or frequency noise. The simulation subsystem 1110 (FIG. 11) includes a generator module 1114 that can implement the first stage 1010. The data 1004 can be accessed from one or more memory devices 1130 (collectively referred to as data storage 1130). The data storage 1130 can be part of the control subsystem 410 (not depicted in FIG. 11) in some cases.

The first error channel represents a gate error model that can be cast in a way that removes any systematic calibration component (so-called “coherent error”). Later, the coherent error mechanisms can be controllably mixed in to model systematic calibration errors that a control agent can be designed to remove. As an illustration, GST could be used to characterize a particular gate error channel, using a model that includes a coherent offset and a stochastic component to a particular microscopic parameter. For example, the Rabi rate error model could be cast as ΔR+N(σ_{R}), where ΔR represents a coherent miscalibration and N(σ_{R}) indicates stochastic noise drawn from a normal distribution with standard deviation σ_{R}. Such a model can be simulated with the coherent component, ΔR, set to zero—this corresponds to the case where the calibration is perfect and all that remains is the stochastic noise which cannot be captured via calibration parameters. To simulate a particular control strategy, some amount of ΔR can then be added into the model—that is, the coherent error mechanism can then be controllably mixed in-which is hidden from the closed-loop controller (control agent) as it would be in a real system. The task of the closed-loop controller is to deduce the amount of ΔR that has been added into the simulation, corresponding to some unknown drift of the physical hardware, and to generate a correction that removes the coherent error ΔR that has been added in simulation to mimic unknown drifts of the system. Stated equivalently, a model of the error channel is assumed to separate into two parameters: a systematic parameter and a stochastic parameter. Thus, a fit of the channel can generate both systematic and stochastic parameters, but in simulation, it is possible to set the systematic parameter to zero to mimic what would happen in a scenario where the closed-loop controller (control agent) removed all calibration error.

In a second stage 1020 (referred to as a parameter monitoring stage 1020) of the example technique 1000, temporal dependencies of a set of calibration parameters can be monitored. The set of calibration parameters can include one or more calibration parameters. Monitoring temporal dependencies of the set of calibration parameters includes monitoring respective temporal dependencies of at least one (or in some cases, each one) of the calibration parameters that form the set. The simulation subsystem 1110 (FIG. 11) includes a monitoring module 1118 that can implement the second stage 1020.

As is described herein, a calibration parameter pertains to equipment that can be used to control the execution of a quantum mechanical operation within quantum hardware. The temporal dependence of a calibration parameter can be monitored in numerous ways. In some cases, the temporal dependence of the calibration parameter can be monitored by measuring the calibration parameter over time. Specifically, the calibration parameter can be measured at various times during offline periods and/or online periods of a QIP system that includes the quantum hardware. The calibration parameter can be measured periodically, according to a schedule, or in response to a particular event. The monitoring module 1118 (FIG. 11) can direct or otherwise cause one or more sensor devices to measure, individually or collectively, a calibration parameter. The quantum hardware includes the sensor device(s). In response, the monitoring module 1118 can receive observed data 1024 (FIG. 10) indicative of values of one or more calibration parameters at various times. The data 1024 can be received or otherwise accessed from the data storage 1130.

In other cases, a temporal dependence of a calibration parameter can be monitored by measuring a noise power spectrum of the calibration parameter. Such a noise power spectrum can be measured at a particular duty cycle during a defined time interval while the QIP system is in operation. The particular duty cycle is greater than a duty cycle used in a measurement cycle (or shot) in the quantum hardware included in the QIP system, during execution of a production quantum circuit. In that way, sufficient data representative of the temporal dependence can be obtained. Measuring the noise power spectrum results in second observed data 1024. The temporal dependence of the calibration parameter can then be obtained by generating the temporal dependence from the second observed data 1024. For example, generating the temporal dependence includes applying an inverse Fourier transform to the measured noise power spectrum. As mentioned, the monitoring module 1118 (FIG. 11) can direct or otherwise cause one or more sensor devices to measure, individually or collectively, the noise power spectrum of the calibration parameter. In response, the monitoring module 1118 can receive the second observed data 1024 defining the noise power of the calibration parameter. The monitoring module 1118 can then generate such a temporal dependence from the observed data 1024.

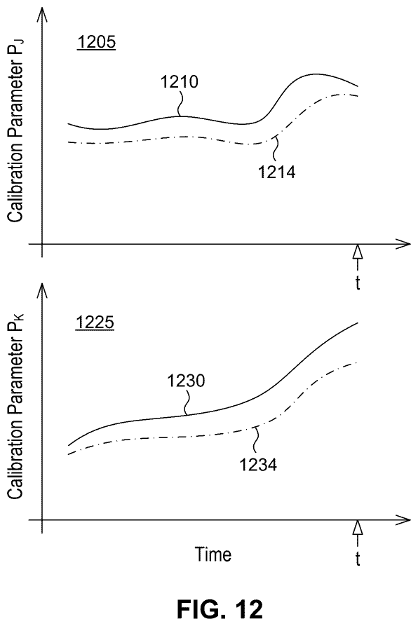

Simply for the sake of illustration, FIG. 12 presents a plot 1205 and a plot 1225 of respective schematic temporal dependencies of a calibration parameter P_{J} and a calibration parameter P_{K} in quantum hardware. A trace 1210 represents an observed temporal dependence of P_{J} that can be obtained as described herein. A trace 1215 represents a calculated temporal dependence of P_{J} according to a control model. Similarly, a trace 1230 represents an observed temporal dependence of P_{K} that also can be obtained as described herein. A trace 1235 represents a calculated temporal dependence of P_{K} according to the control model. As is described herein, the control model is defined by a time-dependent function parameterized by a group of weights (e.g., one, two, or more weights). The control model can be one of the model(s) 418 (FIG. 4).

With further reference to FIG. 10, in a third stage 1030 (referred to as a simulation implementation stage 1030) of the example technique 1000, a second error channel is obtained. The second error channel is based on (i) one or more temporal dependencies of respective calibration parameters and (ii) a control model. Without intending to be bound by theory and/or modeling, each one of the temporal dependencies can be considered to represent a “ground truth” of a respective calibration parameter. Here, “ground truth” refers to the values of the calibration parameter that are adopted over time by equipment within the quantum hardware. As an example, trace 1210 represents the “ground truth” of calibration parameter P_{J}, and trace 1230 represents the “ground truth” of calibration parameter P_{K}. At a particular time, the one or more ground truths associated with respective calibration parameters collectively define a state of the equipment within the quantum hardware. Such a state can be referred to as a “physical state” of the quantum hardware, and can be denoted by [symbol] = [symbol] (t). The control model, on the other hand, defines instantaneous values of the respective calibration parameters. To that end, as is described herein, the control model is defined by one or more time-dependent function parameterized by a group of weights (e.g., one, two, or more weights). A value of one of the time-dependent function(s) at a defined time defines the instantaneous value of a calibration parameter at the defined time. The instantaneous values of respective calibration parameters collectively define, at a particular time, another state of the equipment within the quantum hardware. Such a state can be referred to as a “control state” of the quantum hardware, at the particular time. The control state can be denoted by [symbol] = [symbol] (t).

The second error channel can be generated using a function ƒ( [symbol] ) that defines the second error channel; that is, the function ƒ( [symbol] ) maps both the control state C and the physical state [symbol] to the second error channel. The function ƒ( [symbol] ) quantifies how respective values of [symbol] and [symbol] differ from one another, and can be referred to as a cost function. The function ƒ( [symbol] ) can be the difference between [symbol] and [symbol] , for example, but this disclosure is not limited to that function. Regardless of its form, the second error channel can be combined with the first error channel obtained in the error model generation stage 1010, resulting in a net error channel. The simulation subsystem 1110 (FIG. 11) includes a configuration module 1122 that can obtain the second error channel, and can then generate the net error channel. There are many ways to combine the first error channel and the second error channel. In one example, these channels can be combined via an additional model of the QIP system, where that additional model is determined separately and validated. The additional model can be validated by changing calibration parameters by defined amounts and measuring error channels via tomography techniques. Other techniques also can be used to validate these models. In some cases, the function ƒ( [symbol] ) can compute an additional offset to the error channel parameters used above. Continuing with the example described hereinbefore, if the Rabi rate control differed from the ground truth by an amount δ, then ƒ( [symbol] )=δ and the amount δ can be used as ΔR in the error channel model. In some scenarios, differences between control and ground truth may increase the value of sigma for other parameters. For example, a beam alignment that is off can cause an increased discrepancy of the coherent/systematic component of the Rabi rate ΔR. Such beam misalignment also can increase the stochastic component σ_{R} because small pointing fluctuations in the misaligned beam can sample a slope in the Rabi rate from being on the side of the beam profile, and it is assumed that these pointing fluctuations are fast compared to the timescale of calibration.

A net error channel as is described herein can be used to simulate a calibration quantum circuit at the simulation implementation stage 1030 (FIG. 10). A simulation of a calibration quantum circuit, using the net error channel, yields results that represent a physically-realistic measurement record. As part of the simulation implementation stage 1030, such a measurement record can be supplied to a control agent as if the results were observed data from the quantum hardware included in a QIP system. Such results are included in data 1034 supplied by the computing system that implements the simulation implementation stage 1030. To perform a simulation in such a fashion, the configuration module 1122 can pass the net error model to an execution module 1126. The execution module 1126 can then implement the simulation, thus generating the data 1034. The data 1034 can be retained in the data storage 1130.

Without intending to be bound by theory and/or modeling, to implement the simulation, physically realistic trajectories of respective control parameters (e.g., Pⱼ and Pₖ shown in FIG. 12) are accessed. These trajectories can be generated or can be obtained in another fashion. Such trajectories can be generated by tracking the respective control parameters over a historical period in an experiment, and then applying the techniques described herein in connection with FIG. 12—that is, determining a power spectral density and then inverting the power spectral density to generate random samples of time-domain traces that are consistent with that power spectral density. The disclosure is not limited in that respect, and other techniques can be used to generate physically realistic trajectories of control parameters. For instance, generative machine learning methods can be used to generate such trajectories. Then, the simulation of the full system includes computing the net error model based on ƒ( [symbol] ), where [symbol] is determined by one of the random samples of time-domain parameter traces, and [symbol] is determined by the control agent. The result of simulating the net error model is then fed back to the control agent, and the control agent selects a next control point [symbol] [i+1], where i in an index representing an iteration in the simulation. In some cases, selecting the next control point can be based on a random (or pseudo random) selection of the next control point from a pool of control points or according to a probability distribution. A next ground truth value is then supplied by the predetermined random sampling of the time-domain parameter traces, and the net error model is computed again with the new control value, ƒ( [symbol] [i+1], [symbol] [i+1]). After the simulation completes, a success metric can be determined. An example of the success metric is the RMS deviation between the control [symbol] and the ground truth [symbol] . The success metric can be used to tune the behavior of the closed-loop control agent in simulation.

The simulation subsystem 1110, via the simulation execution module 1126, can execute a simulation of a calibration quantum circuit forward in time relative to a reference instant (or point in time). At any particular time, the performance of a control agent can be represented by an instantaneous control state. Such a performance can be compared to the instantaneous physical state of quantum hardware (e.g., quantum hardware 430 or quantum hardware 610) as a control strategy is changed from simulation to simulation. The control strategy can be changed by changing hyperparameters that individually or in a particular combination define or otherwise configure one or more weights of a control model. Such weights can be deemed other type of hyperparameters that ultimately result from a selection of the hyperparameters being changed from simulation to simulation. Changing the control strategy across simulations permits the tuning of a class of control agents to perform satisfactorily in a physically-realistic scenario. A degree of how satisfactory a performance of a control agent is can be represented by a metric or a score of some sort that quantifies how different the control state is from the physical state.

Execution of the example technique 1000 can permit configuring various aspects of a control agent. In particular, the simulation subsystem 1110 can generate a satisfactory (e.g., optimal or nearly optimal) configuration of several design parameters of a control agent. More specifically, as an example, for each calibration parameter, the simulation subsystem 1110 can permit generating calibration quantum circuits with varying sensitivities to a desired calibration parameter. This provides a measurement “gain” that can be optimized. For purposes of illustration, measurement “gain” refers to a quantum circuit that can be repeated multiple times such that the output is more sensitive to changes in the microscopic parameters (e.g., Rabi rate). As an example, a single GPi2 gate can be implemented or multiple (e.g., N>1) GPi2 gates can be implemented. The probability of measuring the qubit in the |1 [symbol] state can be expressed as P_{bright}=sin²(NRabiᵣₐₜₑ*π/2) (for some normalization convention for Rabi rate). For a large N, P_{bright} is very sensitive to small changes in Rabi rate. There are similar analogs to this measurement “gain” for other calibration parameters. Without intending to be bound by theory and/or modeling, it is noted that if the gain is too high, a measurement result may completely decohere due to stochastic fluctuations, and thus, may not provide any useful information to the calibration agent. Therefore, it is desirable to optimize the measurement “gain.” Similarly, many of the measurement signals are periodic, thus observing a particular outcome does not uniquely determine the calibration parameter value. The control agent may then choose to start with a small gain, such that the control agent can find the right branch of the sinusoidal signal, and then increase the gain to derive higher sensitivity to drifts in that parameter after the control agent has determined a parameter that is close to the correct value.

In addition, for each calibration parameter, the simulation subsystem 1110 can permit analyzing duty cycle of measurement cycle, number of shots of each calibration quantum circuit, and/or filtering strategies to smooth the measurement shot noise. As a result of such analysis, the simulation subsystem 1110 can adjust the design parameters to optimize a cost function that quantifies a deviation of a predicted control state from a physical state of quantum hardware. An example of the cost function is root-mean-square (RMS) deviation of the predicted control state from the physical state (or ground truth) of the quantum hardware.

The above design parameters may be a function of the stochastic system noise, measurement noise, and drift timescale. At different times during the operation of a QIP system, the drift timescale of a calibration parameter may change. Indeed, empirically, the QIP system has periods of time where the drift is slow and periods when the drift is fast. The control agent can be designed to optimize the duty cycle and gain depending on the observed noise and drift timescale, to minimize the overhead associated with calibration.

Given the realistic calibration parameter traces determined as is described hereinbefore and schematically illustrated in FIG. 12, several machine learning (ML) strategies or other predictive modeling strategies, such as the class of auto-regressive models, can be used to predict a parameter value into the future. The simulations described in this disclosure can be used to train predictive models before testing the model on physical hardware. The physical hardware can include, for example, the equipment 630 or other hardware present in the quantum hardware 610, or hardware present in the quantum hardware 430. As the closed-loop control agents track the calibration state over extended periods of time, additional training data can be generated as is described hereinbefore and schematically illustrated in FIG. 12, and used to refine the operation of the control agents.

In some cases, autoregressive models or recurrent neural networks can be used. For purposes of illustration, an autoregressive model is a form of predictive model where future data points are assumed to be a function of historical data points (with particular weights) and a stochastic noise term. The predictive model can be generated by determining weights in the autoregressive model, and using the predictive model to predict future data points. As additional data points are measured, the weights of the autoregressive model can be updated to maintain satisfactory predictive power. In some configurations, the QIP systems in accordance with aspects of this disclosure can include a predictor generation subsystem that can generate the predictive model. To that end, the predictor generation subsystem can obtain calibration data indicative of historical values of one or more calibration parameters. The predictor generation subsystem can fit or train the predictive model based on such data (or historical records), resulting in a trained predictive model. One or more components within a QIP system or a system coupled therewith can apply the trained predictive model to predict future values with some confidence. The application of the trained predictive model can be combined with measurements of the QIP system state in order to determine whether additional calibration data is needed or whether confidence in the predicted values is satisfactory and such values can be used for production quantum circuits without acquiring additional calibration data.

This disclosure, however, is not limited to those models and related techniques. Regardless of the type of technique used to generate predictive models (e.g., ML models and associated ML techniques), an objective of training is to determine a model that can reliably predict future data better than a “null model,” where the null model keeps the last calibration parameter value for all time in the future. In other cases, a straightforward approach that does not use any machine learning techniques can include performing a polynomial fit (e.g., a linear fit, a quadratic fit, or the like) to the most recent M datapoints indicative of a calibration parameter, and using the resulting polynomial to extrapolate into the future. Using the resulting polynomial in such a fashion includes evaluating the resulting polynomial at a particular time after a defined time. The defined time is, in one example, the time corresponding to the most recent datapoint of the M datapoints.

A machine learning model can be trained in numerous ways, using, for example, realistic time-series data representing temporal dependences of respective calibration parameters. In this disclosure, a temporal dependence of a calibration parameter also can be referred to as a temporal trace or a temporal trajectory. Such data can be generated in accordance with aspects described herein. More specifically, a subset of these temporal traces can be configured and used as training datasets. The machine learning model can then be trained such that, given the previous M−1 datapoints, the machine learning model predict a next datapoint with high or otherwise satisfactory confidence, and do so over a wide variety of training data. Training the machine learning model includes tuning (or adjusting) a set of one or more parameters that define the machine learning model. The machine learning model so tuned constitutes a predictive model. To validate this predictive model, another set of temporal traces not used for training can be selected or otherwise configured, and the predictive performance of the predictive model can then be evaluated on this other set. The tuning and validation stages can be reiterated until a satisfactory predicted model is obtained. The validated predictive model can be used to predict the temporal traces (or temporal trajectories) of calibration parameters into the future. A validated predictive model (even if non-optimal) can reduce the difference between the calibration parameter and the ground truth of the calibration parameter, thus improving system performance in the absence of any additional calibration measurements. Such a validated predictive model also can reduce the overhead required to increase performance above what would be achieved by the predictive model alone.

Because it typically is much more expensive to use the physical hardware to perform a calibration, having a realistic simulation environment can significantly more efficiently use physical resources of a QIP system. Even a low-fidelity predictive model can remove a large component of calibration parameter drift, thus reducing the calibration overhead. Accordingly, embodiments of this disclosure can provide an approach to calibration that is more efficient than, and thus superior to, existing approaches to calibration of quantum hardware.

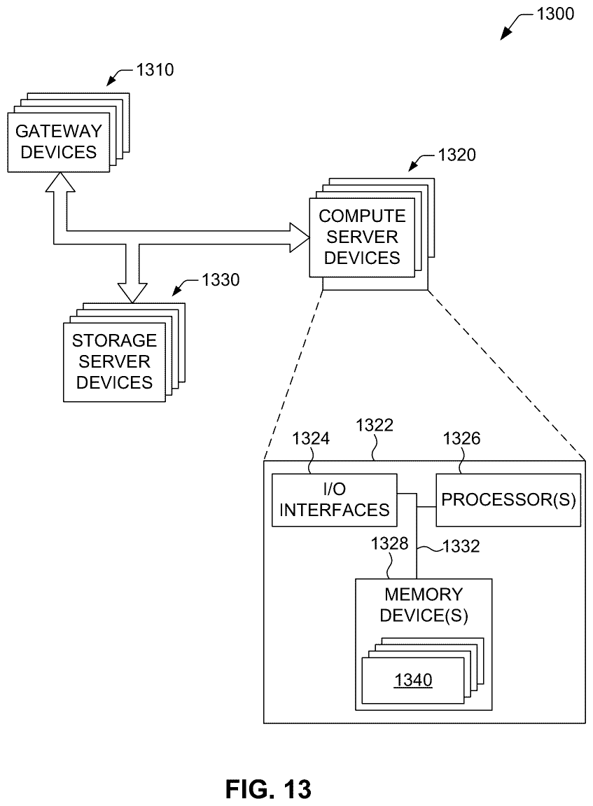

FIG. 13 is a schematic block diagram of an example of a computing system 1300, in accordance with one or more embodiments of this disclosure. The example computing system 1300 can embody, or can be part of, the control subsystem 410, the intermediate representation subsystem 550, the compiler subsystem 570, the predictor generation subsystem 810, the simulation subsystem 1110, or a combination of those subsystems, described herein in connection with example systems of this disclosure. Accordingly, the example computing system 1300 can provide at least some of the functionality described herein in connection with closed-loop control and calibration in accordance with aspects described herein.

The computing system 1300 includes multiple computing devices that can be arranged in a cloud architecture. As such, the example computing system 1300 includes two types of server devices: Compute server devices 1320 and storage server devices 1330. A subset of the compute server devices 1320, individually or collectively, can host various modules 1340 that permit implementing closed-loop control and calibration in accordance with aspects described herein. Thus, the subset of compute server devices 1320 can operate in accordance with functionality described herein in connection with subsystems described herein, including one of the control subsystem 410, the compiler subsystem 570, or the simulation subsystem 1110, or a combination of those subsystems. The architecture of each of the compute server devices 920—as is illustrated with reference to a particular compute server device 1322—includes multiple input/output (I/O) interfaces 1324, one or more processors 1326, one or more memory devices 1328, and a bus architecture 1332 that functionally couples the processor(s) 1324, the memory device(s) 1328, and the I/O interfaces 1324. In some cases, the compute server device 1322 can store the modules 1340 in at least one of the memory device(s) 1328. The compute server device 1322 also can store other modules in the memory device(s) 1328, where those other modules provide some functionality of the compute server device 1322.

At least the subset of the compute server devices 1320 can be functionally coupled to one or multiple ones of the storage server devices 1330. The coupling can be direct or can be mediated by at least one of the gateway devices 1310. The storage server devices 1330 include data and/or metadata that can be used to implement the functionality described herein in connection with tandem execution of quantum circuits in accordance with aspects described herein.

Each one of the gateway devices 1310 can include one or multiple processors functionally coupled to one or multiple memory devices that can retain application programming interfaces (APIs) and/or other types of program code for accessing to the compute server devices 1320 and storage server devices 1330. Such access can be programmatic, via a defined function call, for example. The subset of the compute server devices 1320 that host one or a combination of modules (e.g., modules 1340) that can use API(s) supplied by the gateway devices 1310 in order to provide results of implementing the functionalities described herein in connection with tandem execution of quantum circuits in accordance with aspects described herein.

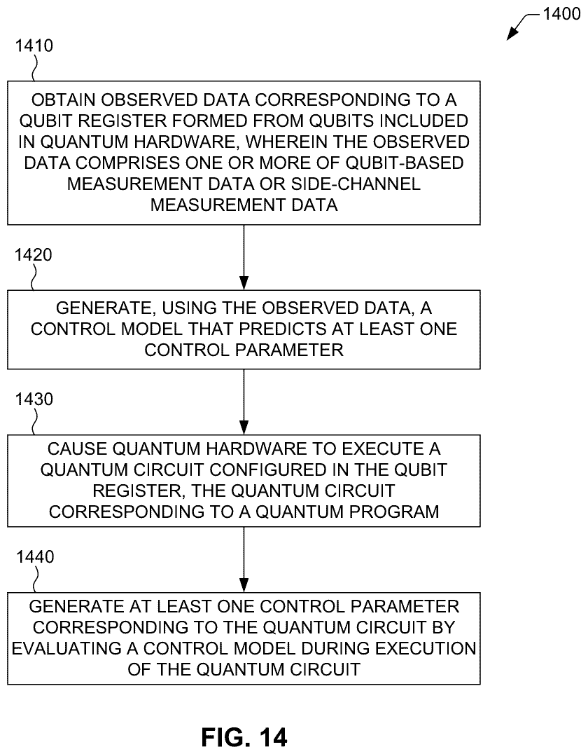

Example of methods that can be implemented in accordance with this disclosure can be better appreciated with reference to FIGS. 14-17. For purposes of simplicity of explanation, example methods disclosed herein are presented and described as a series of acts. The example methods are not limited by the order of the acts, as some acts may occur in different orders and/or concurrently with other acts from that shown and described herein. In some cases, one or more example methods disclosed herein can alternatively be represented as a series of interrelated states or events, such as in a state diagram depicting a state machine. In addition, or in other cases, interaction diagram(s) (or process flow(s)) may represent methods in accordance with aspects of this disclosure when different entities enact different portions of the methodologies. It is noted that not all illustrated acts may be required to implement a described example method in accordance with this disclosure. It is also noted that two or more of the disclosed example methods can be implemented in combination with each other, to accomplish one or more functionalities described herein.

Methods disclosed herein can be stored on an article of manufacture in order to permit or otherwise facilitate transporting and transferring such methodologies to computers or other types of information processing apparatuses for execution, and thus implementation, by one or more processors, individually or in combination, or for storage in a memory device or another type of non-transitory computer-readable storage device. In one example, one or more processors that enact a method or combination of methods described herein can be utilized to execute program code retained in a memory device, or any processor-readable or machine-readable storage device or non-transitory media, in order to implement method(s) described herein. The program code, when configured in processor-executable form and executed by the one or more processors, causes the implementation or performance of the various acts in the method(s) described herein. The program code thus provides a processor-executable or machine-executable framework to enact the method(s) described herein. Accordingly, in some cases, each block of the flowchart illustrations and/or combinations of blocks in the flowchart illustrations can be implemented in response to execution of the program code.

FIG. 14 is a flowchart of an example of a computer-implemented method for updating a control model based on simulation of a quantum system. A computing device or a system of computing devices (or computing system) can implement the example computer-implemented method 1400 in its entirety or in part. To that end, each one of the computing devices includes computing resources that may implement at least one of the blocks included in the example method 1400 and other methods described herein. The computing resources comprise, for example, central processing units (CPUs), graphics processing units (GPUs), tensor processing units (TPUs), memory, disk space, incoming bandwidth, and/or outgoing bandwidth, interface(s) (such as I/O interfaces or APIs, or both); controller devices(s); power supplies; a combination of the foregoing; and/or similar resources. In some cases, a computing system implements the example method 1400.

At block 1410, the computing system can obtain observed data corresponding to a qubit register formed from qubits included in quantum hardware (e.g., quantum hardware 430 (FIG. 4)). Obtaining the observed data includes receiving one or more of qubit-based measurement data or side-channel measurement data. As is described herein, the qubit-based measurement data define one or more bitstrings representative of respective states of the qubit register. The side-channel measurement data define a state of a classical device. Obtaining the observed data can include, for example, determining a solution to an optimization problem with respect to an objective function, where the solution defining a time interval to obtain the observed data, and causing execution of one or more calibration tasks during the time interval.

At block 1420, the computing system can generate, using the observed data, a control model (or metamodel) that predicts at least one control parameter. As is described herein, the control model (or metamodel) can be defined by a time-dependent function that is parameterized by a group of weights. Generating the control model can be include, for example, determining or otherwise configuring the group of weights. Configuring the group of weights can include updating existing values of respective weights in the group values that have been determined based on the observed data. The control model can correspond to one of a PI controller, PID controller, a linear quadratic regulator (LQR) controller, or a model predictive controller. As is described herein, the control model can be defined in several ways. For example, the control model is defined by a time-dependent function that is parameterized by a group of weights and has a domain that includes side-channel measurement values. As another example, the control model is defined piecewise by at least a first time-dependent function that is parameterized by a first group of weights in a first time interval and a second time-dependent function that is parameterized by a second group of weights in a first time interval.

The computing system can generate the control model in several ways. In one example, the computing system can generate the control model by training, using the observed data, a machine-learning model. In addition, or in another example, the computing system can generate the control model by fitting a compact physical model. Further, or in yet another example, the computing system can generate the control model by generating a regression model.

In some cases, the control model further predicts respective scores for the at least one control parameter. Each one of the respective scores quantifies a confidence on an accuracy of a respective predicted control parameter.

At block 1430, the computing system can cause execution of a quantum circuit configured in the qubit register. Causing execution of the quantum circuit includes directing the quantum hardware to execute the quantum circuit in the qubit register. As part of the example method 1400, the quantum hardware executes the quantum circuit in the qubit register. The quantum circuit corresponds to a quantum program of an end-user of the quantum hardware.

At block 1440, the computing system can generate at least one control parameter corresponding to the quantum circuit by evaluating the control model during execution of the quantum circuit. In some cases, the control model can be evaluated at a time corresponding to a timestamp an instruction of the quantum program is executed in the quantum hardware. In addition, or in some cases, while not illustrated in FIG. 14, the computing system can generate scores for the at least one control parameter by applying the control model, each one of the scores represents an estimate of a confidence level on an accuracy of a respective control parameter.

While not illustrated in FIG. 14, in some cases, the example method 1400 can include other acts or operations. More specifically, in example, as part the example method 1400, the computing system can compile, based on the control model, the quantum circuit corresponding to the quantum program on a subset of the qubits included in the quantum hardware. In addition, or in another example, as part of the example method 1400, the computing system can determine that an update rule is satisfied for a quantum circuit. The update rule can be based on performance of the quantum circuit in the quantum hardware. The computing system also can cause a model generator module, for example, to update the control model. In some configurations, updating the control model includes updating a prediction of a first control parameter of the at least one control parameters. Further, or in another example, as part of the example method 1400, the computing system can generate an event-based interrupt corresponding to the quantum hardware. In addition, the computing system can then cause, in response to the event-based interrupt (via a model generator module for example), to update the control model.

Further, in some configurations, as part of the example method 1400, the computing system can determine that an update criterion for updating the control model is satisfied. In response, the computing system can send a request for second observed data. The computing system can then update, based on the second observed data, the control model.

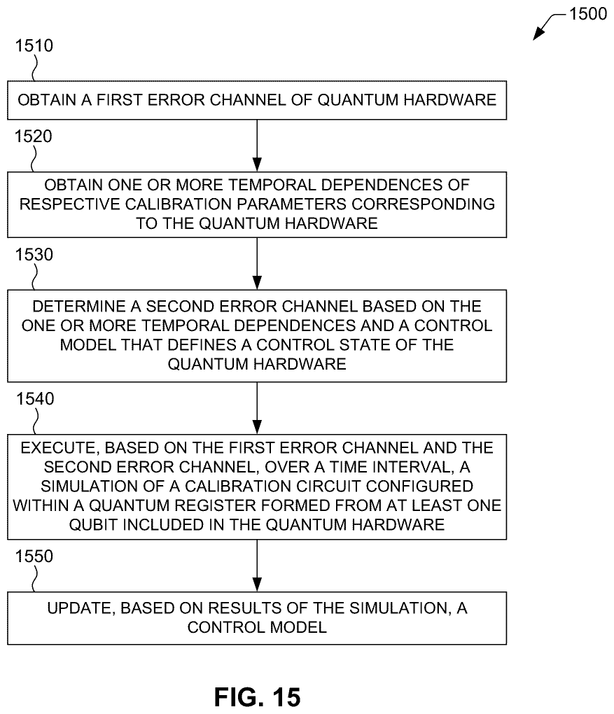

FIG. 15 is a flowchart of an example of a computer-implemented method for updating a control model based on simulation of a quantum system. A computing device or a system of computing devices (or computing system) can implement the example computer-implemented method 1500 in its entirety or in part. To that end, each one of the computing devices includes computing resources that may implement at least one of the blocks included in the example method 1500 and other methods described herein. The computing resources comprise, for example, central processing units (CPUs), graphics processing units (GPUs), tensor processing units (TPUs), memory, disk space, incoming bandwidth, and/or outgoing bandwidth, interface(s) (such as I/O interfaces or APIs, or both); controller devices(s); power supplies; a combination of the foregoing; and/or similar resources. In some cases, a computing system implements the example method 1500. As such, the computing system can host at least one of the generator module 1114, the monitoring module 1118, the configuration module 1122, and the simulation execution module 1126. Accordingly, the computing system can implement the example method 1500 by executing one or more instances of such modules.

At block 1510, the computing system can obtain a first error channel of quantum hardware (e.g., quantum hardware 430 (FIG. 4) or quantum hardware 610 (FIG. 6)). In some cases, the first error channel includes a gate-level error channel. Thus, obtaining the first error channel can include receiving data indicative of attributes of one or more native gates configured in the quantum hardware. The data can originate from a tomography protocol or a measurement of a microscopic parameter, or both. An example of the tomography protocol includes gate set tomography (GST). Examples of microscopic parameters include Rabi rate, phase, or frequency noise.

At block 1520, the computing system can obtain one or more temporal dependencies of respective calibration parameters corresponding to the quantum hardware. In some cases, obtaining such one or more temporal dependencies includes receiving observed data defining a noise power spectrum of a first calibration parameter of the respective calibration parameters. The observed data can originate from measurements of the first calibration parameter at a particular duty cycle during a defined time interval. The particular duty cycle is greater than a duty cycle used in a measurement cycle (or shot) in the quantum hardware during execution of a production quantum circuit corresponding to a quantum program of an end-user. For example, the first calibration parameter can be measured over multiple shots of the production quantum circuit. In addition, obtaining such one or more temporal dependencies also includes generating, using the observed data, a first time-dependence of the first calibration parameter.

In cases where multiple temporal dependences are obtained, the computing system can obtain respective temporal dependences of other calibration parameters in the same fashion. That is, for a second calibration parameter of the respective calibration parameters, the computing system can receive observed data defining a noise power spectrum of the second calibration parameter, and can generate a temporal dependence of the second calibration parameter. In addition, or in some cases, for a third calibration parameter, the computing system can receive observed data defining a noise power spectrum of the third calibration parameter. The computing system can continue such data collection and processing for as many calibration parameters as are present in the respective calibration parameters.

At block 1530, the computing system can determine a second error channel based on (i) the one or more time-dependencies and (ii) a control model that defines a control state of the quantum hardware. As is described herein, the control model is defined by a time-dependent function parameterized by a group of weights (e.g., one, two, or more weights).

At block 1540, the computing system can execute, based on the first error channel and the second error channel, over a time interval, a simulation of a calibration quantum circuit. The calibration quantum circuit is configured within a quantum register formed from at least one qubit included in the quantum hardware. The at least one qubit can include trapped-atom qubit(s) (e.g., a neutral-atom qubit or an ion qubit) or solid-state qubit(s), for example.

At block 1550, the computing system can update, based on results of the simulation, a control model. Updating the control model includes updating at least one weight of the group of weights that parameterizes the time-dependent function defining the control model.

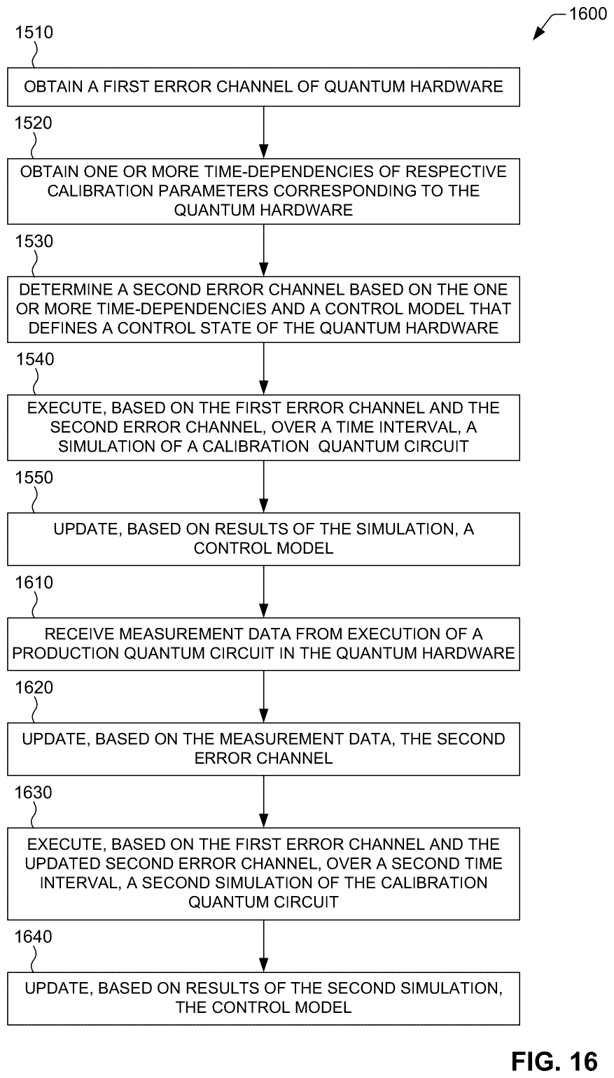

As is illustrated in FIG. 16, the example method 1500 (FIG. 15) can be combined with other operations in order to continue updating a control model. FIG. 16 is a flowchart of an example method 1600 for updating a control model by executing simulations of quantum circuits, in accordance with one or more aspects of this disclosure. The computing system that implements the example method 1500 also can implement the example method 1600 in its entirety or in part.

The example method 1600 includes blocks 1510-1550. The computing system can implement such blocks, individually or in combination, in accordance with aspects described hereinbefore in connection the example method 1500 (FIG. 15). As is described herein, implementing blocks 1510-1550 can result in a current control model.

At block 1610, the computing system can receive measurement data (e.g., data 428) from execution of a production quantum circuit in the quantum hardware. As is described herein, production quantum circuits correspond to quantum programs of one or several end-users of the quantum hardware.

At block 1620, the computing system can update, based on the measurement data, the second error channel determined at block 1430.

At block 1630, the computing system can execute, based on the first error channel and the updated second error channel, over a second time interval, a second simulation of the calibration quantum circuit.

At block 1640, the computing system can update, based on results of the second simulation, the control model.

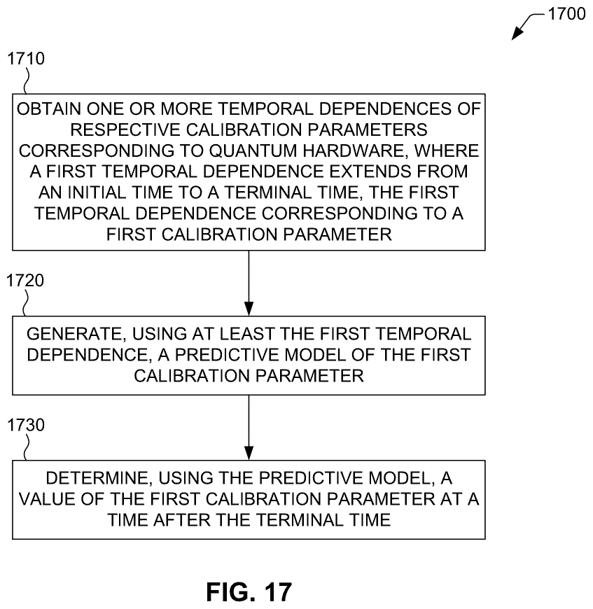

FIG. 17 is a flowchart of an example of a computer-implemented method for generating calibration parameters using a predictive model, in accordance with aspects of this disclosure. A computing device or a system of computing devices (or computing system) can implement the example computer-implemented method 1700 in its entirety or in part. To that end, each one of the computing devices includes computing resources that may implement at least one of the blocks included in the example computer-implemented method 1700 and other methods described herein. The computing resources comprise, for example, CPUs, GPUs, TPUs, memory, disk space, incoming bandwidth, and/or outgoing bandwidth, interface(s) (such as I/O interfaces or APIs, or both); controller devices(s); power supplies; a combination of the foregoing; and/or similar resources. In some cases, a computing system implements the example method 1700.

At block 1710, the computing system can obtain one or more temporal dependences of respective calibration parameters corresponding to quantum hardware (e.g., quantum hardware 430). In some cases, obtaining the temporal dependence(s) includes receiving observed data defining a noise power spectrum of a first calibration parameter of the respective calibration parameters. Further, obtaining the temporal dependence(s) also includes generating, using the observed data, the first temporal dependence. The observed data originates from measurements of the first calibration parameter at a particular duty cycle during a defined time interval, wherein the particular duty cycle is greater than a duty cycle used in a measurement cycle in the quantum hardware during execution of a quantum circuit corresponding to a quantum program of an end-user.

Each temporal dependence of the one or more temporal dependences extends from a respective initial time to a respective terminal time. Respective calibration schedules of the respective calibration parameters dictate the respective initial time and the respective terminal time. In scenarios where there are multiple temporal dependences, a first temporal dependence of the multiple temporal dependences extends from an initial time to a terminal time, and a second temporal dependence of the multiple temporal dependences extends from a second initial time to a second terminal time. The first temporal dependence and the second temporal dependence correspond, respectively, to a first calibration parameter and a second calibration parameter of the respective calibration parameters. In some cases, the initial time and the second initial time can be the same. In addition, or in other cases, the terminal time and the second terminal time can be the same. Respective calibration schedules of the first calibration parameter and the second calibration parameter can dictate if the initial time and the second initial time are the same, and the terminal time and second terminal time are the same.

At block 1720, the computing system can generate, using at least the first temporal dependence, a predictive model of the first calibration parameter. In some cases, generating the predictive model comprises determining a solution to an optimization problem with respect to a cost function based on at least a portion of the observed data and values originating from the predictive model. The portion of the observed data provide ground-truth values of the first calibration parameter. The solution defines the predictive model. The predictive model that is generated can be one of a polynomial function on time that has multiple parameters defined by the solution to the optimization problem; a machine-learning model; or an autoregressive machine-learning model.

The predictive model has valuable practical applications. As is shown in FIG. 17, at block 1730, the computing system can determine, using the predictive model, a value of the first calibration parameter at a time after the terminal time. Determining such a value by using the predictive model as opposed to performing a calibration experiment—that is, a measurement cycle in quantum hardware using a calibration circuit-makes qubit resources and time resources available for execution of a production quantum circuit. In other words, by using the predictive model, the uptime of a quantum computer or QIP system can be extended relative that of other quantum computers that lack a predictive model as is described herein.

Numerous example embodiments emerge from the foregoing detailed description and annexed drawings. Such example embodiments include the following:

Example 1. A computer-implemented method, comprising: executing a quantum circuit configured in a qubit register formed from qubits included in quantum hardware, the quantum circuit corresponding to a quantum program of an end-user of the quantum hardware; and generating at least one control parameter corresponding to the quantum circuit by evaluating a control model during execution of the quantum circuit.

Example 2. The computer-implemented method of example 1, wherein the control model is evaluated at a time corresponding to a timestamp an instruction of the quantum program is executed in the quantum hardware.

Example 3. The computer-implemented method of example 1, further comprising generating scores for the at least one control parameter by applying the control model, each one of the scores represents an estimate of a confidence level on an accuracy of a respective control parameter.

Example 4. The computer-implemented method of example 1, wherein the control model corresponds to one of a PID controller, a linear quadratic regulator (LQR) controller, or a model predictive controller.

Example 5. The computer-implemented method of example 1, wherein the qubit-based measurement data defines one or more bitstrings representative of respective states of the qubit register, and further wherein the side-channel measurement data defines a state of a classical device.

Example 6. The computer-implemented method of example 1, wherein the control model is defined by a time-dependent function that is parameterized by a group of weights.

Example 7. The computer-implemented method of example 1, wherein the control model is defined by a time-dependent function that is parameterized by a group of weights and has a domain that includes side-channel measurement values.

Example 8. The computer-implemented method of example 1, wherein the control model is defined piecewise by at least a first time-dependent function that is parameterized by a first group of weights in a first time interval and a second time-dependent function that is parameterized by a second group of weights in a first time interval.

Example 9. The computer-implemented method of claim 1, further comprising compiling, based on the control model, the quantum circuit corresponding to the quantum program on a subset of the qubits included in the quantum hardware.

Example 10. The computer-implemented method of example 1, further comprising, determining that an update rule is satisfied for a quantum circuit, wherein the update rule is based on performance of the quantum circuit in the quantum hardware; and causing a model generator module to update the control model.

Example 11. The computer-implemented method of example 10, wherein updating the control model comprises updating a prediction of a first control parameter of the at least one control parameters.

Example 12. The computer-implemented method of example 1, further comprising, generating an event-based interrupt corresponding to the quantum hardware; causing, in response to the event-based interrupt, a model generator module to update the control model.

Example 13. A computing system comprising: at least one processor; at least one memory devices storing processor-executable instructions that, in response to being executed by the at least one processor, cause the computing system at least to: execute a quantum circuit configured in a qubit register formed from qubits included in quantum hardware, the quantum circuit corresponding to a quantum program of an end-user of the quantum hardware; and generate at least one control parameter corresponding to the quantum circuit by evaluating a control model during execution of the quantum circuit.

Example 14. The computing system of example 13, wherein the control model is evaluated at a time corresponding to a timestamp an instruction of the quantum program is executed in the quantum hardware.

Example 15. The computing system of example 13, further comprising generating scores for the at least one control parameter by applying the control model, each one of the scores represents an estimate of a confidence level on an accuracy of a respective control parameter.

Example 16. The computing system of example 13, wherein the qubit-based measurement data defines one or more bitstrings representative of respective states of the qubit register, and further wherein the side-channel measurement data defines a state of a classical device.

Example 17. The computing system of example 13, wherein the control model is defined by a time-dependent function that is parameterized by a group of weights.

Example 18. The computing system of claim 13, further comprising compiling, based on the control model, the quantum circuit corresponding to the quantum program on a subset of the qubits included in the quantum hardware.

Example 19. The computing system of example 13, the at least one memory devices storing further processor-executable instructions that, in response to being executed by the at least one processor, individually or in combination, further cause the computing system to: determine that an update rule is satisfied for a quantum circuit, wherein the update rule is based on performance of the quantum circuit in the quantum hardware; and cause a model generator module to update the control model.

Example 20. The computing system of example 19, wherein updating the control model comprises updating a prediction of a first control parameter of the at least one control parameters.

Example 21. The computing system of example 1, further comprising, generating an event-based interrupt corresponding to the quantum hardware; causing, in response to the event-based interrupt, a model generator module to update the control model.

Example 22. A quantum information processing (QIP) system comprising: at least one processor; at least one memory device storing processor-executable instructions that, in response to being executed by the at least one processor, cause the QIP system at least to: execute a quantum circuit configured in a qubit register formed from qubits included in quantum hardware, the quantum circuit corresponding to a quantum program of an end-user of the quantum hardware; and generate at least one control parameter corresponding to the quantum circuit by evaluating a control model during execution of the quantum circuit.

Example 23. The QIP system of example 22, wherein the quantum hardware comprises multiple trapped-atom qubits individually addressable by a laser beam.

Example 24. The QIP system of example 22, wherein the quantum hardware comprises multiple superconducting qubits individually addressable by microwave electromagnetic radiation.

Example 25. The QIP system of example 22, wherein the multiple qubits comprise multiple solid-state impurity qubits individually addressable by a laser beam.

Example 26. A computer-implemented method, comprising: obtaining observed data corresponding to a qubit register formed from qubits included in quantum hardware, wherein the observed data comprises receiving one or more of qubit-based measurement data or side-channel measurement data; and generating, using the observed data, a control model that predicts at least one control parameter.

Example 27. The computer-implemented method of example 26, wherein the control model further predicts respective scores for the at least one control parameter, each one of the respective scores quantifies a confidence on an accuracy of a respective predicted control parameter.

Example 28. The computer-implemented method of example 26, wherein the control model corresponds to one of a PID controller, a linear quadratic regulator (LQR) controller, or a model predictive controller.

Example 29. The computer-implemented method of example 26, wherein the method further comprises, determining that an update criterion is satisfied; sending a request for second observed data; and updating, based on the second observed data, the control model.

Example 30. The computer-implemented method of example 26, wherein the obtaining the observed data comprises, determining a solution to an optimization problem with respect to an objective function, the solution defining a time interval to obtain the observed data; and causing execution of one or more calibration tasks during the time interval.

Example 31. The computer-implemented method of example 26, wherein the qubit-based measurement data defines one or more bitstrings representative of respective states of the qubit register, and further wherein the side-channel measurement data defines a state of a classical device.

Example 32. The computer-implemented method of example 26 wherein the generating the control model comprises training, using the observed data, a machine-learning model.

Example 33. The computer-implemented method of example 26, wherein the generating the control model comprises fitting a compact physical model.

Example 34. The computer-implemented method of example 26, wherein the generating the control model comprises generating a regression model.

Example 35. A computing system comprising: at least one processor; at least one memory devices storing processor-executable instructions that, in response to being executed by the at least one processor, cause the computing system at least to: obtain observed data corresponding to a qubit register formed from qubits included in quantum hardware, wherein the observed data comprises receiving one or more of qubit-based measurement data or side-channel measurement data; and generate, using the observed data, a control model that predicts at least one control parameter.

Example 36. The computing system of example 35, wherein the control model further predicts respective scores for the at least one control parameter, each one of the respective scores quantifies a confidence on an accuracy of a respective predicted control parameter.

Example 37. The computing system of example 35, the at least one memory devices storing further processor-executable instructions that, in response to being executed by the at least one processor, individually or in combination, further cause the computing system to: determine that an update criterion is satisfied; send a request for second observed data; and update, based on the second observed data, the control model.

Example 38. The computing system of example 35, wherein the obtaining the observed data comprises: determining a solution to an optimization problem with respect to an objective function, the solution defining a time interval to obtain the observed data; and causing execution of one or more calibration tasks during the time interval.

Example 39. The computing system of example 35, wherein the qubit-based measurement data defines one or more bitstrings representative of respective states of the qubit register, and further wherein the side-channel measurement data defines a state of a classical device.

Example 40. The computing system of example 35, wherein the generating the control model comprises training, using the observed data, a machine-learning model.

Example 41. The computing system of example 35, wherein the generating the control model comprises fitting a compact physical model.

Example 42. The computing system of example 35, wherein the generating the control model comprises generating a regression model.

Example 43. A quantum information processing (QIP) system comprising: at least one processor; at least one memory devices storing processor-executable instructions that, in response to being executed by the at least one processor, cause the QIP system at least to: obtain observed data corresponding to a qubit register formed from qubits included in quantum hardware, wherein the observed data comprises receiving one or more of qubit-based measurement data or side-channel measurement data; and generate, using the observed data, a control model that predicts at least one control parameter.

Example 44. The QIP system of example 43, wherein the quantum hardware comprises multiple trapped-atom qubits individually addressable by a laser beam.

Example 45. The QIP system of example 43, wherein the quantum hardware comprises multiple superconducting qubits individually addressable by microwave electromagnetic radiation.

Example 46. The QIP system of example 18, wherein the multiple qubits comprise multiple solid-state impurity qubits individually addressable by a laser beam.

Example 47. A system, comprising: one or more processors configured to execute components stored in one or more memory devices, the components comprising, a first component that, in response to execution by the one or more processors, individually or in combination, causes generation of a second component, wherein the first component defines a native gate of quantum hardware comprising multiple qubits, and wherein the second component defines a configuration of hardware elements to implement the native gate, the configuration including a gate variant associated with the native gate, and an association between one or more control hardware elements and one or more target qubits of the multiple qubits.

Example 48. The system of example 47, wherein, in response to execution by the one or more processors, individually or in combination, the second component causes generation of a data structure defining gate parameters including first gate parameters corresponding to the gate variant and second gate parameters corresponding to the one or more control hardware elements.

Example 49. The system of example 48, wherein the second gate parameters include one or more calibration parameters for a first control hardware element of the one or more control hardware elements.

Example 50. The system of example 48, wherein the second component comprises a second data structure defining one or more override parameters, wherein causing generation of the data structure comprises applying the one or more override parameters to the defined gate parameters.

Example 51. The system of example 48, wherein a first override parameter of the one or more override parameters is expressed as an absolute offset value from an existing calibration value, a fraction of the existing calibration value, or a relative offset value from the existing calibration value.

Example 52. The system of example 51, wherein a first override parameter of the one or more override parameters is expressed as a function of an existing calibration value.

Example 53. The system of example 48, wherein the components further comprise a compiler component that, in response to execution by the one or more processors, individually or in combination, using the data structure, causes generation of a second data structure defining pulse-level instructions corresponding to the quantum hardware.

Example 54. The system of example 53, wherein the components further comprise a third component that, in response to execution by the one or more processors, individually or in combination, using the second data structure, cause generation of hardware instructions corresponding to the quantum hardware.

Example 55. The system of example 47, wherein a subset of the components comprises immutable methods identified by a datum defining a version.

Example 56. The system of example 47, wherein a particular first component of the components defines a first parameterization of a quantum gate, and wherein a particular second component comprises a second parameterization of the quantum gate.

Example 57. The system of example 47, wherein a particular component of the components defines a data structure, and wherein, in response to execution, the particular component causes a message to be sent, the message comprising at least one field and respective payload data.

Example 58. A quantum information processing (QIP) system comprising: quantum hardware configured to provide multiple qubits; and a classical computing system comprising: one or more processors configured to execute components stored in one or more memory devices, the components comprising, a first component that, in response to execution by the one or more processors, individually or in combination, causes generation of a second component, wherein the first component defines a native gate of quantum hardware comprising multiple qubits, and wherein the second component defines a configuration of hardware elements to implement the native gate, the configuration including a gate variant associated with the native gate, and an association between one or more control hardware elements and one or more target qubits of the multiple qubits.

Example 59. The QIP system of example 58, wherein, in response to execution by the one or more processors, individually or in combination, the second component causes generation of a data structure defining gate parameters including first gate parameters corresponding to the gate variant and second gate parameters corresponding to the one or more control hardware elements.

Example 60. The QIP system of example 59, wherein the second gate parameters include one or more calibration parameters for a first control hardware element of the one or more control hardware elements.

Example 61. The QIP system of example 59, wherein the second component comprises a second data structure defining one or more override parameters, wherein causing generation of the data structure comprises applying the one or more override parameters to the defined gate parameters.

Example 62. The QIP system of example 59, wherein a first override parameter of the one or more override parameters is expressed as an absolute offset value from an existing calibration value, a fraction of the existing calibration value, or a relative offset value from the existing calibration value.

Example 63. The QIP system of example 62, wherein a first override parameter of the one or more override parameters is expressed as a function of an existing calibration value.

Example 64. The QIP system of example 59, wherein the components further comprise a compiler component that, in response to execution by the one or more processors, individually or in combination, using the data structure, causes generation of a second data structure defining pulse-level instructions corresponding to the quantum hardware.

Example 65. The QIP system of example 64, wherein the components further comprise a third component that, in response to execution by the one or more processors, individually or in combination, using the second data structure, cause generation of hardware instructions corresponding to the quantum hardware.

Example 66. The QIP system of example 58, wherein the multiple qubits comprise multiple trapped-atom qubits individually addressable by a laser beam.

Example 67. The QIP system of example 58, wherein the multiple qubits comprise multiple superconducting qubits individually addressable by microwave electromagnetic radiation.

Example 68. The QIP system of example 58, wherein the multiple qubits comprise multiple solid-state impurity qubits individually addressable by a laser beam.

Example 69. A device, comprising: a first processing unit functionally coupled with a second processing unit by a low-latency bus structure, the first processing unit configured to execute multiple components stored in memory, wherein the components comprise: a first component configured to, compile a quantum program, resulting in one or more hardware instructions, and send, via the second processing unit, towards quantum hardware, a first hardware instruction of the one or more hardware instructions; a second component configured to receive data responsive to the first hardware instruction; and a third component configured to update, based on the data, a control model; wherein the first processing unit, the low-latency bus structure, and the second processing unit are integrated into a module within the quantum hardware.

Example 70. The device of example 69, wherein the quantum program corresponds to a calibration quantum circuit, and wherein the data comprise at least one of qubit-based measurement data or side-channel measurement data.

Example 71. The device of example 69, wherein to compile the quantum program, the first component is further configured to: access the control model; and evaluate the control model.

Example 72. The device of example 69, wherein the second component is further configured to: generate a trigger interruption indicative of initiation of execution of the quantum program; and pass the trigger interruption to a fourth component configured to: receive the trigger interruption; and pass the quantum program to the first component in response to the trigger interruption.

Example 73. The device of example 69, wherein the second component is further configured to pass the data to the third component.

Example 74. The device of example 69, wherein the components further comprise a fourth component configured to identify a particular quantum program for execution.

Example 75. The device of example 74, further comprising a memory device comprising a sequence of quantum programs for execution including the particular quantum program.

Example 76. The device of example 75, wherein identifying the particular quantum program for execution comprises passing a reference value indicative of the particular quantum program.

Example 77. The device of example 75, wherein the module is a system-on-chip (SoC).

Example 78. A quantum information processing (QIP) system comprising: quantum hardware configured to provide multiple qubits; and control hardware configured to control operation of the multiple qubits, the control hardware comprising a device including: a first processing unit functionally coupled with a second processing unit by a low-latency bus structure, the first processing unit configured to execute multiple components stored in memory, wherein the components comprise: a first component configured to, compile a quantum program, resulting in one or more hardware instructions, and send, via the second processing unit, towards quantum hardware, a first hardware instruction of the one or more hardware instructions; a second component configured to receive data responsive to the first hardware instruction; and a third component configured to update, based on the data, a control model; wherein the first processing unit, the low-latency bus structure, and the second processing unit are integrated into a module within the quantum hardware.

Example 79. The QIP system of example 78, wherein the quantum program corresponds to a calibration quantum circuit, and wherein the data comprise at least one of qubit-based measurement data or side-channel measurement data.

Example 80. The QIP system of example 78, wherein to compile the quantum program, the first component is further configured to: access the control model; and evaluate the control model.

Example 81. The QIP system of example 78, wherein the second component is further configured to: generate a trigger interruption indicative of initiation of execution of the quantum program; and pass the trigger interruption to a fourth component configured to: receive the trigger interruption; and pass the quantum program to the first component in response to the trigger interruption.

Example 82. The QIP system of example 78, wherein the second component is further configured to pass the data to the third component.

Example 83. The QIP system of example 78, wherein the components further comprise a fourth component configured to identify a particular quantum program for execution.

Example 84. The QIP system of example 83, further comprising a memory device comprising a sequence of quantum programs for execution including the particular quantum program.

Example 85. The device of example 84, wherein identifying the particular quantum program for execution comprises passing a reference value indicative of the particular quantum program.

Example 86. The QIP system of example 78, wherein the multiple qubits comprise multiple trapped-atom qubits individually addressable by a laser beam.

Example 87. The QIP system of example 78, wherein the multiple qubits comprise multiple superconducting qubits individually addressable by microwave electromagnetic radiation.

Example 88. The QIP system of example 78, wherein the multiple qubits comprise multiple solid-state impurity qubits individually addressable by a laser beam.

Example 89. A computer-implemented method, comprising: obtaining a first error channel of quantum hardware; obtaining one or more temporal dependencies of respective calibration parameters corresponding to the quantum hardware; determining a second error channel based on the one or more temporal dependencies and a control model that defines a control state of the quantum hardware; executing, based on the first error channel and the second error channel, over a time interval, a simulation of a calibration circuit configured within a quantum register formed from at least one qubit included in the quantum hardware; and updating, based on results of the simulation, a control model.

Example 90. The computer-implemented method of example 89, further comprising: receiving measurement data from execution of a quantum circuit in the quantum hardware, the quantum circuit corresponding to a quantum program of an end-user of the quantum hardware; updating, based on the measurement data, the second error channel; and executing, based on the first error channel and the updated second error channel, over a second time interval, a second simulation of the calibration circuit.

Example 91. The computer-implemented method of example 90, further comprising updating, based on results of the second simulation, the control model.

Example 92. The computer-implemented method of example 89, wherein control model is defined by a time-dependent function parameterized by a group of weights defining, the updating comprising updating at least one weight of the group of weights.

Example 93. The computer-implemented method of example 89, wherein the first error channel comprises a gate-level error channel, and wherein the obtaining the first error channel comprises receiving data indicative of attributes of native gates configured in the quantum hardware, the data originating from one or more of a tomography protocol or a measurement of a microscopic parameter.

Example 94. The computer-implemented method of example 89, wherein the obtaining the one or more time-dependencies of respective calibration parameters comprises: receiving observed data defining a noise power spectrum of a first calibration parameter of the respective calibration parameters; and generating, using the observed data, a first temporal dependence of the first calibration parameter.

Example 95. The computer-implemented method of example 94, the observed data originating from measurements of the first calibration parameter at a particular duty cycle during a defined time interval, wherein the particular duty cycle is greater than a duty cycle used in a measurement cycle in the quantum hardware during execution of a quantum circuit corresponding to a quantum program of an end-user.

Example 96. A computing system comprising: at least one processor; at least one memory devices storing processor-executable instructions that, in response to being executed by the at least one processor, cause the computing system at least to: obtain a first error channel of quantum hardware; obtain one or more temporal dependencies of respective calibration parameters corresponding to the quantum hardware; determine a second error channel based on the one or more temporal dependencies and a control model that defines a control state of the quantum hardware; execute, based on the first error channel and the second error channel, over a time interval, a simulation of a calibration circuit configured within a quantum register formed from at least one qubit included in the quantum hardware; and update, based on results of the simulation, a control model.

Example 97. The computing system of example 96, the at least one memory devices storing further processor-executable instructions that, in response to being executed by the at least one processor, individually or in combination, further cause the computing system to: receive measurement data from execution of a quantum circuit in the quantum hardware, the quantum circuit corresponding to a quantum program of an end-user of the quantum hardware; update, based on the measurement data, the second error channel; and execute, based on the first error channel and the updated second error channel, over a second time interval, a second simulation of the calibration circuit.

Example 98. The computing system of example 97, the at least one memory devices storing further processor-executable instructions that, in response to being executed by the at least one processor, individually or in combination, further cause the computing system to update, based on results of the second simulation, the control model.

Example 99. The computing system of example 96, wherein control model is defined by a time-dependent function parameterized by a group of weights defining, the updating comprising updating at least one weight of the group of weights.

Example 100. The computing system of example 96, wherein the first error channel comprises a gate-level error channel, and wherein the obtaining the first error channel comprises receiving data indicative of attributes of native gates configured in the quantum hardware, the data originating from one or more of a tomography protocol or a measurement of a microscopic parameter.

Example 101. The computing system of example 96, wherein the obtaining the one or more time-dependencies of respective calibration parameters comprises: receiving observed data defining a noise power spectrum of a first calibration parameter of the respective calibration parameters; and generating, using the observed data, a first temporal dependence of the first calibration parameter.

Example 102. The computing system of example 101, the observed data originating from measurements of the first calibration parameter at a particular duty cycle during a defined time interval, wherein the particular duty cycle is greater than a duty cycle used in a measurement cycle in the quantum hardware during execution of a quantum circuit corresponding to a quantum program of an end-user.

Example 103. A quantum information processing (QIP) system comprising: at least one processor; at least one memory device storing processor-executable instructions that, in response to being executed by the at least one processor, cause the QIP system at least to: obtain a first error channel of quantum hardware; obtain one or more temporal dependencies of respective calibration parameters corresponding to the quantum hardware; determine a second error channel based on the one or more temporal dependencies and a control model that defines a control state of the quantum hardware; execute, based on the first error channel and the second error channel, over a time interval, a simulation of a calibration circuit configured within a quantum register formed from at least one qubit included in the quantum hardware; and update, based on results of the simulation, a control model.

Example 104. The QIP system of example 103, the at least one memory device storing further processor-executable instructions that, in response to being executed by the at least one processor, individually or in combination, further cause the computing system to: receive measurement data from execution of a quantum circuit in the quantum hardware, the quantum circuit corresponding to a quantum program of an end-user of the quantum hardware; update, based on the measurement data, the second error channel; and execute, based on the first error channel and the updated second error channel, over a second time interval, a second simulation of the calibration circuit.

Example 105. The QIP system of example 104, the at least one memory device storing further processor-executable instructions that, in response to being executed by the at least one processor, individually or in combination, further cause the computing system to update, based on results of the second simulation, the control model.

Example 106. The QIP system of example 105, wherein the quantum hardware comprises multiple trapped-atom qubits individually addressable by a laser beam.

Example 107. The QIP system of example 105, wherein the quantum hardware comprises multiple superconducting qubits individually addressable by microwave electromagnetic radiation.

Example 108. The QIP system of example 105, wherein the multiple qubits comprise multiple solid-state impurity qubits individually addressable by a laser beam.

Example 109. A computer-implemented method, comprising: obtaining one or more temporal dependences of respective calibration parameters corresponding to quantum hardware, wherein a first temporal dependence of the one or more temporal dependences extends from an initial time to a terminal time, the first temporal dependence corresponding to a first calibration parameter of the respective calibration parameters; generating a predictive model of the first calibration parameter, wherein the predictive model is generated using at least the first temporal dependence; and determining, using the predictive model, for a time after the terminal time, a value of the first calibration parameter.

Example 110. The computer-implemented method of example 109, wherein the obtaining the one or more temporal dependences of the respective calibration parameters comprises: receiving observed data defining a noise power spectrum of the first calibration parameter; and generating, using the observed data, the first temporal dependence.

Example 111. The computer-implemented method of example 110, wherein the generating the predictive model comprises determining a solution to an optimization problem with respect to a cost function based on at least a portion of the observed data and values originating from the predictive model, and wherein the solution defines the predictive model.

Example 112. The computer-implemented method of example 111, wherein the predictive model is a polynomial function on time that has multiple parameters defined by the solution to the optimization problem.

Example 113. The computer-implemented method of example 111, wherein the predictive model is a machine-learning model.

Example 114. The computer-implemented method of example 113, wherein the predictive model is an autoregressive machine-learning model.

Example 115. The computer-implemented method of example 110, the observed data originating from measurements of the first calibration parameter at a particular duty cycle during a defined time interval, wherein the particular duty cycle is greater than a duty cycle used in a measurement cycle in the quantum hardware during execution of a quantum circuit corresponding to a quantum program of an end-user.

Example 116. A computing system comprising: at least one processor; at least one memory devices storing processor-executable instructions that, in response to being executed by the at least one processor, individually or in combination, cause the computing system at least to: obtain one or more temporal dependences of respective calibration parameters corresponding to quantum hardware, wherein a first temporal dependence of the one or more temporal dependences extends from an initial time to a terminal time, the first temporal dependence corresponding to a first calibration parameter of the respective calibration parameters; generate a predictive model of the first calibration parameter, wherein the predictive model is generated using at least the first temporal dependence; and determine, using the predictive model, for a time after the terminal time, a value of the first calibration parameter.

Example 117. The computing system of example 116, wherein obtaining the one or more temporal dependences of the respective calibration parameters comprises: receiving observed data defining a noise power spectrum of the first calibration parameter; and generating, using the observed data, the first temporal dependence.

Example 118. The computing system of example 117, wherein the generating the predictive model comprises determining a solution to an optimization problem with respect to a cost function based on at least a portion of the observed data and values originating from the predictive model, and wherein the solution defines the predictive model.

Example 119. The computing system of example 118, wherein the predictive model is a polynomial function on time that has multiple parameters defined by the solution to the optimization problem.

Example 120. The computing system of example 118, wherein the predictive model is a machine-learning model.

Example 121. The computing system of example 120, wherein the predictive model is an autoregressive machine-learning model.

Example 122. The computing system of example 117, the observed data originating from measurements of the first calibration parameter at a particular duty cycle during a defined time interval, wherein the particular duty cycle is greater than a duty cycle used in a measurement cycle in the quantum hardware during execution of a quantum circuit corresponding to a quantum program of an end-user.

Example 123. A quantum information processing (QIP) system comprising: at least one processor; at least one memory device storing processor-executable instructions that, in response to being executed by the at least one processor, individually or in combination, cause the QIP system at least to: obtain one or more temporal dependences of respective calibration parameters corresponding to quantum hardware, wherein a first temporal dependence of the one or more temporal dependences extends from an initial time to a terminal time, the first temporal dependence corresponding to a first calibration parameter of the respective calibration parameters; generate a predictive model of the first calibration parameter, wherein the predictive model is generated using at least the first temporal dependence; and determine, using the predictive model, for a time after the terminal time, a value of the first calibration parameter.

Example 124. The QIP system of example 123, wherein obtaining the one or more temporal dependences of the respective calibration parameters comprises: receiving observed data defining a noise power spectrum of the first calibration parameter; and generating, using the observed data, the first temporal dependence.

Example 125. The QIP system of example 124, wherein the generating the predictive model comprises determining a solution to an optimization problem with respect to a cost function based on at least a portion of the observed data and values originating from the predictive model, and wherein the solution defines the predictive model.

Example 126. The QIP system of example 123, wherein the quantum hardware comprises multiple trapped-atom qubits individually addressable by a laser beam.

Example 127. The QIP system of example 123, wherein the quantum hardware comprises multiple superconducting qubits individually addressable by microwave electromagnetic radiation.

Example 128. The QIP system of example 123, wherein the multiple qubits comprise multiple solid-state impurity qubits individually addressable by a laser beam.

Various aspects of the disclosure may take the form of an entirely or partially hardware aspect, an entirely or partially software aspect, or a combination of software and hardware. Furthermore, as described herein, various aspects of the disclosure (e.g., systems and methods) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit the performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read-only memory (ROM); random access memory (RAM); magnetic disk storage media; optical storage media; flash memory, and so forth.

Aspects of this disclosure are described herein with reference to block diagrams and flowchart illustrations of methods, systems, apparatuses, and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into a general-purpose computer, a special-purpose computer, or another programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps, or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to the arrangement of steps or operational flow; plain meaning derived from grammatical organization or punctuation; the number or type of aspects described in the specification or annexed drawings; or the like.

As used in this disclosure, including the annexed drawings, the terms “component,” “module,” “system,” “platform,” and the like are intended to refer to a computer-related entity or an entity related to an apparatus with one or more specific functionalities. The entity can be either hardware, a combination of hardware and software, software, or software in execution. One or more of such entities are also referred to as “functional elements.” As an example, a component can be a process running on a processor, a processor, an object, an executable, a thread of execution, a program, and/or a computer. For example, both an application running on a server or network controller, and the server or network controller can be a component. One or more components can reside within a process and/or thread of execution and a component can be localized on one computer and/or distributed between two or more computers. Also, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which parts can be controlled or otherwise operated by program code executed by a processor. As yet another example, a component can be an apparatus that provides specific functionality through electronic components without mechanical parts, the electronic components can include a processor to execute program code that provides, at least partially, the functionality of the electronic components. As still another example, interface(s) can include I/O components or Application Programming Interface (API) components. While the foregoing examples are directed to aspects of a component, the exemplified aspects or features also apply to a system, module, and similar.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in this specification and annexed drawings should be construed to mean “one or more” unless specified otherwise or clear from context to be directed to a singular form.

In addition, the terms “example” and “such as” are utilized herein to mean serving as an instance or illustration. Any aspect or design described herein as an “example” or referred to in connection with a “such as” clause is not necessarily to be construed as preferred or advantageous over other aspects or designs described herein. Rather, use of the terms “example” or “such as” is intended to present concepts in a concrete fashion. The terms “first,” “second,” “third,” and so forth, as used in the claims and description, unless otherwise clear by context, is for clarity only and doesn't necessarily indicate or imply any order in time or space.

The term “processor,” as utilized in this disclosure, can refer to any computing processing unit or device comprising processing circuitry that can operate on data and/or signaling. A computing processing unit or device can include, for example, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can include an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. In some cases, processors can exploit nano-scale architectures, such as molecular and quantum-dot based transistors, switches, and gates, in order to optimize space usage or enhance performance of user equipment. A processor may also be implemented as a combination of computing processing units.

In addition, terms such as “store,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. Moreover, a memory component can be removable or affixed to a functional element (e.g., device, server).

Simply as an illustration, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Various aspects described herein can be implemented as a method, apparatus, or article of manufacture using standard programming and/or engineering techniques. In addition, various of the aspects disclosed herein also can be implemented by means of program modules or other types of computer program instructions stored in a memory device and executed by a processor, or other combination of hardware and software, or hardware and firmware. Such program modules or computer program instructions can be loaded onto a general-purpose computer, a special-purpose computer, or another type of programmable data processing apparatus to produce a machine, such that the instructions which execute on the computer or other programmable data processing apparatus create a means for implementing the functionality of disclosed herein.

The term “article of manufacture” as used herein is intended to encompass a computer program accessible from any computer-readable device, carrier, or media. For example, computer readable media can include but are not limited to magnetic storage devices (e.g., hard drive disk, floppy disk, magnetic strips, or similar), optical discs (e.g., compact disc (CD), digital versatile disc (DVD), blu-ray disc (BD), or similar), smart cards, and flash memory devices (e.g., card, stick, key drive, or similar).

The detailed description set forth herein in connection with the annexed figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well-known components are shown in block diagram form, while some blocks may be representative of one or more well-known components.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A computer-implemented method, comprising:
obtaining one or more temporal dependences of respective calibration parameters corresponding to quantum hardware, wherein a first temporal dependence of the one or more temporal dependences extends from an initial time to a terminal time, the first temporal dependence corresponding to a first calibration parameter of the respective calibration parameters;
generating a predictive model of the first calibration parameter, wherein the predictive model is generated using at least the first temporal dependence; and
determining, using the predictive model, for a time after the terminal time, a value of the first calibration parameter.

2. The computer-implemented method of claim 1, wherein the obtaining the one or more temporal dependences of the respective calibration parameters comprises:
receiving observed data defining a noise power spectrum of the first calibration parameter; and
generating, using the observed data, the first temporal dependence.

3. The computer-implemented method of claim 2, wherein the generating the predictive model comprises determining a solution to an optimization problem with respect to a cost function based on at least a portion of the observed data and values originating from the predictive model, and wherein the solution defines the predictive model.

4. The computer-implemented method of claim 3, wherein the predictive model is a polynomial function on time that has multiple parameters defined by the solution to the optimization problem.

5. The computer-implemented method of claim 3, wherein the predictive model is a machine-learning model.

6. The computer-implemented method of claim 5, wherein the predictive model is an autoregressive machine-learning model.

7. The computer-implemented method of claim 2, the observed data originating from measurements of the first calibration parameter at a particular duty cycle during a defined time interval, wherein the particular duty cycle is greater than a duty cycle used in a measurement cycle in the quantum hardware during execution of a quantum circuit corresponding to a quantum program of an end-user.

8. A computing system comprising:
at least one processor;
at least one memory devices storing processor-executable instructions that, in response to being executed by the at least one processor, individually or in combination, cause the computing system at least to:
obtain one or more temporal dependences of respective calibration parameters corresponding to quantum hardware, wherein a first temporal dependence of the one or more temporal dependences extends from an initial time to a terminal time, the first temporal dependence corresponding to a first calibration parameter of the respective calibration parameters;
generate a predictive model of the first calibration parameter, wherein the predictive model is generated using at least the first temporal dependence; and
determine, using the predictive model, for a time after the terminal time, a value of the first calibration parameter.

9. The computing system of claim 8, wherein obtaining the one or more temporal dependences of the respective calibration parameters comprises:
receiving observed data defining a noise power spectrum of the first calibration parameter; and
generating, using the observed data, the first temporal dependence.

10. The computing system of claim 9, wherein the generating the predictive model comprises determining a solution to an optimization problem with respect to a cost function based on at least a portion of the observed data and values originating from the predictive model, and wherein the solution defines the predictive model.

11. The computing system of claim 10, wherein the predictive model is a polynomial function on time that has multiple parameters defined by the solution to the optimization problem.

12. The computing system of claim 10, wherein the predictive model is a machine-learning model.

13. The computing system of claim 12, wherein the predictive model is an autoregressive machine-learning model.

14. The computing system of claim 9, the observed data originating from measurements of the first calibration parameter at a particular duty cycle during a defined time interval, wherein the particular duty cycle is greater than a duty cycle used in a measurement cycle in the quantum hardware during execution of a quantum circuit corresponding to a quantum program of an end-user.

15. A quantum information processing (QIP) system comprising:
at least one processor;
at least one memory device storing processor-executable instructions that, in response to being executed by the at least one processor, individually or in combination, cause the QIP system at least to:
obtain one or more temporal dependences of respective calibration parameters corresponding to quantum hardware, wherein a first temporal dependence of the one or more temporal dependences extends from an initial time to a terminal time, the first temporal dependence corresponding to a first calibration parameter of the respective calibration parameters;
generate a predictive model of the first calibration parameter, wherein the predictive model is generated using at least the first temporal dependence; and
determine, using the predictive model, for a time after the terminal time, a value of the first calibration parameter.

16. The QIP system of claim 15, wherein obtaining the one or more temporal dependences of the respective calibration parameters comprises:
receiving observed data defining a noise power spectrum of the first calibration parameter; and
generating, using the observed data, the first temporal dependence.

17. The QIP system of claim 16, wherein the generating the predictive model comprises determining a solution to an optimization problem with respect to a cost function based on at least a portion of the observed data and values originating from the predictive model, and wherein the solution defines the predictive model.

18. The QIP system of claim 15, wherein the quantum hardware comprises multiple trapped-atom qubits individually addressable by a laser beam.

19. The QIP system of claim 15, wherein the quantum hardware comprises multiple superconducting qubits individually addressable by microwave electromagnetic radiation.

20. The QIP system of claim 15, wherein the multiple qubits comprise multiple solid-state impurity qubits individually addressable by a laser beam.
